(19) United States
(12) Patent Application Publication
(10) Pub. No.: US 2015/0108263 A1
(43) Pub. Date: Apr. 23, 2015

(54) SEATBELT RETRACTOR

(71) Applicant: ASHIMORI INDUSTRY CO., LTD., Osaka-shi, Osaka (JP)

(72) Inventors: Satoshi Suminaka, Osaka (JP); Eri Yamane, Suita (JP)

(21) Appl. No.: 14/404,583

(22) PCT Filed: May 22, 2013
(86) PCT No.: PCT/JP2013/064232

§ 371 Date: Nov. 28, 2014

(30) Foreign Application Priority Data
May 28, 2012 (JP) 2012-120903

(51) Int. Cl. B60R 22/34

(52) U.S. Cl. CPC B60R 22/3413
USPC 242/379.1

(57) ABSTRACT

A seatbelt retractor includes: a take-up drum winding up a webbing thereon; a transmission member arranged coaxially with a rotation axis of the take-up drum, and including a plurality of convex portions protruding radially outward at a predetermined circumferential pitch on an outer periphery of at least one end of the transmission member so as to transmit a rotary driving force; and a fitting member including a fitting portion that receives the one end portion inserted therein and fits with the plurality of convex portions. Each convex portion has a trapezoidal cross section and two faces facing a circumferential direction, one face of which has an inclination angle with regard to a radial direction smaller than the other face has. The one face is configured to receive a load through the fitting member by rotary driving force transmitted in emergency larger than the other face receives.

### TECHNICAL FIELD

The present invention relates to a seatbelt retractor which prevents a webbing from being drawn out in case of emergency such as vehicle collision.

### BACKGROUND ART

Conventionally, there have been proposed various types of seatbelt retractors which prevent a webbing from being drawn out in case of emergency such as vehicle collision.

For instance, in a seatbelt retractor disclosed in Japanese Laid-open Patent Application Publication No. 2000-309249, a spool around which a webbing is to be wound has a drum-like shape with a hollow which elongates in the axial direction, in the center portion thereof. In the hollow, a torsion bar made of soft steel is disposed coaxially with a center shaft of the spool.

In the torsion bar, coupling portions each having a star section shape are formed in both end portions, respectively. One of the coupling portions is coupled to an insertion hole of a coupling member attached to the spool in a mutual rotation disabled manner, and the other of the coupling portions is coupled to an insertion hole of a ratchet wheel of an emergency locking mechanism, similarly in the mutual rotation disabled manner.

In an emergency such as a crash of a vehicle, the ratchet wheel is prevented from rotating in a webbing pull-out direction. Subsequently, when a force drawing the webbing exceeds a certain limit, the torsion bar is subjected to twist deformation, so that the spool rotates in the webbing pull-out direction, absorbing an impact load acting on a vehicle occupant.

### DISCLOSURE OF THE INVENTION

### Problem to be Solved by the Invention

In such a conventional seatbelt retractor as disclosed in the above-described patent publication, the coupling portions disposed in both end portions of the torsion bar have star-like section shapes in each of which concave portions and convex portions of isosceles triangles are regularly and repetitively formed at pitches of 30 degrees in a circumference direction with an apex angle larger than 90 degrees. This enables the coupling portions of the torsion bar to have superior forgeability.

However, the insertion holes of the coupling member and the ratchet wheel, respectively, are formed into a star section analogous to the star section shape of the coupling portions of the torsion bar. As a result, when the torsion bar is subjected to twist deformation in an emergency such as a crash of a vehicle, the inclination angle becomes, large, with regard to the radial direction, at the contact surfaces between the coupling portions of the torsion bar and the insertion holes of the coupling member and the ratchet wheel, and a large load acts radially outward. This makes it necessary for the coupling member and the ratchet wheel to have a high mechanical strength, increasing difficulty in downsizing, weight-saving and cost-reduction thereof.

The present invention has been made in view of the above-described problems and an object thereof is to provide a seatbelt retractor capable of lowering mechanical strength required in a fitting member into which a transmission member that transmits a rotary drive force is inserted, as well as capable of improving forgeability of the transmission member.

### Means for Solving the Problem

To achieve the object of the present invention, there is provided a seatbelt retractor comprising: a take-up drum configured to wind up a webbing thereon; a transmission member arranged coaxially with a rotation axis of the take-up drum, and including a plurality of convex portions protruding radially outward at a predetermined circumferential pitch on an outer peripheral portion of at least one end portion of the transmission member so as to transmit a rotary driving force; and one or more fitting members each including a fitting portion, the fitting portion configured to receive insertion of the one end portion of the transmission member having the plurality of convex portions, and to fit with the plurality of convex portions, wherein each of the plurality of convex portions has a trapezoidal cross section and two faces facing a circumferential direction, with an inclination angle with regard to a radial direction at one face of the two faces smaller than an inclination angle with regard to a radial direction at the other face of the two faces, and the one face is configured to receive a load through one of the one or more fitting members by the rotary driving force transmitted in case of emergency larger than a load that the other face receives.

In the seatbelt retractor, the plurality of convex portions is formed at a predetermined circumferential pitch on an outer peripheral portion of at least one end portion of the transmission member that transmits a rotary driving force. Each of the plurality of convex portions has a trapezoidal cross section, and an inclination angle of the one face of the two faces facing the circumferential direction with regard to a radial direction is formed to be smaller than an inclination angle of the other face with regard to a radial direction.

Thus, at each of the convex portions, by making smaller the inclination angle with regard to a radial direction at the one face of the two faces facing a circumferential direction, even if a larger load acts by the rotary driving force transmitted to the one face of each of the convex portions, radial reaction received at the fitting portion of the fitting member into which each of the convex portions is inserted can be made smaller. Further, at each of the convex portions, even making smaller the inclination angle with regard to a radial direction at the one face of the two faces facing a circumferential direction, the inclination angle with regard to a radial direction at the other face can be made larger than the inclination angle with regard to a radial direction at the one face, so that formability of the plurality of convex portions or the like by forging, etc. can be improved.

Accordingly, when the transmission member transmits the rotary driving force in case of emergency, even if one face of the two faces facing a circumferential direction of the plurality of convex portions receives, via the fitting member, a load larger than a load that the other face receives by the transmitted rotary driving force, the radial reaction that the fitting portion of the fitting member receives from each of the convex portions can be made smaller. Thus, the mechanical strength required in the fitting portion of the fitting member can be lowered, and the downsizing, weight-saving and cost-reduction of the fitting member can be achieved.

Further, even if the inclination angle with regard to a radial direction at one face of two faces facing a circumferential direction of each of the convex portions is made smaller, the inclination angle with regard to a radial direction at the other face can be made larger. Accordingly, in comparison with a case of making similarly smaller the inclination angle with regard to a radial direction at two faces facing a circumferential direction, the width dimension in the circumferential direction can be made larger, so that shear strength in the circumferential direction of each of the convex portions can easily be made larger. Accordingly, the mechanical strength required for each of the convex portions can easily be secured.

Accordingly, by forming the inclination angle with regard to a radial direction at one face of the two faces facing a circumferential direction of the plurality of convex portions smaller than the inclination angle with regard to a radial direction at the other face, the degree of freedom in design of the plurality of convex portions is enhanced, and while securing the mechanical strength required for each of the convex portions and the fitting portion, the formability by forging, etc. of the plurality of convex portions can be improved.

In the seatbelt retractor according to the present invention, the transmission member includes a torsion bar configured to be fittingly inserted in the take-up drum, with one axial end side of the torsion bar configured to be connected to one-end portion of the take-up drum, non-rotatably relative to the take-up drum, the one or more fitting members include a lock member configured to be connected to the other axial end side of the torsion bar, non-rotatably relative to the torsion bar, the lock member configured to be prevented from rotating in a webbing pull-out direction in case of emergency, a set of the plurality of convex portions is protruding radially outward at a predetermined circumferential pitch on an outer peripheral portion at the other axial end side of the torsion bar, the fitting portion is arranged on the lock member, and the one face of the two faces facing a circumferential direction of each of the plurality of convex portions protruding on the outer peripheral portion of the other axial end of the torsion bar is at a side configured to transmit to the lock member a rotary driving force for rotation in the webbing pull-out direction.

In the seatbelt retractor, if the webbing is pulled out under a state where the lock member is prevented from rotating in the webbing pull-out direction in case of emergency, the rotary driving force for rotation in the webbing pull-out direction is transmitted to the fitting portion of the lock member, via the one face of the two faces facing a circumferential direction of each of the plurality of convex portions formed on the other axial end of the torsion bar.

Accordingly, the decrease of the inclination angle with regard to a radial direction at the one face of the plurality of convex portions formed on the other axial end of the torsion bar enables reduction of a radial component force of the rotary driving force for rotation in the webbing pull-out direction, to be applied in case of emergency to the fitting portion of the lock member via the plurality of convex portions. Accordingly, the mechanical strength required in the fitting portion of the lock member can be lowered, and formability by forging, etc. of the torsion bar can be improved, while achieving the downsizing, weight-saving and cost-reduction of the lock member.

In the seatbelt retractor according to the present invention, the transmission member includes a torsion bar configured to be fittingly inserted in the take-up drum, with one axial end side of the torsion bar configured to be connected to one end portion of the take-up drum non-rotatably relative to the take-up drum, the one or more fitting members include the take-up drum configured to fittingly house the torsion bar inserted therein, a set of the plurality of convex portions is arranged protruding radially outward at a predetermined circumferential pitch on an outer peripheral portion of the one axial end side of the torsion bar, the fitting portion is arranged at a one-end-portion side of the take-up drum, and the one face of the two faces facing a circumferential direction of each of the plurality of convex portions arranged on the outer peripheral portion of the one axial end of the torsion bar is at a side configured to transmit to the take-up drum a rotary driving force for rotation in a webbing take-up direction.

In the seatbelt retractor, if the webbing is pulled out under a state where the lock member is prevented from rotating in the webbing pull-out direction in case of emergency, the rotary driving force for rotation in the webbing take-up direction is transmitted to the fitting portion formed on one end portion of the take-up drum through the one face of two faces facing a circumferential direction of each of the plurality of convex portions formed on the one axial end of the torsion bar.

Accordingly, the decrease of the inclination angle with regard to a radial direction at the one face of the plurality of convex portions formed on the one axial end of the torsion bar enables the reduction of a radial component force of the rotary driving force for rotation in the webbing take-up direction applied via the plurality of convex portions in case of emergency to the fitting portion of the one end portion of the take-up drum. Accordingly, the mechanical strength required in the fitting portion formed on the one-end-portion side of the take-up drum can be lowered, and the formability by forging, etc. of the torsion bar can be improved, while achieving the downsizing, weight-saving and cost-reduction of the take-up drum.

In the seatbelt retractor according to the present invention, the take-up drum comprises: a shaft hole having an approximately cylindrical shape, closed at the one-end-portion side of the take-up drum, and housing the torsion bar fittingly inserted from the other-end-portion side of the take-up drum; and a plurality of projecting ribs each having an approximately trapezoidal cross section, projecting radially inward at a predetermined circumferential pitch at the one-end-portion side on an inner circumferential surface of the shaft hole, and extending axially in a predetermined length so as to fit in-between the plurality of convex portions, and the fitting portion is structured with the inner circumferential surface of the shaft hole and the plurality of projecting ribs.

In the seatbelt retractor, on the fitting portion formed on the one-end-portion side of the take-up drum, the plurality of projecting ribs each having an approximately trapezoidal cross section are formed projecting radially inward at a predetermined circumferential pitch from the inner circumferential surface of the shaft hole on the one-end-portion side at a predetermined length along the axial direction so as to fit with the plurality of convex portions. Thus, the mechanical strength can be easily secured at the fitting portion formed on the one-end-portion side of the take-up drum, so that the downsizing, weight-saving and cost-reduction of the take-up drum can be achieved.

In the seatbelt retractor according to the present invention, the seatbelt retractor further comprises a pretensioner mechanism configured to wind up the webbing at vehicle collision. In the seatbelt retractor, the pretensioner mechanism includes: a driven body configured to rotate coaxially with the rotation axis of the take-up drum; a driving mechanism configured to rotatingly drive the driven body at vehicle collision; a rotating body fixedly mounted on the driven body coaxially; and an engaging member supported by the rotating body and configured to engage with an engaging portion arranged on an axially outer side at the one end portion of the take-up drum in response to rotation of the rotating body, the transmission member includes the driven body, the one or more fitting members include the rotating body, a set of the plurality of convex portions are arranged protruding radially outward at a predetermined circumferential pitch on an outer peripheral portion of an axial end portion of the driven body at a take-up-drum side, the fitting portion is arranged on an inner circumferential surface of a through hole of the rotating body configured to fittingly house the axial end portion of the driven body at the take-up-drum side inserted therein, and the one face of the two faces facing a circumferential direction of each of the plurality of convex portions is at a side configured to transmit to the rotating body a rotary driving force for rotation in the webbing take-up direction.

In the seatbelt retractor, if the pretensioner mechanism is activated at vehicle collision, the rotary driving force that abruptly rotates the take-up drum in the webbing take-up direction is transmitted to the fitting portion formed on the inner circumferential surface of the through hole of the rotary body, via the one face of two faces facing a circumferential direction of the plurality of convex portions formed at an end portion in axial direction of the take-up-drum side of the driven body.

Accordingly, the decrease of the inclination angle with regard to a radial direction at the one face of the plurality of convex portions formed at the end portion in the axial direction on the take-up drum side of the driven body enables reduction of a radial component force of the rotary driving force that rotates the take-up drum in the webbing take-up direction, the rotary driving force applied via the plurality of convex portions to the fitting portion of the rotary body at vehicle collision. Accordingly, the mechanical strength required in the fitting portion of the rotary body can be lowered and the formability by forging etc. of the driven body can be improved, while achieving the downsizing, weight-saving and cost-reduction of the rotary body.

Further, in the seatbelt retractor according to the present invention, the plurality of convex portions include at least one positioning convex portion having a different cross section from that of other convex portions, the one positioning convex portion having a positioning portion on the other face thereof, and the one end portion of the transmission member is fittingly inserted into one of the fitting portion under a state positioned by the positioning convex portion.

In the seatbelt retractor, the one end portion of the transmission member is inserted under a state positioned at the fitting portion by the positioning convex portion, so that assembly accuracy can be improved and the efficiency of assembly operation can be promoted by a simple configuration. Further, the positioning portion of the positioning convex portion is formed on the other face to which a larger load is not applied, of the two faces facing a circumferential direction of the convex portion. Accordingly, an adverse influence of the positioning convex portion on the mechanical strength can be reduced.

### BRIEF DESCRIPTION OF THE DRAWINGS

FIG. 1 is a perspective view showing an external appearance of a seatbelt retractor according to the present embodiment;

FIG. 2 is a perspective view showing respective assemblies of the seatbelt retractor in a disassembled state;

FIG. 3 is a perspective view showing respective assemblies of the seatbelt retractor in a disassembled state;

FIG. 4 is an exploded perspective view of a housing unit;

FIG. 5 is an exploded perspective view of a ratchet gear, a take-up spring unit and a locking unit;

FIG. 6 is an exploded perspective view of the ratchet gear, the take-up spring unit and the locking unit;

FIG. 7 is a cross sectional view of an assembled state including a locking arm of the locking unit;

FIG. 8 is a partial cutaway sectional view showing the locking unit with a bottom face portion of a mechanism cover partially cut away;

FIG. 9 is an enlarged sectional view of a principal portion of the seatbelt retractor including the take-up spring unit and the locking unit;

FIG. 10 is a view for illustrating an operation of the locking unit by pull-out acceleration of the webbing (before activation);

FIG. 11 is a view for illustrating an operation of the locking unit by pull-out acceleration of the webbing (at a start of the activation);

FIG. 12 is a view for illustrating an operation of the locking unit by pull-out acceleration of the webbing (in shifting to a locked state);

FIG. 13 is a view for illustrating an operation of the locking unit by pull-out acceleration of the webbing (in the locked state);

FIG. 14 is a view for illustrating an operation of the locking unit by vehicle acceleration (before activation);

FIG. 15 is a view for illustrating an operation of the locking unit by vehicle acceleration (at a start of the activation);

FIG. 16 is a view for illustrating an operation of the locking unit by vehicle acceleration (in shifting to a locked state);

FIG. 17 is a view for illustrating an operation of the locking unit by vehicle acceleration (in the locked state);

FIG. 18 is a sectional view of a take-up drum unit including an axial center thereof;

FIG. 19 is an exploded perspective view of the take-up drum unit;

FIG. 20 is a front view of the take-up drum seen from a side for mounting the ratchet gear;

FIG. 21 is a perspective view of the ratchet gear;

FIG. 22 is a front view of an inner side of the ratchet gear;

FIG. 23 is a side view of a torsion bar seen from a side of the take-up drum;

FIG. 24 is a side view of the torsion bar seen from a side of the ratchet gear;

FIG. 25 is a cross sectional view taken along a line indicated by arrows X1-X1 in FIG. 18 and seen in the direction of the arrows;

FIG. 26 is an exploded perspective view of a pretensioner unit;

FIG. 27 is a cross sectional view for illustrating an internal configuration of the pretensioner unit;

FIG. 28 is a cross sectional view for illustrating an operation of a pawl at vehicle collision;

FIG. 29 is a view for illustrating a pull-out-wire operation;

FIG. 30 is a view for illustrating the pull-out-wire operation;

FIG. 31 is a view for illustrating the pull-out-wire operation;

FIG. 32 is a view for illustrating the pull-out-wire operation;

FIG. 33 is an exploded perspective view of a take-up drum unit of a seatbelt retractor according to a first different embodiment;

FIG. 34 is a side view of the torsion bar in FIG. 33 seen from a side of the take-up drum;

FIG. 35 is a front view of the take-up drum in FIG. 33 seen from a side for mounting the ratchet gear;

FIG. 36 is a partial cutaway sectional view showing the take-up drum in the axial direction;

FIG. 37 is a cross sectional view showing the take-up drum with the torsion bar installed thereon;

FIG. 38 is a perspective view showing a pinion gear of a seatbelt retractor according to a second different embodiment;

FIG. 39 is a side view of the pinion gear in FIG. 38 on a pawl-base side;

FIG. 40 is a perspective view showing a pawl base of the seatbelt retractor according to the second different embodiment;

FIG. 41 is a front view of the pawl base in FIG. 40;

FIG. 42 is a sectional view illustrating a state of a clutch mechanism at activation of a pretensioner unit of the seatbelt retractor according to the second different embodiment;

FIG. 43 is a side view of a torsion bar on a ratchet gear side of a seatbelt retractor according to a third different embodiment;

FIG. 44 is a front view illustrating an inside of the ratchet gear of the seatbelt retractor according to the third different embodiment; and

FIG. 45 is a sectional view of the ratchet gear with the torsion bar attached thereon.

### DETAILED DESCRIPTION OF THE PREFERRED EMBODIMENTS

Hereinafter, an embodiment of a seatbelt retractor according to the present invention will be described in detail while referring to the accompanying drawings.

### [Schematic Configuration]

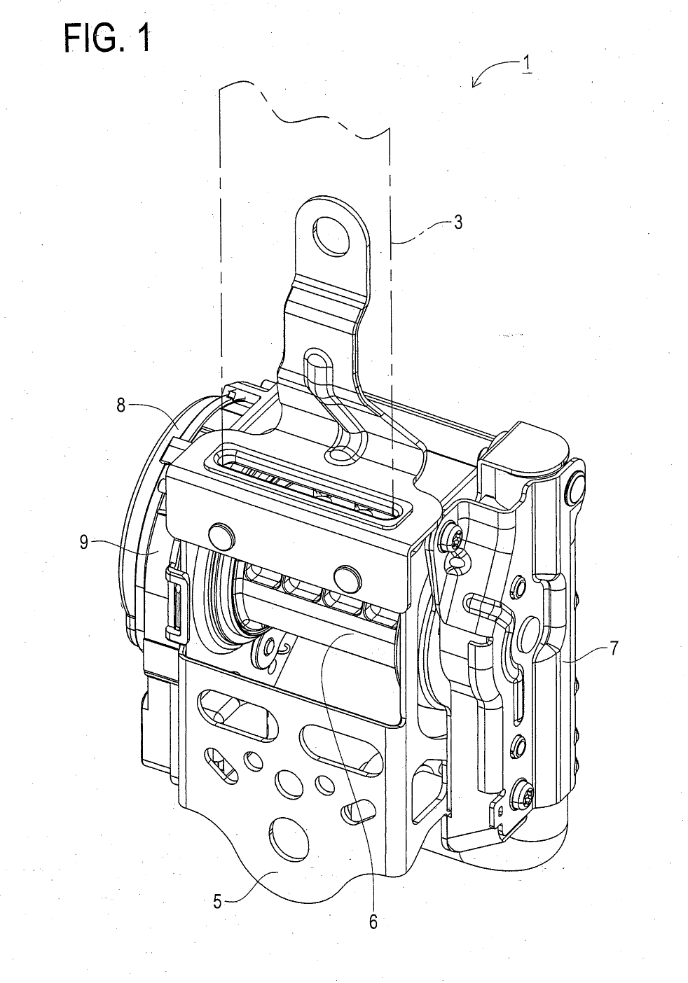

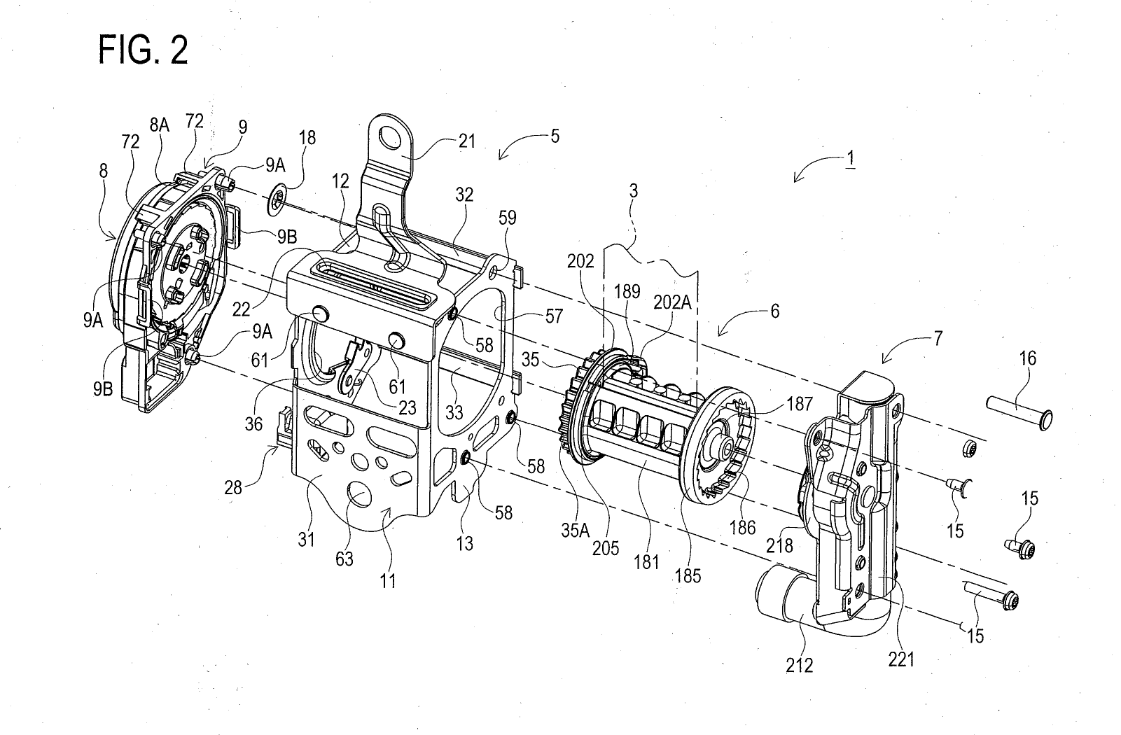

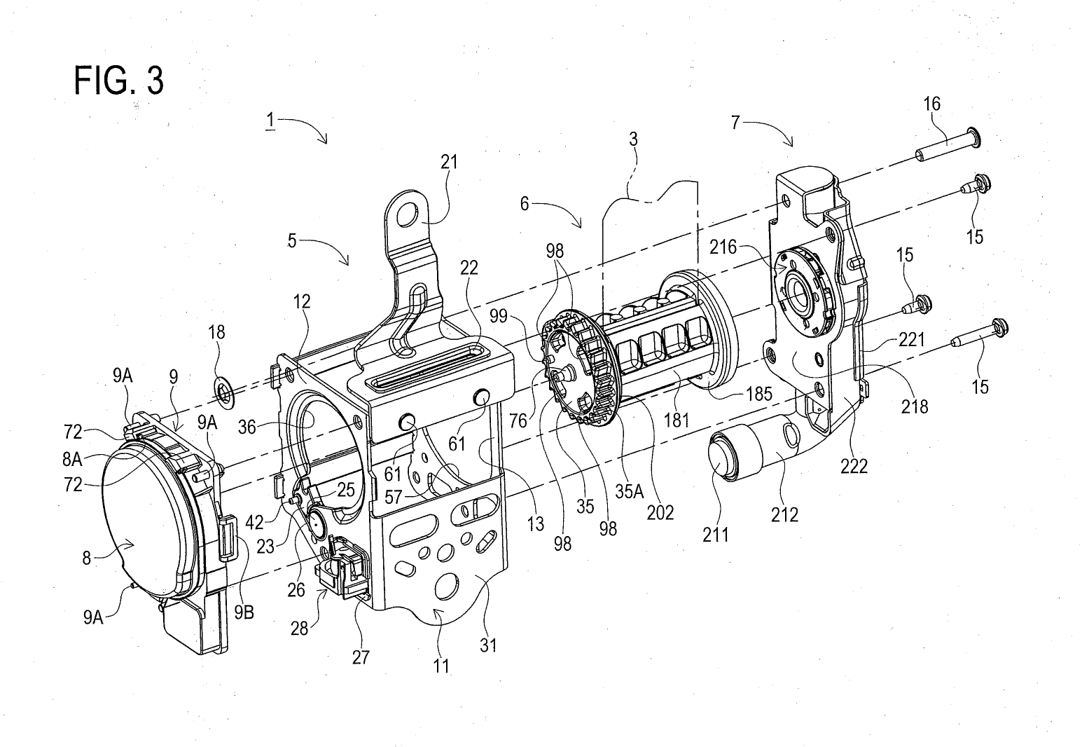

First, a schematic configuration of the seatbelt retractor 1 according to the embodiment will be described based on FIG. 1 through FIG. 3. FIG. 1 is a perspective view showing an external appearance of a seatbelt retractor 1 according to the embodiment FIG. 2 and FIG. 3 each are a perspective view showing the respective assemblies of the seatbelt retractor 1 in a disassembled state.

As shown in FIG. 1 through FIG. 3, the seatbelt retractor 1 is a device for retracting a webbing 3 of a vehicle. The seatbelt retractor 1 has a housing unit 5, a take-up drum unit 6, a pretensioner unit 7, a take-up spring unit 8 and a locking unit 9.

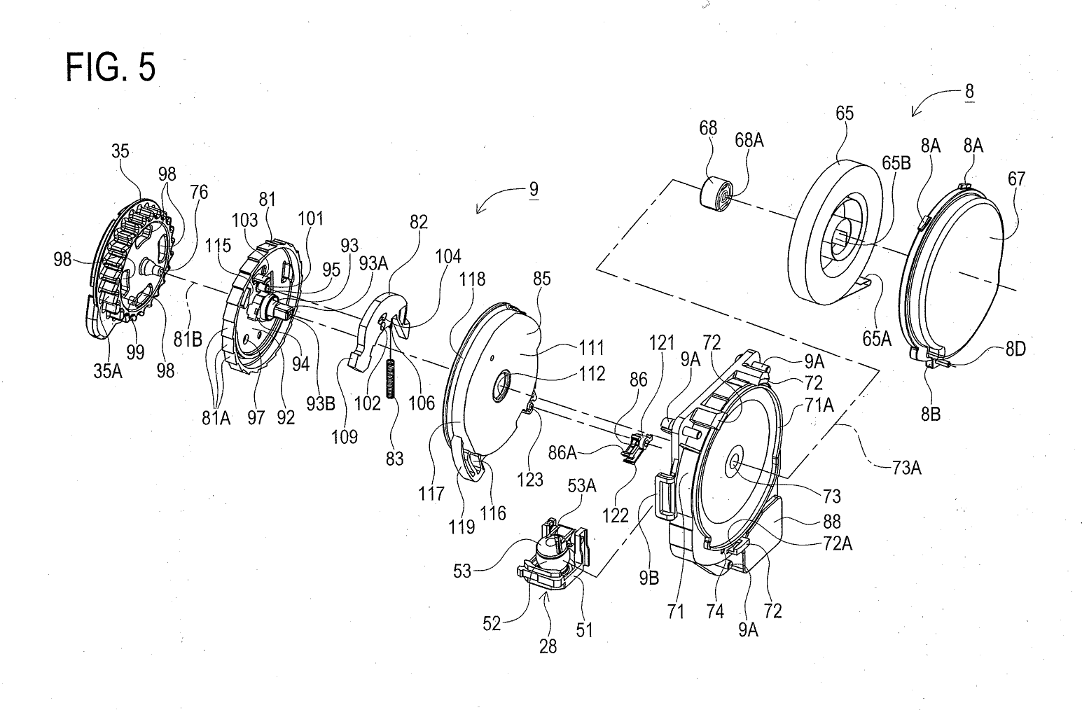

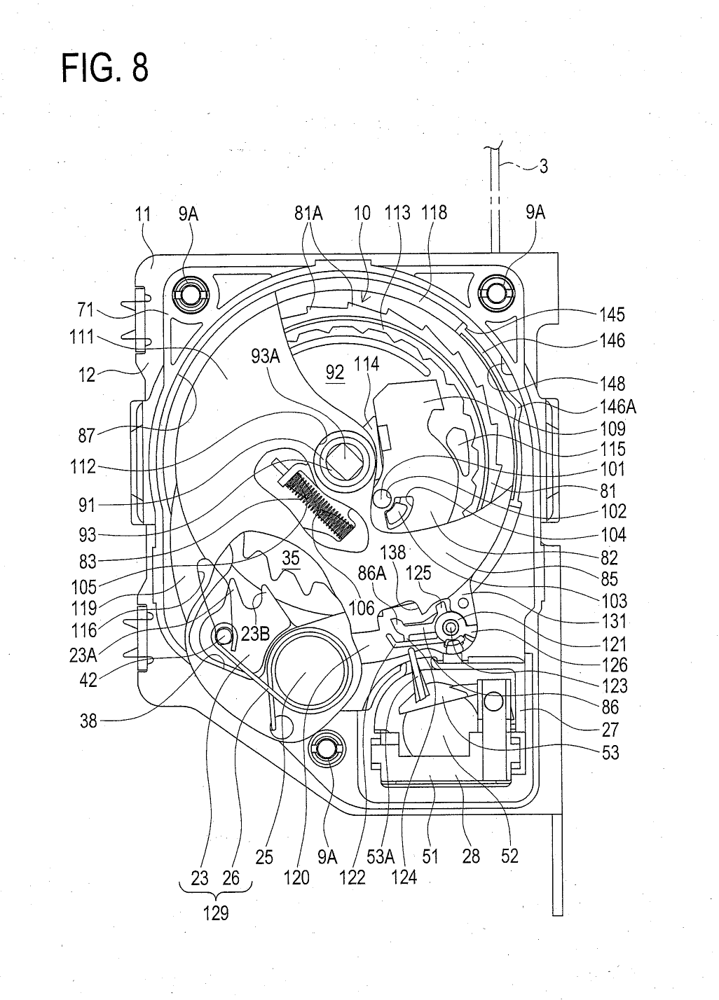

The locking unit 9 has a mechanism cover 71 (refer to FIG. 5) with nylon latches 9A and locking hooks 9B integrally formed thereat. The locking unit 9 is fixed by the nylon latches 9A and the locking hooks 9B at one side wall portion 12 of a housing 11 constituting the housing unit 5. The locking unit 9 constitutes a lock mechanism 10 (refer to FIG. 8) that stops pull-out of the webbing 3 in response to a sudden pull-out of the webbing 3 or an abrupt change in acceleration of a vehicle, to be later described.

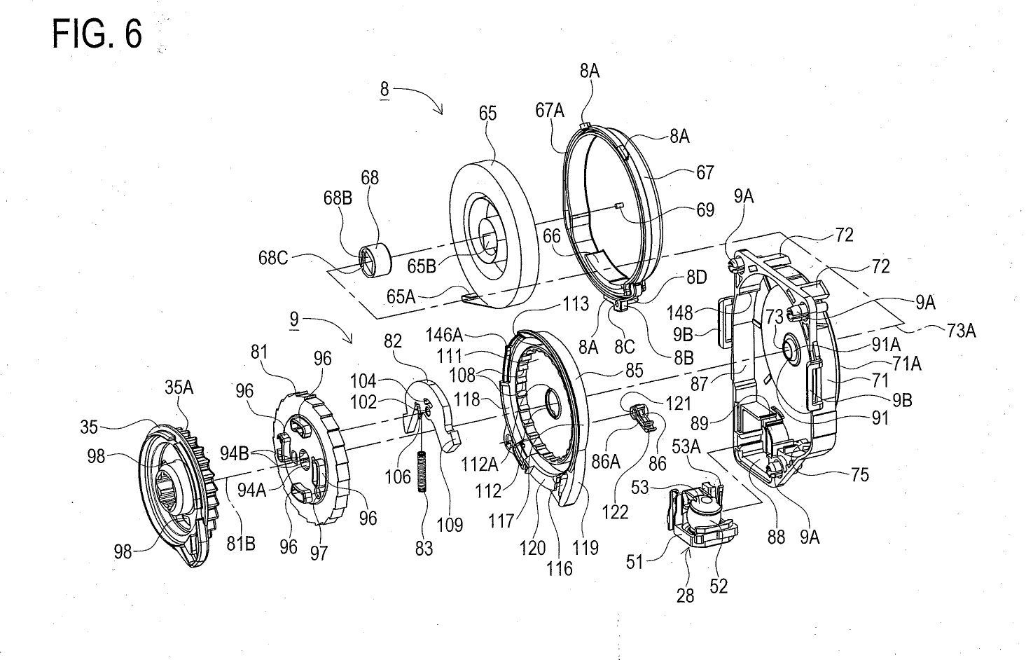

The take-up spring unit 8 is fixed onto the outside in a direction of a rotational axis of the take-up drum unit 6 of the locking unit 9, through three tabular engagement pieces 8A (refer to FIG. 6) projecting from an outer periphery of a spring case 67 (refer to FIG. 5).

The pretensioner unit 7 is mounted to at a side wall portion 13 of the housing 11. The side wall portion 13 is located opposite to the side wall portion 12 of the housing 11 having a substantially square-bracket shape in planer view, and screwed by screws 15 inserted through from an outside, in a direction of the rotational axis of the take-up drum unit 6, of the pretensioner unit 7. The pretensioner unit 7 is pinned with a stopper pin 16 and a push nut 18. The stopper pin 16 is inserted into the side wall portion 13 from an outside of the pretensioner unit 7 in the direction of the rotational axis of the take-up drum unit 6. The push nut 18 is inserted to the stopper pin 16 from an inside in a direction of the rotational axis of the take-up drum unit 6 with regard to the side wall portion 13.

A take-up drum unit 6 onto which the webbing 3 is wound is rotatably supported between the locking unit 9 fixed to the side wall portion 12 of the housing unit 5 and the take-up spring unit 8 fixed to the side wall portion 13 of the housing unit 5. The take-up drum unit 6 is constantly urged in a take-up direction of the webbing 3 by the take-up spring unit 8 fixed on the outside of the locking unit 9.

### [Schematic Configuration of Housing Unit]

A schematic configuration of the housing unit 5 will next be described referring to FIG. 2 through FIG. 4.

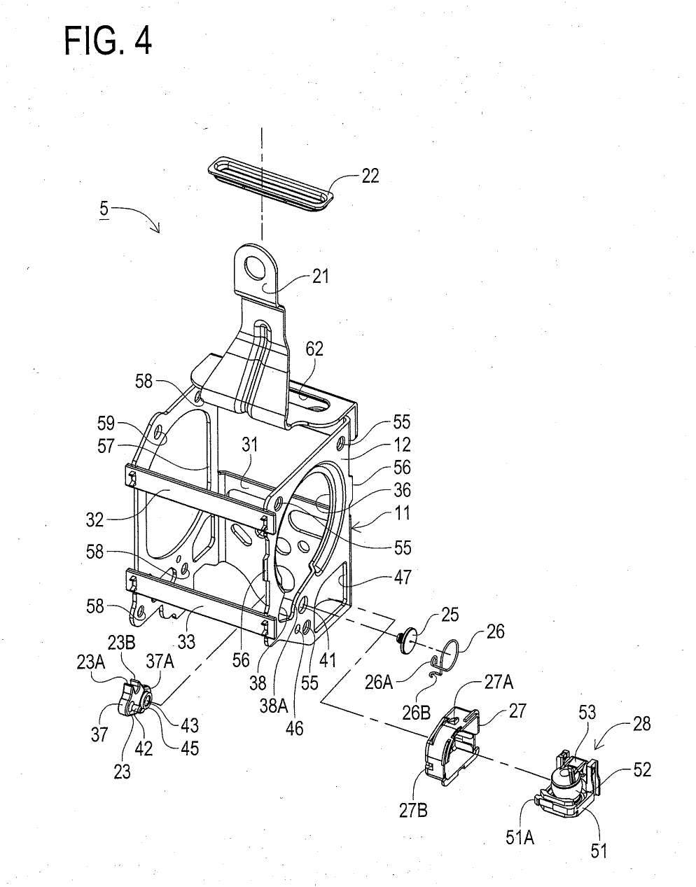

FIG. 4 is an exploded perspective view of the housing unit 5.

As shown in FIG. 2 through FIG. 4, the housing unit 5 includes the housing 11, a bracket 21, a protector 22, a pawl 23, a pawl rivet 25, a twisted coil spring 26, a sensor cover 27, an acceleration sensor 28, connecting members 32, 33, and rivets 61.

The housing 11 has a back plate portion 31 to be fixed at a vehicle body and the side wall portions 12, 13 opposed to each other and extending from both side edge portions of the back plate portion 31. The housing 11 is made of a steel material or the like and is formed to have a substantially square bracket-shape in planer view. The side wall portions 12, 13 are connected to each other with the connecting members 32, 33, each of which has a horizontally long thin plate-like shape, being long in a direction of the rotational axis of the take-up drum unit 6. An opening portion is formed in the center of the back plate portion 31, and helps reduce weight and regulates the accommodation amount of the webbing 3.

The side wall portion 12 has a through hole 36 into which a ratchet gear 35 of the take-up drum unit 6 is inserted with a predetermined clearance (for instance, a clearance of approximately 0.5 mm). The inner peripheral portion of the through hole 36 is recessed axially inward in a predetermined depth toward the take-up drum unit 6, opposing to the ratchet gear 35 of the take-up drum unit 6.

From an obliquely lower edge portion of the through hole 36 (at a portion obliquely lower left in FIG. 4), a notch portion 38 is notched outwardly regarding a rotation direction of the pawl 23 (in a direction away from the ratchet gear 35 of the pawl 23). The notch portion 38 is positioned opposite to a tip-side portion 37 of the pawl 23 including engagement teeth 23A, 23B, and is notched deep enough to receive a tip-side portion 37. A through hole 41 is formed at a position lateral to the notch portion 38, at the side of the back plate portion 31. The through hole 41 is configured to mount the pawl 23 in a rotatable manner. At a portion on the through hole 41 side on which the pawl 23 abuts, the notch portion 38 further has a guiding portion 38A shaped in a coaxial arc with the through hole 41.

Meanwhile, the pawl 23 is made of a steel material or the like and has a stepped portion 37A at a portion to abut on and move along the guiding portion 38A. The stepped portion 37A is formed at approximately the same height as the thickness of the side wall portion 12, recessed in an arc-like shape at the same radius curvature as the guiding portion 38A. The pawl 23 further has a guiding pin 42 at a tip portion on an axially outer side face (frontward in FIG. 4). The guiding pin 42 is inserted into a guiding hole 116 (refer to FIGS. 5 and 8) of a clutch 85 that forms the locking unit 9.

Further, at an base end portion (one end portion) of the pawl 23, there is formed a through hole 43 into which the pawl rivet 25 is inserted. The through hole 43 has, along the periphery thereof, a boss portion 45 to be rotatably inserted in the through hole 41 of the side wall portion 12, shaped cylindrically and at a height approximately the same as the thickness of the side wall portion 12. Further, in a state where the boss portion 45 is inserted in the through hole 41 of the side wall portion 12 from the inner side of the housing 11, the pawl rivet 25 is inserted into the through hole 43 from the outer side of the side wall portion 12 to rotatably fix the pawl 23. Accordingly, the engagement teeth 23A, 23B of the pawl 23 and ratchet gear portions 35A provided on the outer periphery of the ratchet gear 35 are arranged substantially on the same plane as the outer side surface of the side wall portion 12.

The head of the pawl rivet 25 is formed into a disk-like shape having a larger diameter than the through hole 41 and at a predetermined thickness (for instance, approximately 1.5 mm thick). Then, the twisted coil spring 26 that operates as an example of a return spring is arranged in a single wind to surround the periphery of the head of the pawl rivet 25, and one end side 26A thereof is attached to the guiding pin 42 of the pawl 23. Further, the wire diameter of the twisted coil spring 26 is approximately half the height of the head of the pawl rivet 25 (for instance, approximately 0.6 mm wire diameter). Accordingly, the spring height of the single wind of the twisted coil spring 26 is set to have approximately the same height of the head of the pawl rivet 25.

Further, the other end side 26B of the twisted coil spring 26 is passed at the side wall portion 12 side of the one end side 26A in such a way as to be able to slide on the side wall portion 12, then bent approximately at an right angle inward the side wall portion 12 (backside of the side wall portion 12 in FIG. 4), and inserted into a mounting hole 46 formed at the side wall portion 12. The end portion of the other end side 26B is bent into a U-shape side and abuts on the inner surface of the side wall portion 12, to form a slip-prevention portion. As a result, the pawl 23 is urged to rotate in a direction deeper into the notch portion 38 (counterclockwise in FIG. 3) by the twisted coil spring 26, and the tip-side portion 37 including the engagement teeth 23A, 23B is made to abut on the innermost side of the notch portion 38. Thus, the pawl 23 is urged to rotate by the twisted coil spring 26 in a direction moving away from the ratchet gear 35.

Further, as illustrated in FIG. 2 through FIG. 4, below the through hole 36 of the side wall portion 12 (downward in FIG. 4), there is formed an opening portion 47 which is substantially square-shaped. The opening portion 47 is opened from a portion below the center axis of the through hole 36 (downward in FIG. 4) toward the back plate portion 31. The sensor cover 27 is fitted into the opening portion 47. The sensor cover 27 is shaped in a shallow box body which is substantially the same square shape as the opening portion 47, and fitted from the outside (front side in FIG. 4). There, the sensor cover 27 made of resin is made to abut on the outer periphery portion of the opening portion 47 (periphery on the front side in FIG. 4) at a brim portion formed at the periphery on the opening thereof. At the same time, as a pair of fixing claws 27A projecting at both end faces in the vertical direction in FIG. 4 of the sensor cover 27 (one of the fixing claws 27A on the upper end face is illustrated in FIG. 4) is inserted inward at the both sides in the vertical direction of the opening portion 47 in FIG. 4 and elastically locked.

Further, the acceleration sensor 28 includes a sensor holder 51, an inertia mass 52 and a sensor lever 53. The sensor holder 51 is made of resin, formed in an approximately box-like shape, opened on the vertically upper side (upper side in FIG. 4) and has a bowl-shaped mounting portion on a bottom face. The inertia mass 52 is made of metal such as steel formed into a spherical body and movably placed on the mounting portion. The sensor lever 53 is made of resin, placed on the vertically upper side of the inertia mass 52. The sensor holder 51 supports the sensor lever 53 at an end portion opposite to the pawl 23 (right end portion in FIG. 4), in a manner allowing vertical movement (in up/down direction in FIG. 4).

The sensor holder 51 has a pair of engagement claws 51A at both side face portions opposed to both side wall portions inside the sensor cover 27 (one of the engagement claws 51A is illustrated in FIG. 4). The acceleration sensor 28 is fitted into the sensor cover 27 so that the pair of engagement claws 51A is fitted into and locked at fixing holes 27B of the sensor cover 27. As a result, the acceleration sensor 28 is mounted onto the housing 11 through the sensor cover 27.

Further, the side wall portion 12 has mounting holes 55 into which the nylon latches 9A of the locking unit 9 are fitted, at three locations including both corners of the upper end portion (the upper end portion in FIG. 4) and the portion below the through hole 36 (the lower portion in FIG. 4). Further, engagement pieces 56 are funned at center portions (the center portions in vertical direction in FIG. 4) of right and left edge portions of the side wall portion 12, respectively. The engagement pieces 56 protrude orthogonal to the rotation axis of the take-up drum unit 6. The engagement pieces 56 are elastically engaged with locking hooks 9B of the locking unit 9, respectively.

Further, at a center in the side wall portion 13 is formed a through hole 57 into which the take-up drum unit 6 is inserted. Further, the side wall portion 13 has screw holes 58 into which the screws 15 are screwed and fixed, at three locations including the approximate center of the lower end portion (lower end portion in FIG. 2), the corner on a connecting member 33 side and the corner of the upper end portion (upper end portion in FIG. 2) and closer to the back plate portion 31. The screw holes 58 are formed by burring processing toward the pretensioner unit 7 side. The side wall portion 13 has a through hole 59 at the corner closer to a connecting member 32 of the upper end portion (upper end portion in FIG. 2). The stopper pin 16 is inserted through the through hole 59.

The bracket 21 is made of steel material or the like, and configured to be attached onto the upper end portion of the back plate portion 31 (the upper end portion in FIG. 2) by the rivets 61. The bracket 21 has a horizontally-long through hole 62, long in a width direction of the back plate portion 31, from which the webbing 3 is drawn out. The through hole 62 is formed in an extension portion extending approximately at a right angle from the upper end portion of the back plate portion 31 toward the connecting member 32. The horizontally long frame-like protector 22 made of synthetic resin such as nylon is fitted inside the through hole 62. A bolt insertion hole 63 is formed at the lower end portion of the back plate portion 31 (the lower end portion in FIG. 2). A bolt is inserted through the bolt insertion hole 63 when mounted onto a fastening piece of a vehicle (not shown).

### [Schematic Configuration of Take-Up Spring Unit]

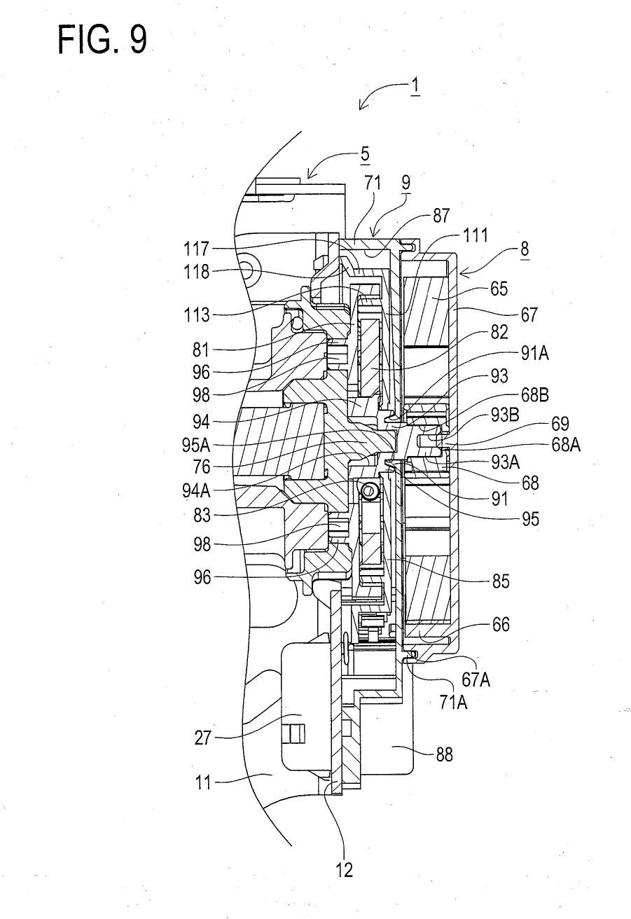

Next, a schematic configuration of the take-up spring unit 8 will be described based on FIG. 2, FIG. 3, FIG. 5, FIG. 6, and FIG. 9.

FIG. 5 and FIG. 6 each are an exploded perspective view of the locking unit 9 and the take-up spring unit 8 including the ratchet gear. FIG. 9 is an enlarged sectional view of a principal portion of the seatbelt retractor 1 including the take-up spring unit 8 and the locking unit 9.

As shown in FIG. 2, FIG. 3, FIG. 5, FIG. 6 and FIG. 9, the take-up spring unit 8 has a spiral spring 65, the spring case 67 and a spring shaft 68. The spring case 67 fixes an outer end 65A of the spiral spring 65 at a rib 66 projecting from the bottom face of the inner peripheral portion thereof, and accommodates this spiral spring 65. In the spring shaft 68, the inner end 65B of the spiral spring 65 is fitted so that the spring shaft 68 is urged by the spring force. The spring case 67 has a groove portion 67A of a predetermined depth (for instance, approximately 2.5 mm deep) on a substantially entire periphery at the end portion on the mechanism cover 71 side constituting the locking unit 9.

Further, the tabular engagement pieces 8A substantially rectangular shaped in front view are projecting at the end portion of the mechanism cover 71 side of the spring case 67, from three locations of the outer circumference portion. The engagement pieces 8A are projecting coaxially with regard to an axial center 73A of a through hole 73 formed in the substantially center portion of the mechanism cover 71. Further, outer circumferential surfaces radially outward with regard to the axial center 73A of the through hole 73 of the engagement pieces 8A are formed so as to be positioned on concentric circles.

As shown in FIG. 5 and FIG. 6, a fixation portion 8B is connected to the engagement piece 8A positioned in the lower end portion of the spring case 67. The fixation portion 8B has a square cross section, and is formed continuously to an end portion on the counterclockwise direction side with regard to the axial center 73A of the through hole 73. The fixation portion 8B has: a through hole 8C parallel to the axial center 73A of the through hole 73 at the substantial center of the fixation portion 8B; and a fixation pin 8D integrally formed so as to close an end portion of the through hole 8C on the outside in the axial center 73A direction.

Further, the shaft diameter of the fixation pin 8D is substantially the same as the inner diameter of the through hole 8C. Through pushing the fixation pin 8D toward the mechanism cover 71 side at a predetermined load or higher, the fixation pin 8D can be inserted inside the through hole 8C. The length of the fixation pin 8D is designed to be larger than the thickness of the fixation portion 8B.

The mechanism cover 71 has thick plate-like holding portions 72 projecting toward the take-up spring unit 8 side from three locations of the outer circumference portion facing the engagement pieces 8A, respectively. Each of the holding portions 72 is substantially rectangular shaped in cross section. As illustrated in FIG. 5, an engagement groove portion 72A is formed at a base end portion of each of the holding portions 72. The engagement groove portion 72A is cut-off in a counterclockwise direction with regard to the axial center 73A of the through hole 73, and closed at an innermost side end portion.

Further, in each engagement groove portion 72A, a bottom face portion on the outside radially with regard to the axial center 73A of the through hole 73 is formed so as to be disposed on concentric circles with a radius slightly larger (for instance, a radius larger by approximately 0.2-0.5 mm) than that of each radially outside end portion of the engagement pieces 8A of the spring case 67. The width dimension of the axial center 73A direction of each engagement groove portion 72A is designed to be substantially the same as the thickness dimension of each engagement piece 8A. The engagement pieces 8A are configured to be inserted inside the engagement groove portions 72A, respectively.

The mechanism cover 71 further has a substantially ring-like rib portion 71A, projecting along a peripheral portion outside with regard to a rotational axis direction of the take-up drum unit 6, at a predetermined height (for instance, a height of approximately 2 mm). The rib portion 71A is disposed at a position corresponding to the groove portion 67A. The inner diameter and outer diameter of the rib portion 71A are set so that, when the rib portion 71A is inserted in the groove portion 67A, a predetermined clearance (for instance, a clearance of approximately 0.1-0.3 mm) is formed, to each of the inner diameter and outer diameter of the groove portion 67A.

As illustrated in FIGS. 5 and 6, a fixation hole 74 is formed at a position to face the fixation pin 8D when the spring case 67 is mounted onto the mechanism cover 71. The fixation hole 74 is circular in cross section and located in vicinity of the holding portion 72 facing the lower end portion of the rib portion 71A, on a clockwise direction side with regard to the axial center 73A.

The inner diameter of the fixation hole 74 is formed so as to be smaller by a predetermined dimension (for instance, approximately by 0.1-0.3 mm) than the outer diameter of the fixation pin 8D of the spring case 67, and designed to allow press-fitting of the fixation pin 8D. Further, a cylindrical boss 75 is formed in a periphery of the fixation hole 74, on the inner back side thereof, namely, on the side wall portion 12 side of the housing 11. An inner back end of the cylindrical boss 75 is closed. The inner diameter of the cylindrical boss 75 is formed circular in cross section, with the same diameter as the fixation hole 74, and formed coaxially with regard to the fixation hole 74.

A method for mounting the take-up spring unit 8 onto the mechanism cover 71 will be described here.

As illustrated in FIG. 6, firstly, the outer end 65A of the spiral spring 65 is inserted in the rib 66 erected inside the spring case 67, and the spiral spring 65 is housed inside the spring case 67. Then the mounting groove 68C of the spring shaft 68 is fitted to the inner end 65B of the spiral spring 65.

Thereafter, as illustrated in FIGS. 5 and 6, a pin 69 is erected approximately at the center position of a bottom face portion of the spring case 67. The pin 69 is inserted into a through hole 68A in the bottom face portion of the spring shaft 68, to rotatably support the spring shaft 68 at the bottom face portion side.

Further, the engagement pieces 8A projecting radially outward from three locations on the outer circumference portion of the spring case 67 are positioned so as to face end portions on the clockwise direction side in front view of the holding portions 72 of the mechanism cover 71, respectively. Further, as illustrated in FIGS. 5 and 9, a locking gear 81 has a rotational axis portion 93 including a tip portion 93A. The tip portion 93A is configured to protrude from the through hole 73 of the mechanism cover 71 and formed in a rectangular cross-sectional shape. The tip portion 93A has a shaft hole 93B formed along the axial center, and configured to receive the insertion of the pin 69.

Thereafter, as illustrated in FIGS. 5, 6 and 9, the tip portion 93A of the rotational axis portion 93 of the locking gear 81 protrudes from the through hole 73 of the mechanism cover 71, and is fitted inside a cylindrical hole 68B of the spring shaft 68. The cylindrical hole 68B is formed in a rectangular cross-sectional shape. Accordingly, the rotational axis portion 93 of the locking gear 81 is connected relatively non-rotatably with regard to the spring shaft 68. At the same time, the rib portion 71A erected in the peripheral portion of the mechanism cover 71 is fitted inside the groove portion 67A of the spring case 67.

The spring case 67 is rotated in the webbing pull-out direction, namely, a counterclockwise direction in front view (in the counterclockwise direction in FIG. 5), the engagement pieces 8A of the spring case 67 are fitted inside the engagement groove portions 72A of the holding portions 72 of the mechanism cover 71, respectively, and abut on the inner back sides of the engagement groove portions 72A, respectively. Accordingly, the spring case 67 is positioned so as not to shift in radial direction or axial direction with regard to the axial center 73A of the through hole 73 of the mechanism cover 71.

Thereafter, the fixation pin 8D of the spring case 67 in this state is pushed and press-fitted inside the through hole 8C of the fixation portion 8B and the fixation hole 74 of the mechanism cover 71, so that the take-up spring unit 8 is fixed in a relatively non-rotatable manner with regard to the mechanism cover 71. Thus, the take-up spring unit 8 is installed, abutting on the outer side in the rotational axis direction of the take-up drum unit 6 of the mechanism cover 71.

As a result, the rib portion 71A erected in the peripheral portion of the mechanism cover 71 is fitted inside the groove portion 67A of the spring case 67, so that fine particles or dust can be prevented from entering inside the spring case 67. As illustrated in FIG. 9, in a state that the bottom face portion side of the mechanism cover 71 at the spring shaft 68 rotatably abuts on the peripheral portion of the pin 69, a predetermined clearance (for instance, a clearance of approximately 0.3 mm) is formed between the end portion of the spring shaft 68 on the locking unit 9 side, and the peripheral portion on the back side of the through hole 73 formed at the substantially center portion of the mechanism cover 71.

At the same time, a predetermined clearance (for instance, a clearance of approximately 0.3 mm) is also formed between the bottom surface of the cylindrical hole 68B of the spring shaft 68 and the tip portion 93A of the rotational axis portion 93 of the locking gear 81. Accordingly, the spring shaft 68 is provided movably in an axial direction of the axial center 73A by the amount of the predetermined clearance between the spring case 67 and the mechanism cover 71.

### [Schematic Configuration of Locking Unit]

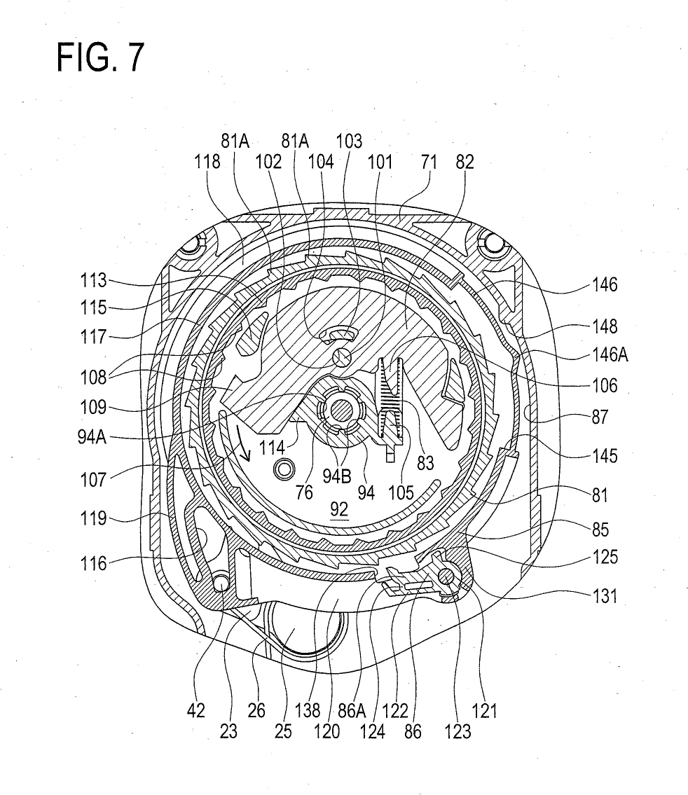

Next will be described a schematic configuration of the locking unit 9 composing the lock mechanism 10 that stops the pull-out of the webbing 3 in response to the abrupt pull-out of the webbing 3 or abrupt change in acceleration of a vehicle, referring to FIGS. 5 through 9. FIG. 7 is a cross sectional view of an assembled state including a locking arm of the locking unit 9. FIG. 8 is a partial cutaway sectional view showing the locking unit 9 with a bottom face portion of the mechanism cover 71 partially cut away.

As illustrated in FIG. 5 through FIG. 9, the locking unit 9 includes the mechanism cover 71, the locking gear 81, a locking arm 82, a sensor spring 83, a clutch 85 and a pilot lever 86. In the embodiment, the members included in the locking unit 9 are made of synthetic resin except the sensor spring 83. Thus, friction coefficient of contact between the members is quite small.

The mechanism cover 71 has a substantially box-shaped mechanism housing portion. 87 having a bottom face portion formed in substantially circular shape and opened on the side facing the side wall portion 12 of the housing 11, to house the locking gear 81, the clutch 85, and the like. Further, the mechanism cover 71 has a sensor housing portion 88. The sensor housing portion 88 is formed in a concave shape being rectangular in cross section, at a corner portion (downward left corner in FIG. 6) facing the acceleration sensor 28 attached to the housing 11 with the sensor cover 27.

The sensor holder 51 of the acceleration sensor 28 is configured to be fitted into the sensor housing portion 88 when the mechanism cover 71 is attached to the side wall portion 12 by the nylon latches 9A and the locking hooks 9B, so that the sensor lever 53 is housed in a vertically movable manner (in up/down direction in FIG. 6). Further, an opening portion 89 is opened to allow communication between the mechanism housing portion 87 and the sensor housing portion 88, on substantially middle of the lower end portion of the mechanism housing portion 87 of the mechanism cover 71 (substantially middle on the lower end portion in FIG. 6).

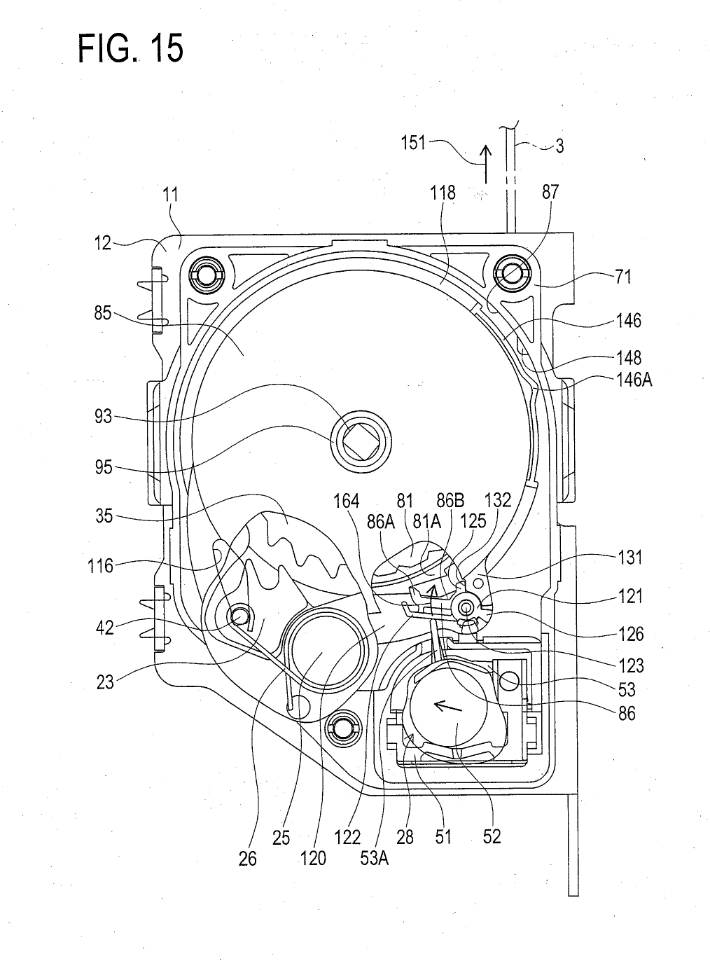

This opening portion 89 is formed to allow vertical movement (in up/down direction in FIG. 6) of the tip portion of a lock claw 53A. The lock claw 53A is projecting in upward direction (upward in FIG. 6) from a top end portion of the sensor lever 53 of the acceleration sensor 28. In normal time, the tip portion of the lock claw 53A is positioned in vicinity of a receiving plate portion 122 of the pilot lever 86 (refer to FIG. 8). As later described, when the inertia mass 52 is moved by acceleration exceeding a predetermined value to pivotally move the sensor lever 53 vertically upward, the lock claw 53A abuts on the receiving plate portion 122 of the pilot lever 86 through the opening portion 89 to pivotally move the pilot lever 86 vertically upward (refer to FIG. 15).

The mechanism housing portion 87 has a cylindrical supporting boss 91 projecting at a periphery of the through hole 73 formed in the center of the approximately circular-shaped bottom face portion thereof. A chamfered portion 91A is formed on the whole outer periphery of the tip portion of the supporting boss 91 on the locking gear 81 side, tapered toward the top with an inclination of a predetermined angle (for instance, approximately 30 degrees inclination). Further, the locking gear 81 has a disk-like bottom face portion 92 provided with the cylindrical rotational axis portion 93 projecting from the back side facing the mechanism cover 71, at the center portion thereof. The cylindrical rotational axis portion 93 is inserted into the supporting boss 91, and held slidably and rotatably.

The locking gear. 81 is formed as a circular ring-like projection projecting toward the clutch 85 side on the whole periphery of the disk-like bottom face portion 92 and has locking gear teeth 81A configured to engage with the pilot lever 86 on the outer peripheral portion thereof. A locking gear tooth 81A is formed to engage with an engagement claw portion 86A of the pilot lever 86 only when the locking gear 81 is rotated in the webbing pull-out direction (refer to FIG. 15).

As illustrated in FIG. 5, FIG. 6, FIG. 8 and FIG. 9, the center portion of the bottom face portion 92 of the locking gear 81 has a through hole, which fittingly receives a shaft portion 76 projecting at the center portion of the end face of the ratchet gear 35 on the locking gear 81 side. Further, a cylindrical pedestal portion 94 is formed projecting at the peripheral portion of the through hole on the mechanism cover 71 side, at a height substantially similar to the height in axial direction of the locking gear teeth 81A. Further, the cylindrical rotational axis portion 93 of the locking gear 81 is co-axially extended from the edge portion of the cylindrical pedestal portion 94 on the mechanism cover 71 side, at an outer diameter smaller than the pedestal portion 94 and substantially the same diameter as the inner diameter of the supporting boss 91, toward the mechanism cover 71 side. The end, portion on the mechanism cover 71 side of the cylindrical rotational axis portion 93 is closed and the tip portion 93A having a rectangular cross-sectional shape is coaxially extended.

Accordingly, inside the pedestal portion 94 and the rotational axis portion 93, there is formed a shaft hole portion 94A, circular shaped in cross section. The shaft hole portion 94A is opened at the end face of the locking gear 81 on the ratchet gear 35 side, and fittingly receives the shaft portion 76 projecting at the center portion of the end face of the ratchet gear 35 on the mechanism cover 71 side. Further, on the inner periphery of the shaft hole portion 94A, a plurality of ribs 94B are projecting along the axial direction at radially the same height, and configured to make contact with the outer periphery of the shaft portion 76 of the ratchet gear 35. Further, of a whole length of the shaft portion 76, an approximately half on the base end portion side is formed in a truncated cone, and the remaining approximately half on the tip portion side is shaped cylindrically, continuing to the truncated cone.

Around the base end portion of the rotational axis portion 93, a circular ring-like rib 95 is co-axially formed, at a height substantially the same as the thickness dimension of a substantially disk-like plate portion 111 of the clutch 85, and an insertion groove 95A is formed thereat. The inner circumferential wall portion of the circular ring-like rib 95 is inclined radially outward at an angle larger than the inclination of the tip portion of the supporting boss 91 (for instance, approximately 45 degrees inclination). Further, the outer diameter of the bottom face portion of the insertion groove formed inside the circular ring-like rib 95 is formed to be substantially the same as the outer diameter of the tip portion of the supporting boss 91.

Still further, the outer diameter of the circular ring-like rib 95 is formed substantially the same as the inner diameter of a through hole 112 formed at the center portion of the plate portion 111 of the clutch 85, and at the same time, smaller than the outer diameter of the pedestal portion 94. Further, a circular ring-like rib 112A is projecting for whole periphery of the edge portion of the through hole 112 of the clutch 85 on the locking gear 81 side, at a predetermined height (for instance, approximately 0.5 mm high).

Accordingly, the circular ring-like rib 95 of the locking gear 81 is fittingly inserted into the through hole 112 of the clutch 85 so as to make the circular ring-like rib 112A abut on the outer peripheral side of the base end portion of the rib 95, and then the rotational axis portion 93 is inserted into the supporting boss 91 of the mechanism cover 71. Then the tip portion of the supporting boss 91 is made to abut on the bottom face portion of the insertion groove formed radially inside the circular ring-like rib 95, so that the rotational axis portion 93 projecting from the backside of the locking gear 81 is attached co-axially with regard to the supporting boss 91 for substantially the whole height and is pivotally supported. Further, the circular ring-like rib 95 of the locking gear 81 is inserted into the through hole 112 slidably and rotatably, and the clutch 85 is housed between the locking gear 81 and the mechanism cover 71 in a manner rotatable within a predetermined rotation range.

As illustrated in FIG. 5, FIG. 6 and FIG. 9, the locking gear 81 has four convex portions 96 formed each projecting in a substantially rectangular pipe shape with a circumferentially long cross section, on the end face thereof on the ratchet gear 35 side. The four convex portions 96 are positioned at equal center angles, on a concentric circle a predetermined distance away (for instance, approximately 14 mm away) from a rotational axis 81B, radially outwardly. Incidentally, a radially outward peripheral portion of one convex portion 96 is partially cut off. On a bottom portion of the locking gear 81, a positioning hole 97 having a predetermined inner diameter (for instance, inner diameter of approximately 3.5 mm) is formed at a substantially center position between one pair of convex portions 96 neighboring in circumferential direction.

Further, the ratchet gear 35 has four through holes 98 each having substantially the same shape as a convex portion 96 of the locking gear 81. The four through holes 98 each have a substantially rectangular shape with a circumferentially long cross section, on an end face portion thereof facing the locking gear 81. The four through holes 98 are positioned at equal center angles, radially outwardly a predetermined distance away (for instance, approximately 14 mm away) from a rotational axis 81B, at positions corresponding to the convex portions 96, respectively.

Further, the end face portion facing the locking gear 81 of the ratchet gear 35 has a positioning pin 99 erected at a position between one pair of through holes 98 neighboring in circumferential direction, the position opposite to the positioning hole 97. The positioning pin 99 has substantially the same outer diameter as the inner diameter of the positioning hole 97. Further, the height of the shaft portion 76 erected on the end face outside in the rotational axis of the ratchet gear 35 is designed to be substantially the same as the depth of the shaft hole portion 94A of the locking gear 81. The depth of the shaft hole portion 94A of the locking gear 81 is configured such that the top of the shaft portion 76 is located on the inner side in rotational axis direction than the top of the tip portion 93A of the rotational axis portion 93.

Accordingly, while the shaft portion 76 of the ratchet gear 35 is inserted into the shaft hole portion 94A of the locking gear 81, the positioning pin 99 of the ratchet gear 35 is fitted into the positioning hole 97 of the locking gear 81, and at the same time, each convex portion 96 of the locking gear 81 is fitted into each through hole 98 of the ratchet gear 35. As a result, with the locking gear 81 abutting on the axially outside end face of the ratchet gear 35, the locking gear 81 is co-axially mounted onto the ratchet gear 35 so as to be relatively non-rotatable. The shaft portion 76 of the ratchet gear 35 is positioned within the supporting boss 91 of the mechanism cover 71 and pivotally supported through the rotational axis portion 93 of the locking gear 81.

Further, through the tip portion 93A of the rotational axis portion 93 of the locking gear 81, the ratchet gear 35 of the take-up drum unit 6 is mounted coaxially and relatively non-rotatably with on the spring shaft 68 of the take-up spring unit 8. Accordingly, the take-up drum unit 6 is constantly urged to rotate in the webbing take-up direction, through the take-up spring unit 8.

Further, as illustrated in FIGS. 5 through 9, a columnar supporting boss 101 is projecting on the surface of the bottom face portion 92 of the locking gear 81 on the clutch 85 side. The columnar supporting boss 101 is projecting adjacent to the pedestal portion 94, at a height lower than the locking gear teeth 81A. The locking arm 82 made of synthetic resin is formed into approximately an arch shape so as to surround the pedestal portion 94. In the locking arm 82, a through hole 102 is formed in the edge portion at the approximately center portion in longitudinal direction on the pedestal portion 94 side, and the supporting boss 101 is rotatably inserted into the through hole 102 so that the locking arm 82 is rotatably supported.

The bottom face portion 92 of the locking gear 81 has an elastic engagement piece 103 projecting at a position in vicinity of the radially outside of the supporting boss 101, on the mechanism cover 71 side. The elastic engagement piece 103 is reverse-L shaped in cross section. This elastic engagement piece 103 is inserted into a window portion 104 formed next to the through hole 102 of the locking arm 82, and engaged elastically and rotatably around the axis of the pedestal portion 94. The window portion 104 is formed in an approximately fan-like shape and has a stepped portion.

Further, as illustrated in FIGS. 7 and 8, in the locking gear 81, a spring supporting pin 105 is projecting on the rib portion extended radially outward from the outer periphery of the pedestal portion 94. One end side of the sensor spring 83 is fitted onto the spring supporting pin 105. The spring supporting pin 105 is projecting in webbing pull-out direction perpendicular to the axial center of the pedestal portion 94. Further, at the locking arm 82, a spring supporting pin 106 is projecting on the side wall facing the spring supporting pin 105, and the other end side of the sensor spring 83 is fitted into the spring supporting pin 106.

Accordingly, as illustrated in FIGS. 7 and 8, by putting both ends of sensor spring 83 onto the spring supporting pins 105, 106, respectively, the locking arm 82 is urged with a predetermined load so as to rotate toward the webbing pull-out direction side (direction of arrow 107 in FIG. 7) centering the axis of the supporting boss 101. Further, the locking arm 82 has an engagement claw 109 configured to engage with a clutch gear 108 of the clutch 85, and at an edge portion on the engagement claw 109 side, abuts on a stopper 114 projecting radially outward from the pedestal portion 94 of the locking gear 81.

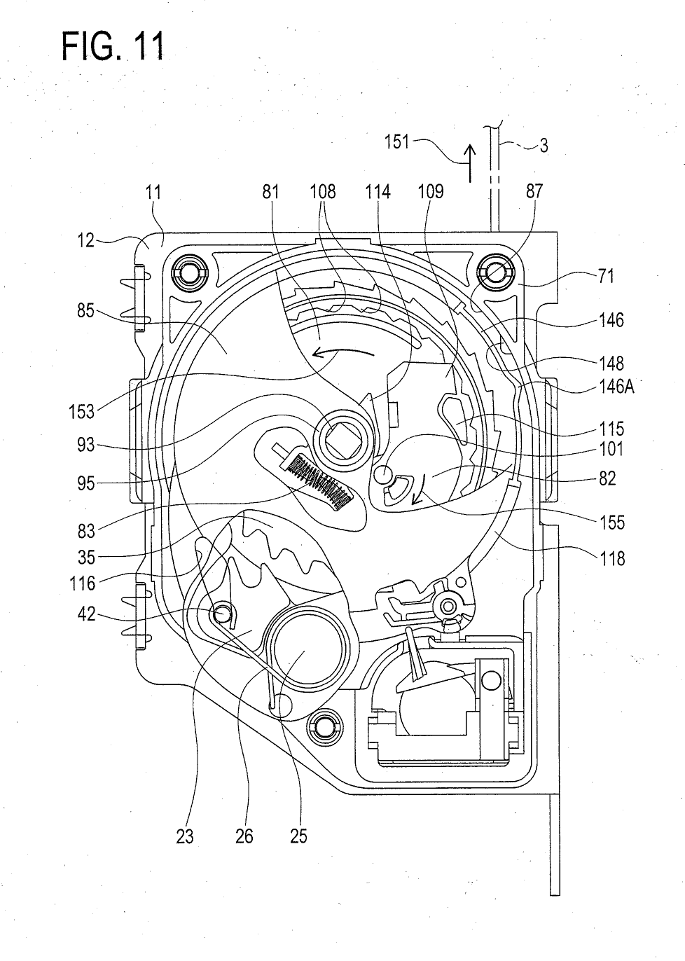

Meanwhile, as later described, when the locking arm 82 is rotated in webbing take-up direction (direction opposite to arrow 107 in FIG. 7) against the urging force of the sensor spring 83 and is engaged with the clutch gear 108, an edge portion opposite to the engagement portion of the engagement claw 109 forms a predetermined clearance (for instance, approximately 0.3 mm clearance) with a rotation restrictor 115 formed at the bottom face portion 92 of the locking gear 81. The rotation restrictor 115 is spindle-shaped in cross section (refer to FIG. 11).

Further, as illustrated in FIGS. 5 through 9, the clutch 85 is housed in a manner rotatable within a predetermined rotation range in the mechanism housing portion 87, while being held between the locking gear 81 and the mechanism cover 71. On the locking gear 81 side of the clutch 85, there is provided a circular ring-like rib portion 113. The circular ring-like rib portion 113 is co-axially formed with regard to the through hole 112, and has a slightly smaller outer diameter than the inner periphery of the circular ring-like projection of the locking gear 81 having the locking gear teeth 81A on the outer periphery portion thereof.

The rib portion 113 has the clutch gear 108 configured to engage with the engagement claw 109 of the locking arm 82, on the inner periphery thereof (refer to FIG. 11). The clutch gear 108 is to engage with the engagement claw 109 of the locking arm 82 only when the locking gear 81 is rotated in the webbing pull-out direction around the axis of the through hole 112 (refer to FIG. 11).

Further, a circular ring-like outer rib portion 117 is formed at the outer peripheral portion of the substantially disk-like plate portion 111 of the clutch 85, so as to surround the rib portion 113. Further, on the whole periphery of the edge portion of the outer rib portion 117 on the ratchet gear 35 side, a flange portion 118 is formed, extending radially outward with respect to the central axis of the through hole 112, being slightly slanted toward the ratchet gear 35 side.

The outer rib portion 117 has a guiding block portion 119 extended on a portion opposing the pawl 23 (lower left corner portion in FIG. 7). The guiding block portion 119 is extended from the outer periphery of the outer rib portion 117 downward in vertical direction (downward in FIG. 5). The guiding block portion 119 has a long guiding hole 116 into which the guiding pin 42 formed on the side face of the tip portion including engagement teeth 23A, 23B of the pawl 23 is movably engaged from the ratchet gear 35 side.

The guiding hole 116 is, as illustrated in FIG. 8, formed at a corner portion opposed to the pawl 23 of the outer rib portion 117 into a long groove-like shape substantially parallel to the webbing pull-out direction (vertical direction in FIG. 8). Accordingly, when the clutch 85 is rotated in the webbing pull-out direction (direction of arrow 107 in FIG. 7) as later described, the guiding pin 42 is moved along the guiding hole 116, and the engagement teeth 23A, 23B of the pawl 23 are rotated so as to come closer to the ratchet gear portion 35A of the ratchet gear 35 (refer to FIGS. 11 through 13).

Further, the pawl 23 is rotatably urged in a direction away from the ratchet gear 35 by the twisted coil spring 26, and the guiding pin 42 of the pawl 23 movably engaged at the guiding hole 116 urges the clutch 85. The clutch 85 is urged by this urging force so as to achieve a rotated state where the guiding pin 42 of the pawl 23 makes contact with the edge portion of the guiding hole 116 (lower edge portion of the guiding hole 116 in FIG. 7) located farthest away from the ratchet gear 35 in radial direction of the rotation of the clutch 85, so that the clutch 85 is rotatably urged in the direction opposite to the webbing pull-out direction. Thus, a clutch urging mechanism 129 is configured by the pawl 23 and the twisted coil spring 26.

At the same time, as the guiding pin 42 of the pawl 23 is made to have contact with the edge portion of the guiding hole 116 (lower edge portion of the guiding hole 116 in FIG. 7) located farthest away from the ratchet gear 35 in the radial direction of the rotation of the clutch 85 to regulate the rotation of the pawl 23 in normal occasion, the pawl 23 is held to be positioned in vicinity of the rear side of the notch portion 38 formed at the side wall portion 12.

Further, an extending portion 120 is extended in a plate-like shape, radially outward in approximately arc-like shape from the flange portion 118, on the lower edge portion of the outer rib portion 117 of the clutch 85 (lower edge portion in FIG. 6). The extending portion 120 extends from the end face portion of the guiding block portion 119 on the ratchet gear 35 side, to the portion facing the upper portion of the sensor housing portion 88 (upper direction in FIG. 6). Further, as illustrated in FIGS. 5 through 8, in vicinity of the edge portion opposite to the guiding block portion 119, the extending portion 120 has a mounting boss 123 on the mechanism cover 71 side at substantially the same height as the outer rib portion 117. The mounting boss 123 is thin columnar shaped and to be inserted into a cylindrical sleeve portion 121 of the pilot lever 86 (refer to FIG. 5).

Here, as illustrated in FIGS. 5 through 8, the pilot lever 86 includes the cylindrical sleeve portion 121, the plate-like engagement claw portion 86A, the thin-plate-like receiving plate portion 122, and a thin-plate-like connecting plate portion 124. The length of the sleeve portion 121 in axial direction is set substantially the same as the height of the mounting boss 123 erected at the extending portion 120. Further, the plate-like engagement claw portion 86A is formed approximately L shaped when viewed in the rotation axis direction, with the tip portion thereof obliquely bent toward the locking gear 81 side. Further, the plate-like engagement claw portion 86A is projecting from the outer periphery of the sleeve portion 121 to the guiding hole 116 side, in a predetermined length and at a width shorter than the length of the sleeve portion 121. The plate-like engagement claw portion 86A is projecting so as to be substantially horizontal when the pilot lever 86 is rotated by its own weight to regulate downward rotation in vertical direction.

Further, the thin-plate-like receiving plate portion 122 is projecting from the outer periphery of the sleeve portion 121 to the guiding hole 116 side in tangential direction so as to oppose to the engagement claw portion 86A, and the tip portion is obliquely bent so as to be substantially parallel with the tip side of the engagement claw portion 86A. The thin-plate-like connecting plate portion 124 is formed to connect the tip portions of the engagement claw portion 86A and the receiving plate portion 122. In vicinity of the base end portion of the engagement claw portion 86A, an upward rotation restrictor portion 125 is projecting radially outward from the outer periphery of the sleeve portion 121. The upward rotation restrictor portion 125 regulates the rotation of the pilot lever 86 in a direction of the locking gear 81 side, namely, the rotation upward in vertical direction. Further, the upward rotation restrictor portion 125 is projecting at substantially the same width dimension of the width of engagement claw portion 86A and at a predetermined height (for instance, approximately 1.5 mm high) so as to form a right angle with the base end portion of the engagement claw portion 86A.

The sleeve portion 121 has a downward rotation restrictor portion 126 on a side opposite to the receiving plate portion 122 in a direction of the tangent line. The downward rotation restrictor portion 126 projects radially outward from an outer circumferential surface of the sleeve portion 121, and restricts the rotation of the pilot lever 86 in a direction of the sensor lever 53 side, in other words, the rotation in vertically downward direction. The downward rotation restrictor portion 126 projects, from the end portion opposite to the ratchet gear 35 of the sleeve portion 121, at a width dimension in the rotational axis direction narrower than the width of receiving plate portion 122 in the rotational axis direction and at a predetermined height (for instance, approximately 1.5 mm high) so as to face the base end portion of the receiving plate portion 122.

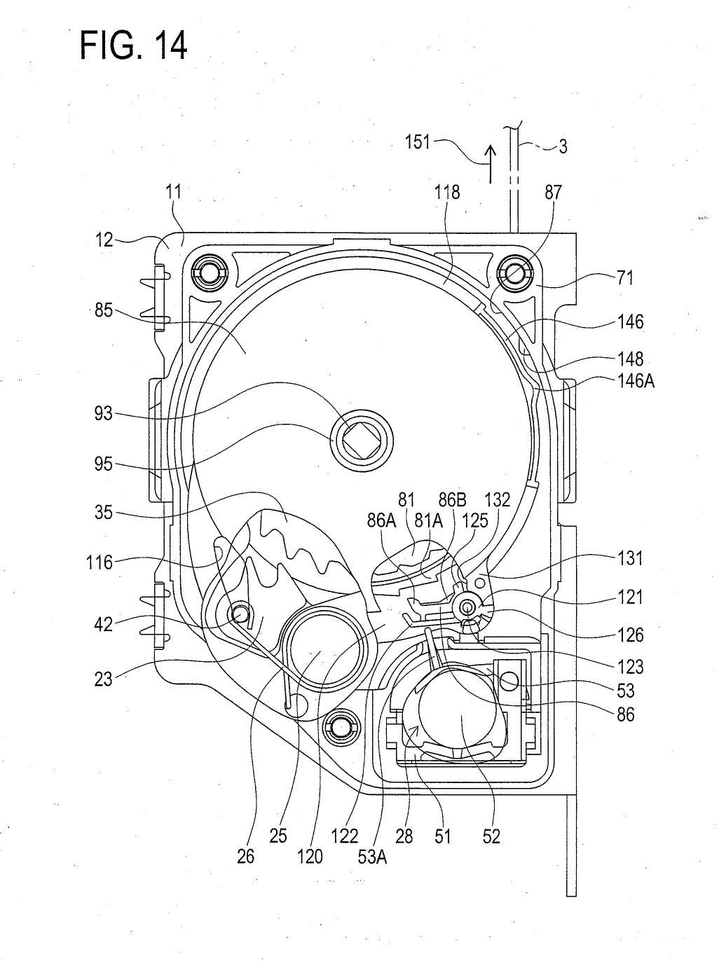

As illustrated in FIGS. 7 and 8, at the edge portion of the extending portion 120 facing to the mounting boss 123, a pilot lever supporting block 131 is projecting toward the mechanism cover 71 side at a substantially the same height with the outer rib portion 117. On the inner surface of the pilot lever supporting block 131 facing the mounting boss 123, an upward rotation restricting end face portion 132 is formed (refer to FIG. 14). The upward rotation restricting end face portion 132 is configured to make contact with the upward rotation restrictor portion 125 when the pilot lever 86 is rotated toward the locking gear 81 side.

A load receiving surface is formed on the inner surface of the pilot lever supporting block 131 facing the mounting boss 123, extending further from the upward rotation restricting end face portion 132 to an end portion on the vertical downward side of the extending portion 120, formed co-axially with the mounting boss 123 into an approximately semicircular smooth curved face in front view at a radius curvature slightly larger (for instance, approximately 0.1 mm larger) than the radius of the outer periphery of the sleeve portion 121 of the pilot lever 86.

The end portion on the vertically downward side of the pilot lever supporting block 131 has a stepped portion formed by cutting-off at a predetermined height toward the extending portion 120 side thereon, and a downward rotation restricting end face portion configured to abut on the downward rotation restrictor portion 126 when the pilot lever 86 rotates by its own weight.

Further, as illustrated in FIGS. 7 and 8, an opening portion 138 penetrating in vertical direction is formed on the outer rib portion 117, at a location that the engagement claw portion 86A of the pilot lever 86 faces. The opening portion 138 is formed by cutting out the outer rib portion 117 at a predetermined dimension and at a predetermined circumferential width, to a portion more inward than the edge portion of the plate portion 111. As later described, the opening portion 138 is formed so as to allow the engagement claw portion 86A to enter the opening portion 138 and engage with a locking gear tooth 81A, when the engagement claw portion 86A is pushed and rotated by the lock claw 53A of the sensor lever 53 (refer to FIG. 15).

Further, as illustrated in FIG. 8, when the pilot lever 86 is rotated by its own weight to the lower side in vertical direction (in lower direction in FIG. 8), a downward rotation restrictor portion 126 makes contact with the pilot lever supporting block 131 to regulate the rotation angle to the lower side in a vertical direction (in lower direction in FIG. 8). Further, in a normal state, the receiving plate portion 122 of the pilot lever 86 and the lock claw 53A of the sensor lever 53 have a clearance therebetween.

As illustrated in FIGS. 6 through 8, the flange portion 118 of the clutch 85 has a cutout portion 145 on a side substantially opposite to the through hole 112 of the guiding block portion 119. The flange portion 118 is cut out to the outer rib portion 117, at a predetermined center angle (for instance, at a center angle of approximately 60 degrees) with regard to an axial center of the through hole 112, to form the cutout portion 145. An elastic rib 146 is formed between both end portions of the cutout portion 145 in circumferential direction with regard to the axial center of the through hole 112, at a width narrower than the width of the flange portion 118, from one end portion to the other end portion. The elastic rib 146 has a circular-arc rib-like shape concentric with the axial center of the through hole 112.

At the circumferential center portion of this elastic rib 146, a clutch side projecting portion 146A is formed approximately U-shaped in cross section. The clutch side projecting portion 146A is projecting at a predetermined height (for instance, approximately 1.2 mm high) radially further outward than the outer periphery of the flange portion 118. Further, the elastic rib 146 having a rib-like shape is formed elastically deformable such that, the clutch side projecting portion 146A formed in the circumferential center portion is allowed to move radially further inward than the outer periphery of the flange portion 118, when the clutch side projecting portion 146A is pressed radially inward.

In the mechanism housing portion 87 of the mechanism cover 71, an inner circumferential wall facing the flange portion 118 of the clutch 85 is formed concentrically with regard to the axial center 73A of the through hole 73, arranged to face the flange portion 118 with a predetermined clearance (for instance, a clearance of approximately 1.5 mm) therebetween.

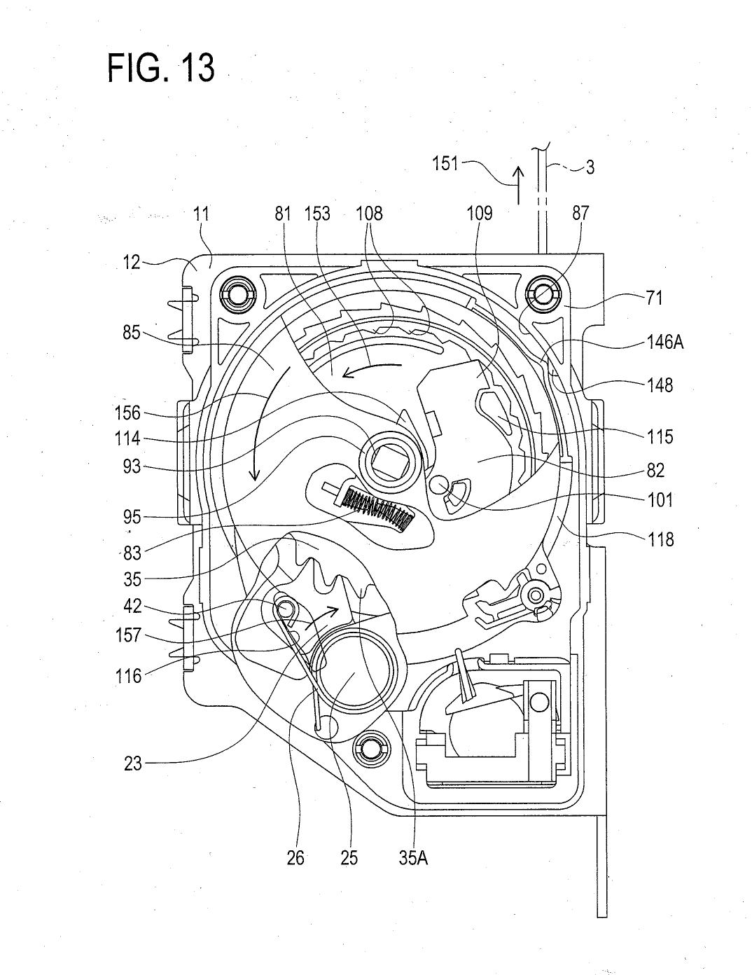

Further, on the inner circumferential wall of the mechanism housing portion 87, a rib-like fixed side projecting portion 148 is erected along the axial center 73A direction (refer to FIG. 13), in a portion opposite to the elastic rib 146 of the clutch 85. The rib-like fixed side projecting portion 148 is formed at a location over which the clutch side projecting portion 146A can ride, when the clutch 85 rotates in the webbing pull-out direction and the pawl 23 engages with the ratchet gear portion 35A of the ratchet gear 35, as later described. The fixed side projecting portion 148 is formed from the inner circumferential wall of the mechanism housing portion 87 to the radially inner side, in a substantially semicircular shape in cross section, projecting at a predetermined height (for instance, approximately 1.2 mm high).

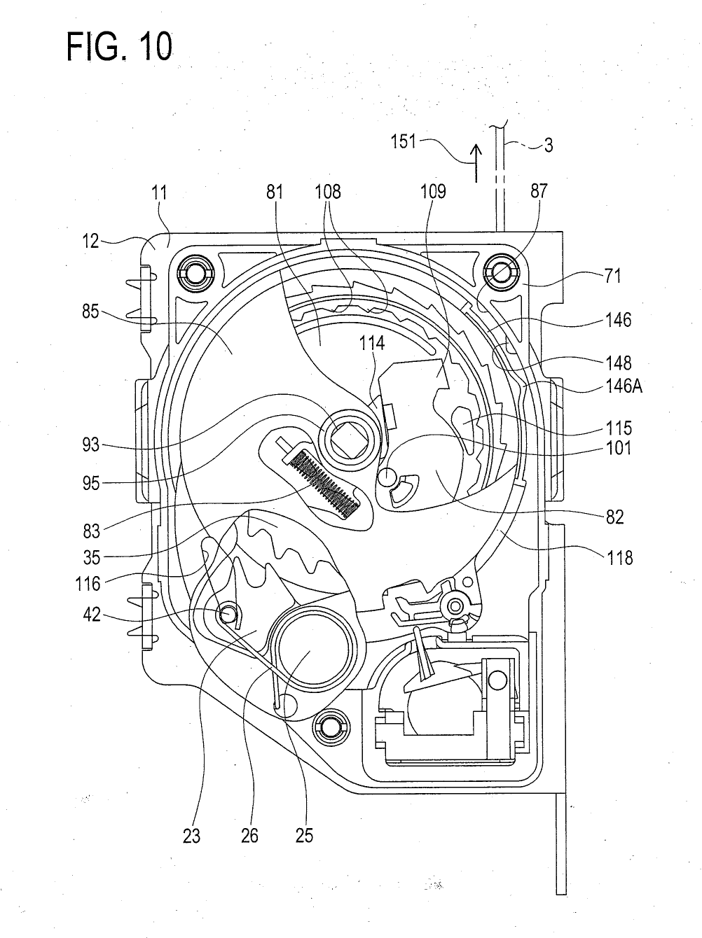

Next, the operation of the lock mechanism 10 will be described referring to FIGS. 10 through 17. In each figure, the pull out direction of the webbing 3 is indicated by arrow 151. Further, in each figure, the counterclockwise direction is the direction of the rotation of the take-up drum unit 6 when the webbing 3 is pulled out (webbing pull-out direction). Some parts on the drawings are cut off for the convenience of illustrating the operation of the lock mechanism 10, when necessitated.

Here, the lock mechanism 10 operates two types of lock mechanisms, including a “webbing-sensitive lock mechanism” which is activated in response to sudden pull-out of the webbing 3, and a “vehicle-body-sensitive lock mechanism” which is activated in response to acceleration caused by vehicle rocking or tilting. The “webbing-sensitive lock mechanism” and the “vehicle-body-sensitive lock mechanism” have a common operation with respect to the pawl 23. Accordingly, FIGS. 10 through 17 are depicted in a state with some portion cut off to reveal the relation between the pawl 23 and the ratchet gear 35.

### [Description of Operation in Webbing-Sensitive Lock Mechanism]

First, the operation of the “webbing-sensitive lock mechanism” will be described referring to FIGS. 10 through 13. FIGS. 10 through 13 each are a view for illustrating an operation of the “webbing-sensitive lock mechanism” To illustrate the “webbing-sensitive lock mechanism,” other portions are cut off to reveal the relation between the locking arm 82 and the clutch gear 108, and to reveal the operation of the sensor spring 83, in addition to the portion cut off to reveal the relation between the pawl 23 and the ratchet gear 35.

As illustrated in FIGS. 10 and 11, the locking arm 82 is rotatably supported by the supporting boss 101 of the locking gear 81, so that when the acceleration to pull out the webbing 3 exceeds a predetermined acceleration (for instance, approximately 2.0 G, regarding 1G⇄9.8 m/s²), an inertial delay is generated in the locking arm 82, to the rotation of the locking gear 81 in the webbing pull-out direction (in a direction of arrow 153).

As a result, the locking arm 82 abutting on the stopper 114 maintains the initial position against the urging force of the sensor spring 83, rotates clockwise (in a direction of arrow 155) centering the supporting boss 101 with regard to the locking gear 81, to the vicinity of the rotation restrictor 115. Accordingly, the engagement claw 109 of the locking arm 82 is rotated radially outward with regard to the rotational axis of the locking gear 81, and engaged with the clutch gear 108 of the clutch 85.

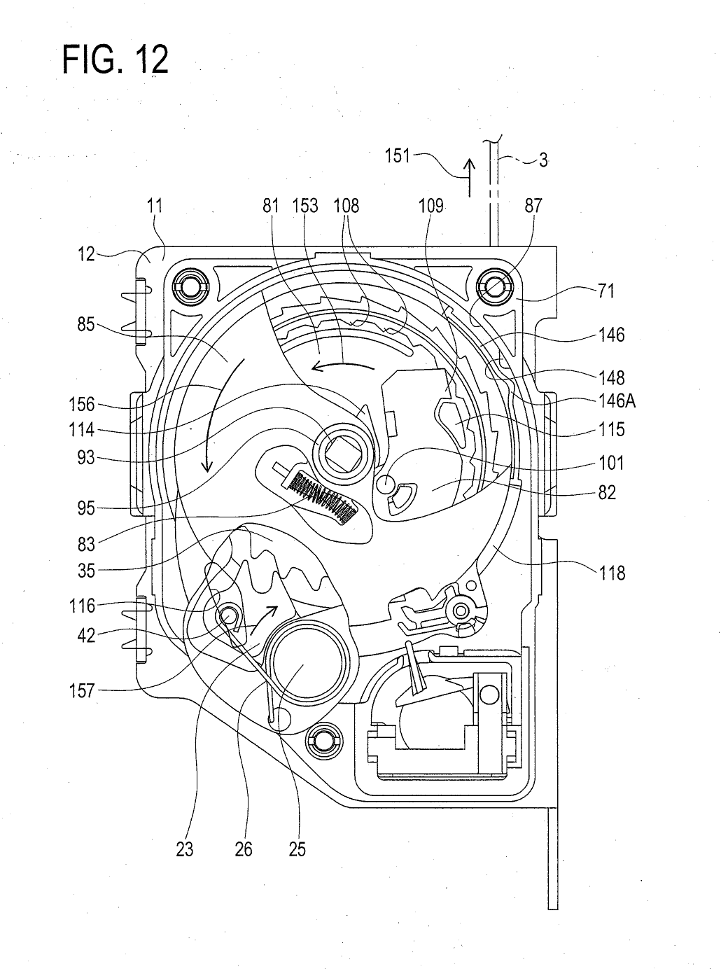

As illustrated in FIGS. 11 and 12, when the pull out of the webbing 3 is continued exceeding the predetermined acceleration, the locking gear 81 further rotates in the webbing pull-out direction (in the direction of arrow 153), so that the engagement claw 109 of the locking arm 82 is rotated in the webbing pull-out direction (in the direction of arrow 153) while being engaged with clutch gear 108.

Accordingly, as the clutch gear 108 is rotated in the webbing pull-out direction (in a direction of arrow 156) by the locking arm 82, the clutch 85 is rotated in the webbing pull-out direction (in the direction of arrow 156) around the axial center of the rib 95 of the locking gear 81, namely, around the axial center of the rotational axis portion 93, against the urging force of the guiding pin 42 of the pawl 23 rotatably urged by the twisted coil spring 26 in the direction away from the ratchet gear 35.

Thus, along the rotation of the clutch 85 in the webbing pull-out direction (in the direction of arrow 156), the guiding pin 42 of the pawl 23 is guided by the guiding hole 116 of the clutch 85, so that the pawl 23 is rotated toward the ratchet gear 35 side (in a direction of arrow 157) against the urging force of the twisted coil spring 26. The clutch side projecting portion 146A of the elastic rib 146 is formed elastically deformable toward the radially inside, on the flange portion 118 on the substantially diametrically opposite side of the guiding hole 116 of the clutch 85. The clutch side projecting portion 146A of the elastic rib 146 is also rotated in a direction of the fixed side projecting portion 148 erected on the inner circumferential wall of the mechanism housing portion 87 of the mechanism cover 71, together with the rotation of the clutch 85.

As illustrated in FIG. 13, if the pull-out of the webbing 3 exceeding the predetermined acceleration is herewith further continued, the clutch 85 is further rotated in the webbing pull-out direction (in the direction of arrow 156) against the urging force of the guiding pin 42 of the pawl 23 rotatably urged by the twisted coil spring 26 in the direction away from the ratchet gear 35. Accordingly, the guiding pin 42 of the pawl 23 is further guided by the guiding hole 116 of the clutch 85, and the pawl 23 is engaged with the ratchet gear 35, against the urging force of the twisted coil spring 26. Accordingly, the rotation of the take-up drum unit 6 is locked, and thus the pull out of the webbing 3 is locked.

Further, as the clutch side projecting portion 146A is further rotated toward the side having the fixed side projecting portion 148 erected on the inner circumferential wall of the mechanism housing portion 87, the elastic rib 146 of the clutch 85 makes contact with and is pressed by the fixed side projecting portion 148, and elastically deforms radially inward, and smoothly rides over the fixed side projecting portion 148. Then, each of the engagement teeth 23A, 23B of the pawl 23 makes contact with the ratchet gear portion 35A of the ratchet gear 3, stopping the rotation of the pawl 23, so that the clutch 85 stops rotating in the webbing pull-out direction (in a direction of arrow 156) at a position where the fixed side projecting portion 148 is overridden by the clutch side projecting portion 146A of the elastic rib 146.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

### [Description of Operation in Vehicle-Body-Sensitive Lock Mechanism]

Next, the locking operation of the “vehicle-body-sensitive lock mechanism” will be described referring to FIGS. 14 through 17. FIGS. 14 through 17 are explanatory views depicting the operations of “vehicle-body-sensitive lock mechanism.” To illustrate the “vehicle-body-sensitive lock mechanism,” other portions are cut off to reveal the relation between the pilot lever 86 and the locking gear 81, and to reveal the relation between the sensor holder 51 and the sensor lever 53 of the vehicle acceleration sensor 28, in addition to the portion cut off to reveal the relation between the pawl 23 and the ratchet gear 35.

### [Normal Locking Operation]

As illustrated in FIGS. 14 and 15, the spherical inertia mass 52 of the acceleration sensor 28 is placed on a bowl-like bottom face portion of the sensor holder 51, and moves on the bottom face portion of the sensor holder 51 to pivotally move the sensor lever 53 upward in vertical direction, if the acceleration due to rocking or tilting of the vehicle body exceeds the predetermined acceleration (for instance, approximately 2.0 G).

Thus, the lock claw 53A of the sensor lever 53 makes contact with the receiving plate portion 122 of the pilot lever 86 rotatably attached to the mounting boss 123 formed at the extending portion 120 of the clutch 85, to rotate the pilot lever 86 upward in vertical direction. Accordingly, the pilot lever 86 is rotated clockwise (in a direction of arrow 164) around the axial center of the mounting boss 123, and the engagement claw portion 86A of the pilot lever 86 enters inside the opening portion 138 of the clutch 85 (refer to FIG. 8), and is engaged with a locking gear tooth 81A formed at the outer peripheral portion of the locking gear 81. Here, a predetermined clearance (for instance, approximately 0.1 mm clearance) is formed between the upward rotation restrictor portion 125 and the upward rotation restricting end face portion 132 of the pilot lever supporting block 131.

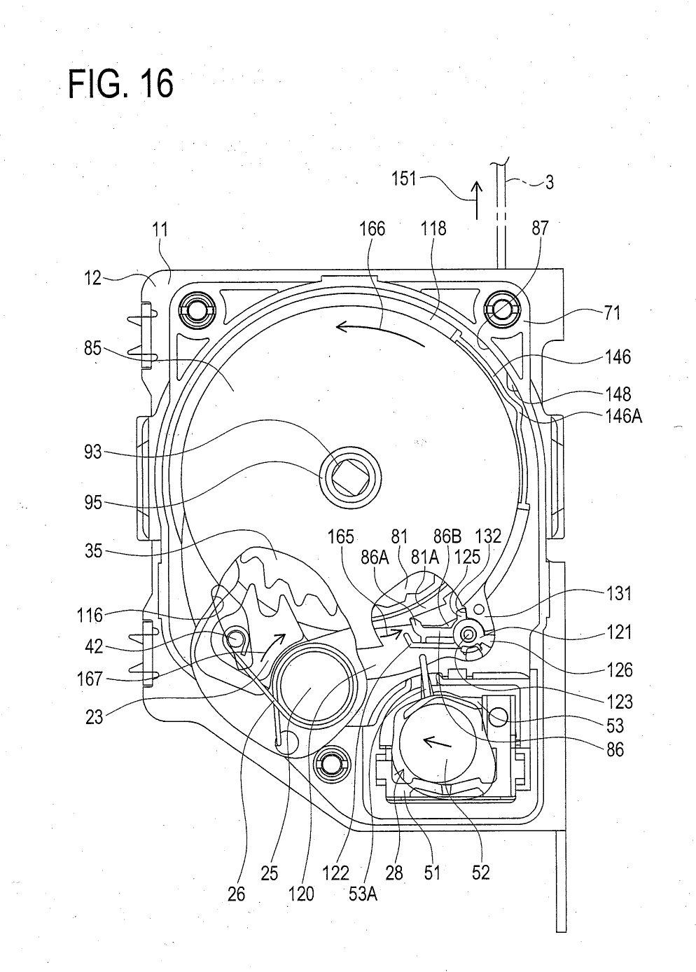

Then, as illustrated in FIGS. 15 and 16, when the webbing 3 is pulled out while the pilot lever 86 is engaged with the locking gear tooth 81A of the locking gear 81, the locking gear 81 is rotated in the webbing pull-out direction (in a direction of arrow 165). Further, if the mounting boss 123 is deformed by a load applied to the engagement claw portion 86A of the pilot lever 86, the outer peripheral surface of the sleeve portion 121 abuts on the inner surface of the pilot lever supporting block 131. Accordingly, the rotation of the locking gear 81 in the webbing pull-out direction is transmitted to the clutch 85, through the pilot lever 86, the mounting boss 123 and the pilot lever supporting block 131.

Accordingly, in response to the rotation of the locking gear 81 in the webbing pull-out direction, the clutch 85 is rotated around the axial center of the rib 95 of the locking gear 81, namely, around the axial center of the rotational axis portion 93 in the webbing pull-out direction (in a direction of arrow 166), against the urging force by the guiding pin 42 of the pawl 23 rotatably urged by the twisted coil spring 26 in the direction away from the ratchet gear 35.

Thus, along the rotation of the clutch 85 in the webbing pull-out direction (in the direction of arrow 166), the guiding pin 42 of the pawl 23 is guided by the guiding hole 116 of the clutch 85, so that the pawl 23 is rotated toward the ratchet gear 35 side (in a direction of arrow 167). The clutch side projecting portion 146A of the elastic rib 146 is formed elastically deformable toward the radially inside, on the flange portion 118 on the substantially diametrically opposite side of the guiding hole 116 of the clutch 85. The clutch side projecting portion 146A of the elastic rib 146 is also rotated in a direction of the fixed side projecting portion 148 erected on the inner circumferential wall of the mechanism housing portion 87 of the mechanism cover 71, together with the rotation of the clutch 85.

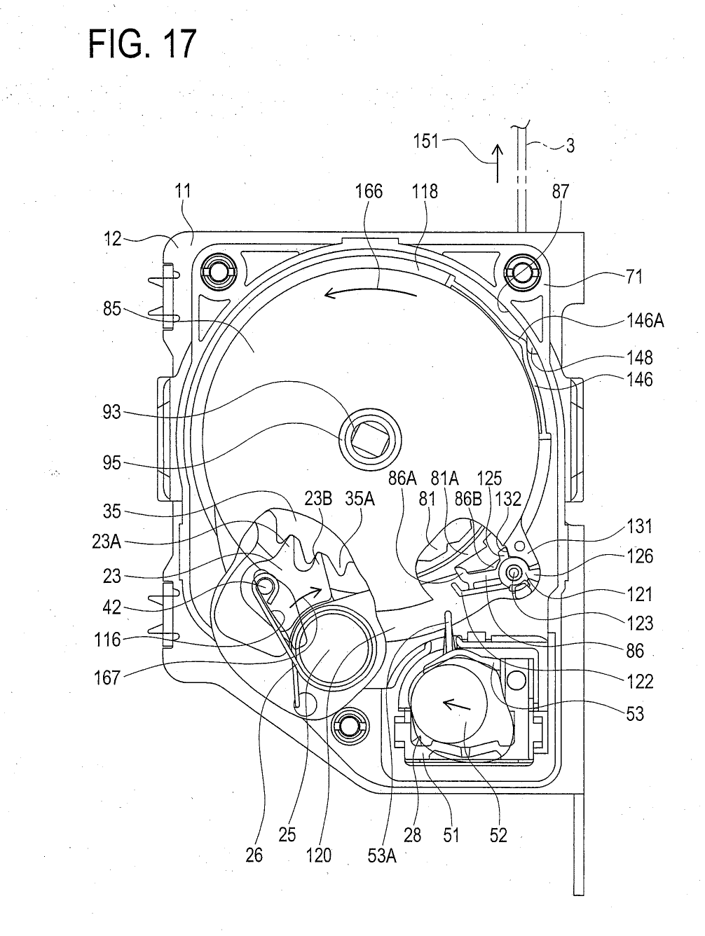

Accordingly, as illustrated in FIG. 17, if the webbing 3 is continuously pulled out, the clutch 85 is further rotated in the webbing pull-out direction (in the direction of arrow 166), against the urging force by the guiding pin 42 of the pawl 23 rotatably urged by the twisted coil spring 26 in the direction away from the ratchet gear 35. Thereby, the guiding pin 42 of the pawl 23 is guided by the guiding hole 116 of the clutch 85, and each of the engagement teeth 23A and 23B of the pawl 23 is engaged with the ratchet gear portion 35A of the ratchet gear 35. Thus, the rotation of the take-up drum unit 6 is locked, and thus the pull-out of the webbing 3 is locked.

Further, as the clutch side projecting portion 146A is further rotated toward the side having the fixed side projecting portion 148 erected on the inner circumferential wall of the mechanism housing portion 87, the elastic rib 146 of the clutch 85 makes contact with and is pressed by the fixed side projecting portion 148, and elastically deforms radially inward, and smoothly rides over the fixed side projecting portion 148. Then, each of the engagement teeth 23A, 23B of the pawl 23 makes contact with the ratchet gear portion 35A of the ratchet gear 3, stopping the rotation of the pawl 23, so that the clutch 85 stops rotating in the webbing pull-out direction (in a direction of arrow 166) at a position where the fixed side projecting portion 148 is overridden by the clutch side projecting portion 146A of the elastic rib 146.

There, the clutch side projecting portion 146A of the elastic rib 146, which is formed projecting radially outward from the outer circumference portion of the clutch 85, deforms radially inward elastically, and then rides over the fixed side projecting portion 148 provided on the inner circumferential wall of the mechanism housing portion 87, and makes contact with, or is positioned in the vicinity of, a side portion on the webbing pull-out side of the fixed side projecting portion 148.

### [Schematic Configuration of Take-Up Drum Unit]

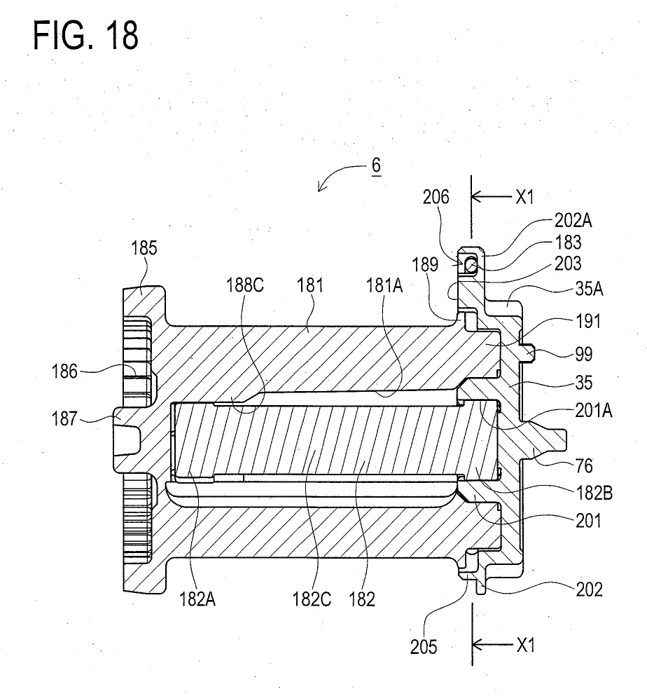

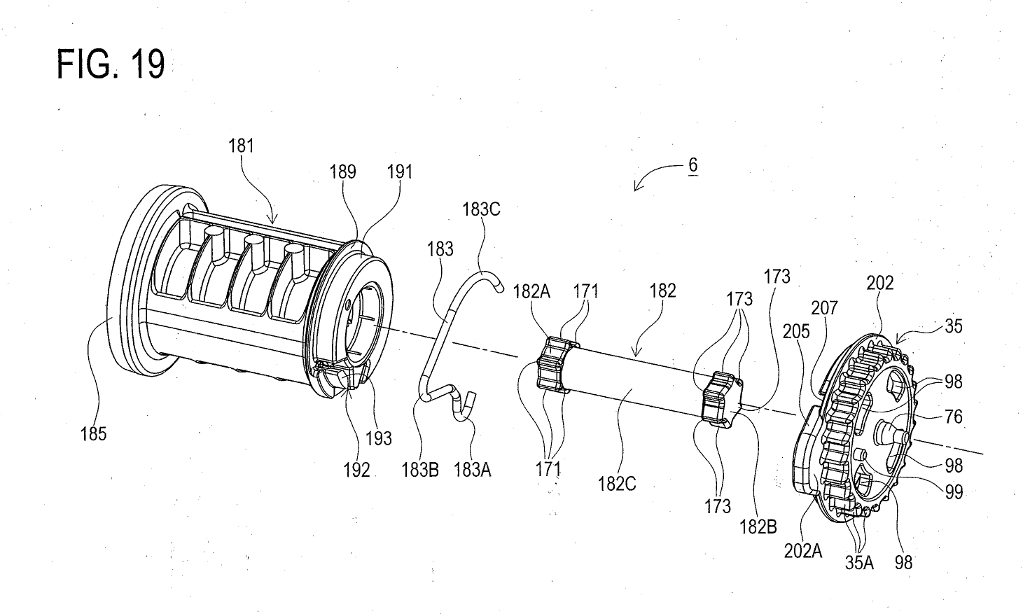

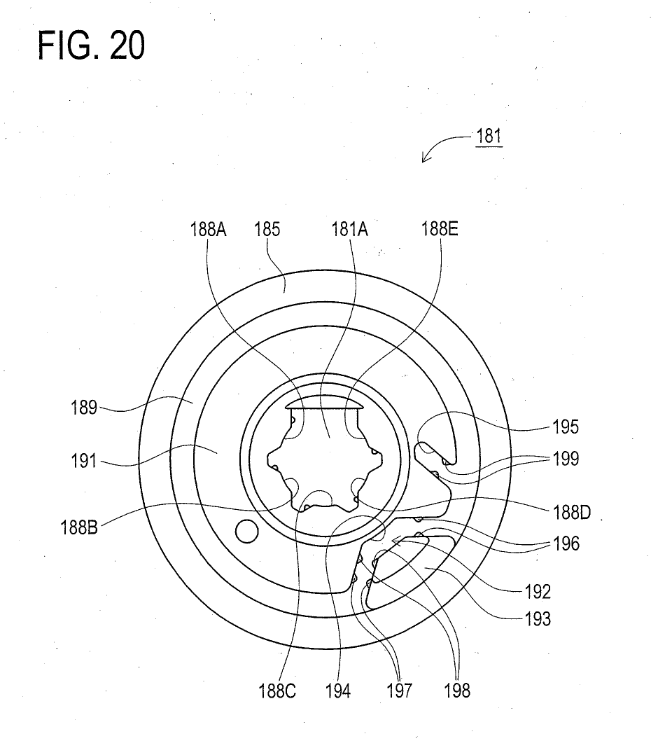

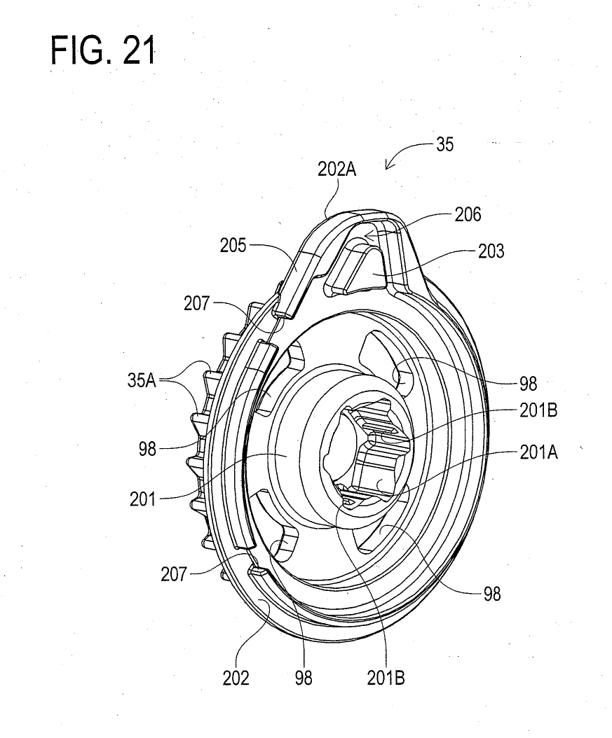

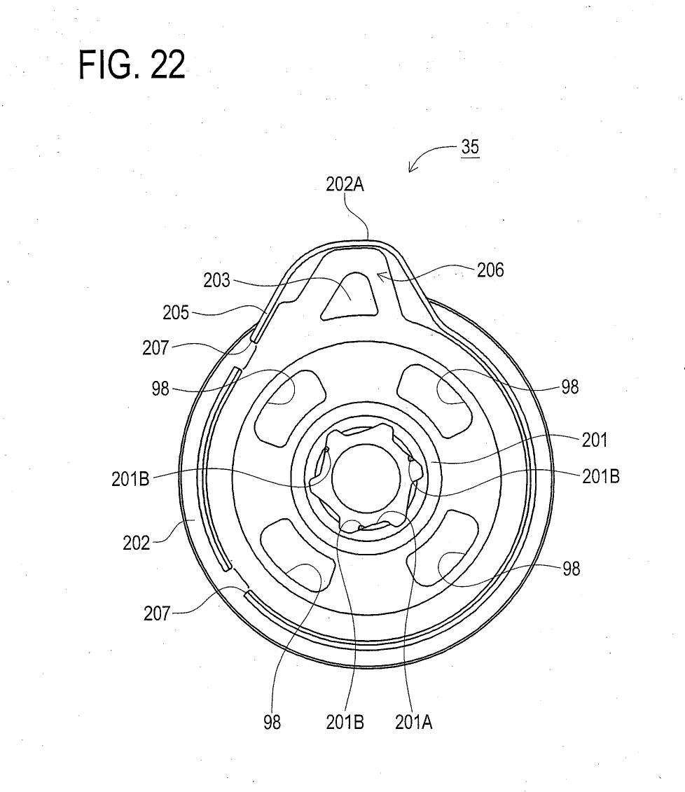

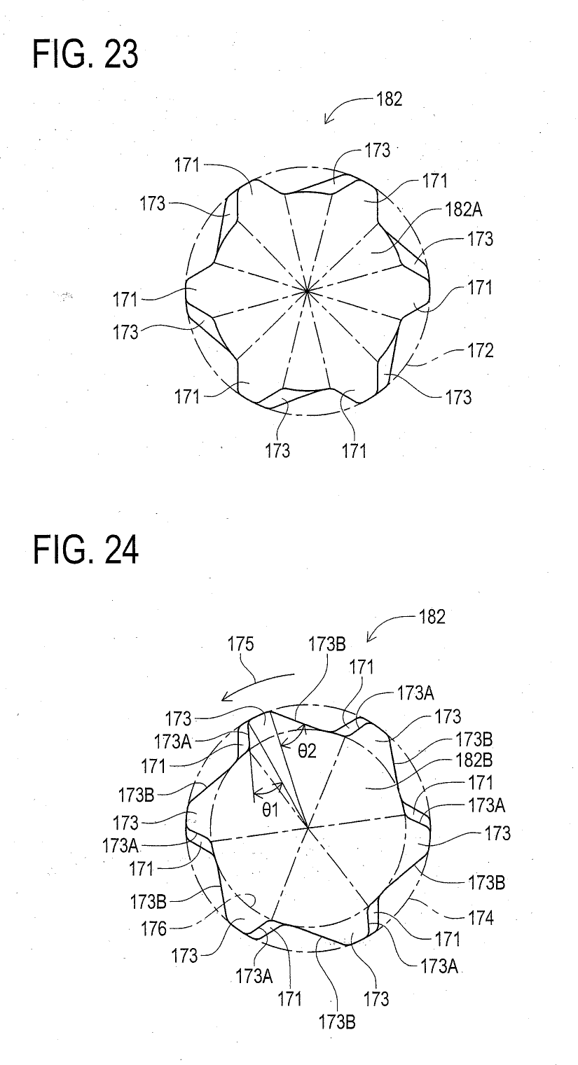

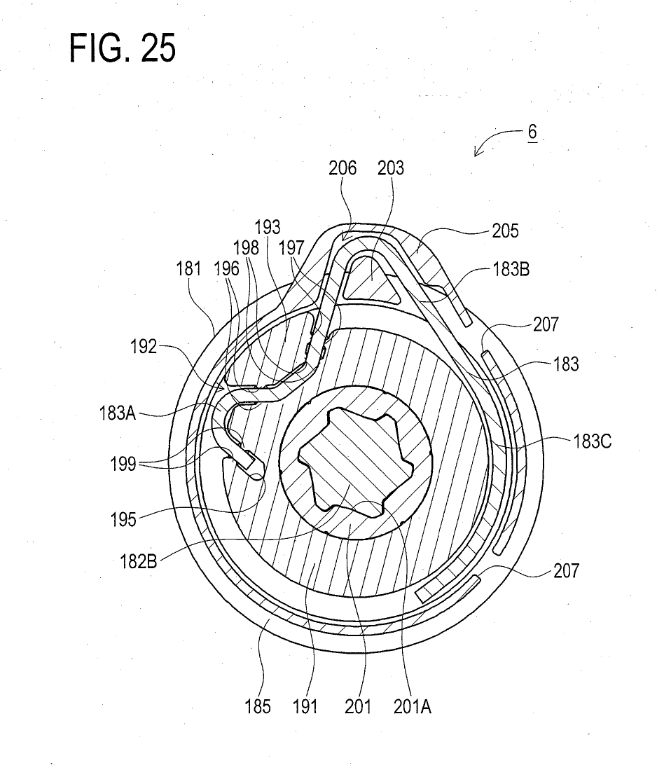

Next, a schematic configuration of the take-up drum unit 6 will be described based on FIG. 2, FIG. 3, and FIG. 18 through FIG. 25. FIG. 18 is a sectional view of a take-up drum unit 6 including an axial center thereof. FIG. 19 is an exploded perspective view of the take-up drum unit 6. FIG. 20 is a front view of a take-up drum 181 seen from a side for mounting a ratchet gear 35. FIG. 21 is a perspective view of the ratchet gear 35. FIG. 22 is a front view of an inner side of the ratchet gear 35. FIG. 23 is a side view of a torsion bar 182 in FIG. 19 seen from a side of the take-up drum. FIG. 24 is a side view of the torsion bar 182 in FIG. 19 seen from a side of the ratchet gear 35. FIG. 25 is a cross sectional view taken along a line indicated by arrows X1-X1 in FIG. 18 and seen in the direction of the arrows.

As illustrated in FIG. 18 and FIG. 19, the take-up drum unit 6 includes the take-up drum 181, a torsion bar 182, the wire 183 and the ratchet gear 35.

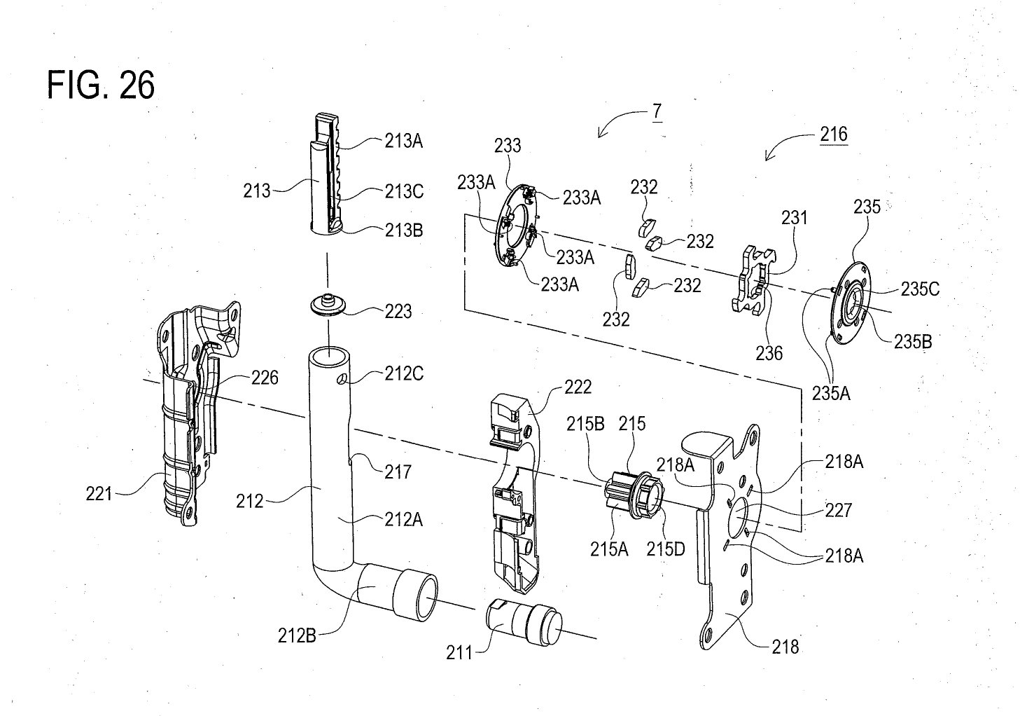

As illustrated in FIG. 2, FIG. 3, FIG. 18 and FIG. 19, the take-up drum 181 is made by aluminum die-casting, zinc die-casting or the like and is formed in a substantially cylindrical shape, with an end face on the side of the pretensioner unit 7 being walled and closed. On an edge portion of the take-up drum 181 at the side of the pretensioner unit 7 with respect to axial direction of the take-up drum 181, there is formed a flange portion 185 extending radially and outwardly at substantially right angles (leftward in FIG. 18) from an outer peripheral portion thereof. Further, on the inner circumferential surface of the flange portion 185, as later described, there is formed an internal gear 186 which engages with clutch pawls 232 (refer to FIG. 26) at vehicle collision to transmit the rotation of a pinion gear 215 (refer to FIG. 26).

A cylindrical boss 187 is erected on the center position of the end face portion on the pretensioner unit 7 side of the take-up drum 181. The boss 187 is fitted into a bearing 235 (refer to FIG. 26) formed of synthetic resin material such as polyacetal to be later described, and the base end portion of the boss 187 abuts on the bearing 235. Accordingly, one side of the take-up drum unit 6 is rotatably supported, via the bearing 235, at the boss portion 215D of the pinion gear 215 making up the pretensioner unit 7 (refer to FIG. 26). Accordingly, the pretensioner unit 7 and the locking unit 9 rotatably support the take-up drum unit 6 while preventing backlash in rotational axis direction.

The take-up drum 181 has a shaft hole 181A inside thereof. The shaft hole 181A has a draft angle in a manner tapering along a center axis. As illustrated in FIG. 18 and FIG. 20, there are formed five projecting portions 188A through 188E on an inner circumferential surface of the shaft hole 181A on the side closer to the flange portion 185. The five projecting portions 188A through 188E each have a trapezoidal shape in cross section, with a predetermined circumferential pitch, and are projecting radially inward in a rib-like shape. The torsion bar 182 is made of a steel material or the like, and includes a shaft portion 182C of a stick-like shape and circular in cross section, and connecting portions 182A, 182B formed on both ends of the shaft portion 182C.

As illustrated in FIG. 19 and FIG. 23, six protruding portions 171 are protruding from outer periphery of a column of a predetermined length in axial direction (for instance, approximately 6 mm long in axial direction), on the connecting portion 182A formed on an end portion of the torsion bar 182 at the side to be inserted to the take-up drum 181. The six protruding portions 171 are formed by every 60 degrees of equal central angle with predetermined circumferential pitches (for instance, with an pitch of approximately 30 degrees center angle), each in an isosceles trapezoid shape in cross section. Further, the tip diameter 172 of the protruding portion 171 is formed substantially equal to the inner diameter of the end portion of the flange portion 185 side within the shaft hole 181A. Further, each protruding portion 171 has two faces facing the circumferential direction, and the inclination angle of each of the two faces with regard to a radial direction is formed at a predetermined angle smaller than 45 degrees (for instance, an inclination angle of approximately 30 degrees).

Further, the projecting portions 188A through 188E are projecting in a manner respectively lockable between the protruding portions 171 of the connecting portion 182A formed on the end portion of the torsion bar 182 at the side to be inserted into the take-up drum 181. Accordingly, as illustrated in FIG. 18 and FIG. 19, the torsion bar 182 is relatively non-rotatably press-fitted inside the take-up drum 181, through pushing and putting the connecting portion 182A side of the torsion bar 182 into the shaft hole 181A of the take-up drum 181, among the projecting portions 188A through 188E.

Further, as illustrated in FIG. 18 through FIG. 20, at an end portion of the take-up drum 181 axially on the side of the locking unit 9, there is formed a flange portion 189 having substantially circular shape in front view, radially extended on the slightly axially inner circumferential surface from the end portion. Further, at a portion axially outward from the flange portion 189, a cylindrical stepped portion 191 is formed in a shape with slightly narrower outer diameter. The stepped portion 191 is provided so as to surround the spline 182B on the other side of the torsion bar 182 press-fitted inside the shaft hole 181A, forming a predetermined clearance.

Further, there is integrally formed a holding-side crooked path 192 on the outer peripheral surface of the stepped portion 191 formed on the outer side surface of the flange portion 189, having approximately circular shape in front view, as a part thereof. A crooked portion 183A at one end of linear wire 183 made of a metal material such as stainless material and having circular cross section is fixedly held at the holding-side crooked path 192.

As illustrated in FIG. 19 and FIG. 20, the holding-side crooked path 192 consists of: a convex portion 193 substantially trapezoid shaped in front view so as to go narrower in an inner radial direction and configured to project axially outward from outer side surface of the flange portion 189; a concave portion 194 configured to face the convex portion 193 on the outer peripheral surface of the stepped portion 191; a groove portion 195 formed so as to extend toward obliquely inner direction slanting in counterclockwise direction from the outer peripheral surface of the stepped portion 191 slightly away from an end portion at the counterclockwise direction in front view (counterclockwise direction side in FIG. 20) of the concave portion 194; and an outer peripheral surface between the concave portion 194 and the groove portion 195 on the stepped portion 191.

Further, as illustrated in FIG. 19 and FIG. 20, at the opposite faces on the groove portion 195 side (on a counterclockwise direction side in FIG. 20) disposed slantwise in radial direction of the convex portion 193 and that of the concave portion 194, there is erected a set of opposite ribs 196 along the depth direction of the holding-side crooked path 192. Further, on opposite faces on the opposite side (on a clockwise direction side in FIG. 20) of the groove portion 195 disposed slantwise in the radial direction of the convex portion 193 and the concave portion 194, two set of opposite ribs 197, 198 are provided along the depth direction of the holding-side crooked path 192, on a back side end portion radially inside, and on an end portion on a wire 183 exit-side radially outside, respectively.

A set of opposite ribs 199 are provided in a face opposite to the groove portion 195 along the depth direction of the holding-side crooked path 192. Further, the distance between each pair of opposite ribs 196 through 199 is made smaller than outer diameter of the wire 183. Incidentally, the height of each of the ribs 196 through 199 from the bottom portion of the holding-side crooked path 192 is made higher than the outer diameter of the wire 183.

As illustrated in FIG. 19 and FIG. 25, the crooked portion 183A at the one end of the wire 183 is fitted in the holding-side crooked path 192 crushing each rib and fixedly held thereat. Further, the wire 183 includes a crooked portion 183B that is substantially inverted U-shaped in front view and formed so as to continue to the crooked portion 183A and project exterior to the outer periphery of the flange portion 189. The wire 183 further includes a crooked portion 183C that is formed so as to continue to the crooked portion 183B and shaped like an arc along outer peripheral surface outline of the stepped portion 191.

Accordingly, the crooked portion 183A of the wire 183 is held at the exist-side end portion of the holding-side crooked path 192 by two pairs of ribs 197 and 198 arranged along the axial line direction of the wire 183, so that the slant of the crooked portion 183B continued to the crooked portion 183A can be made substantially constant, with regard to the exit side of the holding-side crooked path 192.

Further, as illustrated in FIG. 18, FIG. 19, FIG. 21 and FIG. 22, the ratchet gear 35 is made by aluminum die-casting, zinc die-casting or the like, has a substantially ring shape in axial cross section and has on the outer periphery thereof the ratchet gear portion 35A. A cylindrical fixation boss 201 is erected at an inner center position of the ratchet gear 35. The inner peripheral face of the fixation boss 201 has a fitting concave portion 201A formed to have a cross section analogous to a connecting portion 182B formed on an end portion of the torsion bar 182 on a side to be inserted to the ratchet gear 35 and into which the connecting portion 182B is press-fitted. Further, the inner peripheral portion of the ratchet gear portion 35A is configured to have an inner diameter enough to allow insertion of the stepped portion 191 of the take-up drum 181.

As illustrated in FIG. 19 and FIG. 24, the connecting portion 182B is formed at the end portion of the torsion bar 182 at the side to be inserted into the ratchet gear 35. The connecting portion 182B has six convex portions 173 protruding from outer periphery of a column of a predetermined length in axial direction (for instance, approximately 5 mm long in axial direction), by every 60 degrees of equal central angle continuously in the circumferential direction. Each of the six convex portions 173 has a trapezoidal cross section. Further, a tip diameter 174 of each of the convex portions 173 is formed substantially equal to a tip diameter 172 of the protruding portions 171, and the height in radial direction of each of the convex portions 173 is formed substantially equal to the height of the protruding portions 171 in radial direction.

Further, each of the convex portions 173 has the two faces facing a circumferential direction. Of the two faces, a face 173A is on a side that transmits to the ratchet gear 35 a rotary driving force for rotating in the webbing pull-out direction (in the direction indicated by arrow 175 in FIG. 24). An inclination angle θ1 of the face 173A with regard to a radial direction is designed to be smaller than 45 degrees, or preferably smaller than 26.6 degrees. A face 173B is on a side that transmits a rotary driving force for rotating in the webbing take-up direction (in the direction opposite to arrow 175 in FIG. 24) to the ratchet gear 35, namely, on the circumferentially opposite side. The inclination angle θ1 of the face 173A with regard to a radial direction is further designed to be smaller than an inclination angle θ2 of the face 173B with regard to a radial direction. For instance, the inclination angle θ1 may be approximately 25 degrees, and the inclination angle θ2 may be approximately 50 degrees.

Further, base end portions of the two faces 173A, 173B facing a circumferential direction of each of the convex portions 173 are formed to be positioned on a concentric circle 176. As illustrated in FIGS. 21 and 22, three ribs 201B are formed on the inner circumferential surface facing the face 173B of each of the convex portions 173 of the fitting concave portion 201A of the ratchet gear 35. The three ribs 201B stand radially inward along the rotational axis direction. However, the base end portions of the two faces 173A, 173B facing a circumferential direction of each of the convex portions 173 may be connected to the base end portions of the face 173A located adjacent in the circumferential direction, or alternatively, may be connected to the base end portion of the face 173B. Accordingly, the inclination angle θ2 of the face 173B with regard to a radial direction can further be increased.

Further, as illustrated in FIGS. 18, 19, 21 and 22, the ratchet gear 35 has a flange portion 202 extended radially outward in an entire periphery from the end face portion on the take-up drum 181 side of the ratchet gear portion 35A. The flange portion 202 has a ring-like shape in front view, extending radially outward than the outer diameter of the flange portion 189 of the take-up drum 181. Further, the flange portion 202 is extended radially outward from an outer circumference portion having a predetermined center angle (for instance, center angle of roughly 60 degrees) in approximately a trapezoidal shape in front view, which becomes narrower in the tip portion. Further, the outer diameter of the flange portion 202 is formed roughly the same size as the outer diameter of the flange portion 185 of the take-up drum 181.

A trapezoid-like portion 202A is extended radially outward from the flange portion 202. The trapezoid-like portion 202A is narrower at the tip portion thereof in front view and has approximately a trapezoidal shape. A convex portion 203 having approximately a conical shape in front view is formed at an approximately center portion on an inner side surface of the trapezoid-like portion 202A at the take-up-drum 181 side, and projecting axially outward from the trapezoid-like portion 202A. The crooked portion 183B of the wire 183, substantially inverted U-shaped in front view, is fitted inside the convex portion 203.

Further, a flange portion 205 is formed on the inner side surface of the flange portion 202 at the take-up drum 181 side. The flange portion 205 have an inner diameter slightly larger than the outer diameter of the flange portion 189 of the take-up drum 181, erected along the outer circumference portion of the trapezoid-like portion 202A, and substantially oval-shaped in front view. Further, the inner periphery of the flange portion 205 and the outer periphery of the convex portion 203 make up a deformation-giving crooked path 206 that is substantially inverted U-shaped in front view (refer to FIG. 25). The wire 183 is guided and pulled out through the deformation-giving crooked path 206. Further, the outer circumference portion of the flange portion 205 has window portions 207 in two locations. The window portions 207 are cut out in circumferential direction so as to allow visual recognition of the installed wire 183.

There will be described on attachment of the wire 183 to the take-up drum 181 and the ratchet gear 35, referring to FIG. 18, FIG. 19 and FIG. 25.

As shown in FIG. 19 and FIG. 25, the crooked portion 183A at one end of the wire 183 being bent like a substantially S-like shape is first fitted in the holding-side crooked path 192 formed on the flange portion 189 of the take-up drum 181 and the stepped portion 191. When the crooked portion 183A is fitted in the holding-side crooked path 192, the ribs 196 through 199 are crushed thereby. The crooked portion 183B that is substantially inverted U-shaped in front view and formed to continue to the crooked portion 183A is placed so as to project exterior to the outer periphery of the flange portion 189.

Further, the crooked portion 183C that is formed to continue to the crooked portion 183B and shaped like an arc is placed along outer peripheral surface outline of the stepped portion 191. Thereby, the crooked portion 183A at one end of the wire 183 is fixedly held by the holding-side crooked path 192 formed on the flange portion 189 of the take-up drum 181 and the stepped portion 191 while the crooked portion 183C is placed so as to face the flange portion 189.

Subsequently, in order to attach the ratchet gear 35 onto the take-up drum 181, first, the crooked portion 183B of the wire 183 that is substantially inverted U-shaped in front view and configured to project exterior to the outer periphery of the flange portion 189 of the take-up drum 181 is fitted in the deformation-giving crooked path 206 formed at outer peripheral portion of the convex portion 203 arranged on the trapezoid-like portion 202A of the flange portion 202 of the ratchet gear 35.

Further, at the same time, the fixation boss 201 of the ratchet gear 35 is inserted inside the stepped portion 191 of the take-up drum 181, and the connecting portion 182B formed on the end portion of the torsion bar 182 to be inserted in the ratchet gear 35 is press-fitted inside the fitting concave portion 201A of the fixation boss 201 while crushing the ribs 201B. The wire 183 is thus arranged between the flange portion 189 of the take-up drum 181 and the flange portions 202 and 205 and the ratchet gear 35, and the ratchet gear 35 is attached on the take-up drum 181.

### [Schematic Configuration of Pretensioner Unit]

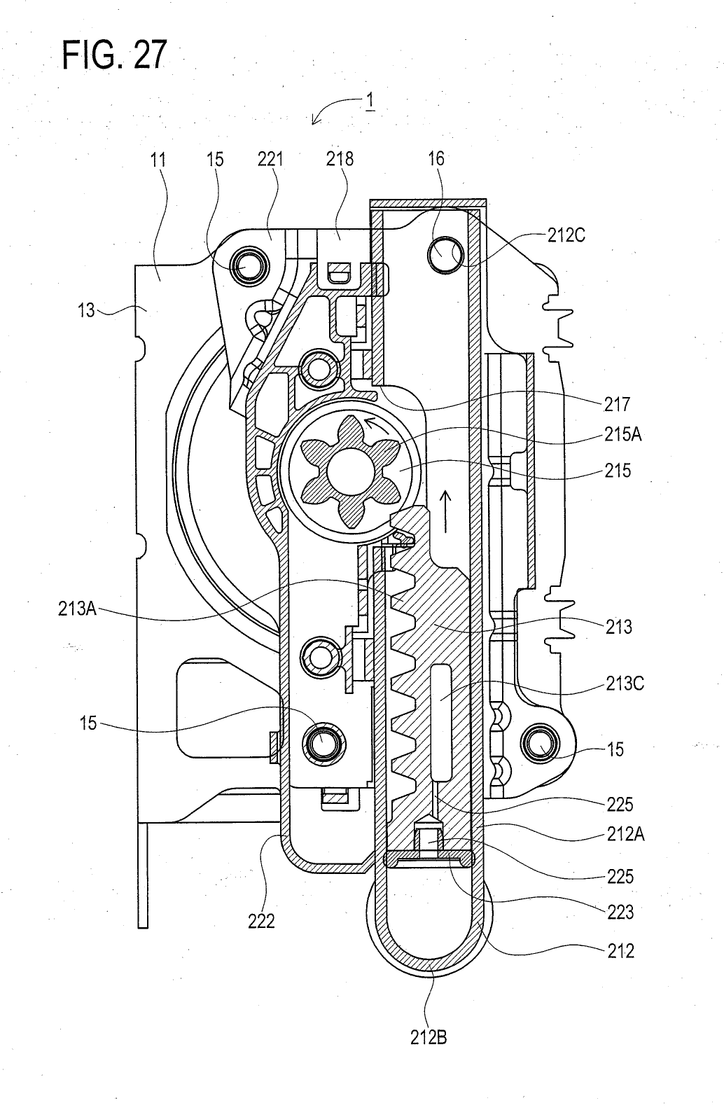

Next, a schematic configuration of the pretensioner unit 7 will be described referring to FIG. 2, FIG. 3, FIG. 26 and FIG. 27. FIG. 26 is an exploded perspective view showing the pretensioner unit 7 in a disassembled state. FIG. 27 is a cross sectional view showing an internal configuration of the pretensioner unit 7.

The pretensioner unit 7 is configured to securely restrain a vehicle occupant, through rotating the take-up drum 181 in the webbing take-up direction to remove the slack of the webbing 3, in an emergency such as vehicle collision.

As illustrated in FIG. 26 and FIG. 27, the pretensioner unit 7 includes a gas generating member 211, a pipe cylinder 212, a piston 213, the pinion gear 215, a clutch mechanism 216, and the bearing 235.

This gas generating member 211 includes a gas generating agent such as explosive powder which is ignited in response to an ignition signal transmitted from a control portion, which is not shown, generating gas as a result of combustion of the gas generating agent.

The pipe cylinder 212 is formed as a substantially L shaped cylindrical member, with a gas introducing portion 212B connected on one end of a piston guiding cylindrical portion 212A having a linear shape. The gas introducing portion 212B is configured to house the gas generating member 211. Accordingly, the gas generated at the gas generating member 211 is introduced inside the piston guiding cylindrical portion 212A from the gas introducing portion 212B. Further, an opening portion 217 is formed in the middle portion in longitudinal direction on one side portion of the piston guiding cylindrical portion 212A, and part of pinion gear teeth 215A of the pinion gear 215 is arranged therein as later described.

The pipe cylinder 212 is held by the base plate 218 on the side wall portion 13 side of the housing 11 and by the cover plate 221 on the outside, and fixedly attached on the outer surface of the side wall portion 13 by the screws 15 under a state further held by a base block 222 and the cover plate 221 between these.

Further, a pair of through holes 212C is formed on the upper end portion of the piston guiding cylindrical portion 212A, arranged facing each other. The stopper pin 16 is inserted into the pair of through holes 212C. The stopper pin 16 attaches the pretensioner unit 7 on the side wall portion 13, and serves as a stopper for the piston 213, and also as a stopper and a rotation preventer for the pipe cylinder 212.

The piston 213 is made of a steel material or the like and has an overall lengthy shape, with a substantially rectangular shape in cross section that enables insertion thereof from the top end portion of the piston guiding cylindrical portion 212A. On a surface of the pinion gear 215 side of the piston 213, there is formed a rack 213A configured to engage with the pinion gear teeth 215A of the pinion gear 215. Further, on the end face of the gas generating member 211 side of the piston 213 is formed into a circular end face 213B corresponding to the cross sectional shape of the piston guiding cylindrical portion 212A. A sealing plate 223 formed of a rubber material or the like is attached on the circular end face 213B.

The piston 213 has a through hole 213C long along the longitudinal direction thereof. The through hole 213C has a rectangular cross-sectional shape, with both side face portions communicating. A gas releasing hole 225 is formed in the piston 213 and the sealing plate 223, and communicates from a pressure receiving side of the sealing plate 223 for receiving the pressure of the gas, to the through hole 213C. As illustrated in FIG. 27, before activation of the pretensioner unit 7, namely, in a normal waiting state in which the gas is not generated by the gas generating member 21, the piston 213 is inserted and arranged in the depth side of the piston guiding cylindrical portion 212A, up to a location in which the rack 213A is not engaged with the pinion gear teeth 215A.

The pinion gear 215 is a columnar member made of a steel material or the like. The pinion gear 215 is provided with the pinion gear teeth 215A on an outer peripheral portion thereof engageable with the rack 213A. The pinion gear 215 also has a support portion 215B formed cylindrically-shaped, extending toward the cover plate 221 side from the pinion gear teeth 215A. The support portion 215B is rotatably fitted into a supporting hole 226 formed in the cover plate 221 mountable to the side wall portion 13.

With the support portion 215B rotatably inserted in the supporting hole 226, part of the pinion gear teeth 215A is arranged inside the opening portion 217 of the piston guiding cylindrical portion 212A. As illustrated in FIG. 27, when the piston 213 moves toward the tip end side of the piston guiding cylindrical portion 212A from the normal waiting state, the rack 213A then engages with the pinion gear teeth 215A and the pinion gear 215 rotates in the webbing take-up direction.

The rotation of the pinion gear 215 is transmitted through the clutch mechanism 216 to the take-up drum 181.

That is, a cylindrical boss portion 215D projecting along the axial center direction is formed on an end portion on the side wall portion 13 side in the axial center direction of the pinion gear 215. The outer circumferential surface of the boss portion 215D has a spline formed of six projections having the outer diameter of the base end portion. The boss portion 215D is rotatably inserted in a through hole 227 formed on the base plate 218, and arranged projecting on the take-up drum 181 side.

Further, the clutch mechanism 216 is capable of switching-over from a state where the take-up drum 181 is freely rotatable with regard to the pinion gear 215 in normal time (a state where the clutch pawls 232 are housed) to a state where the rotation of the pinion gear 215 is transmitted to the take-up drum 181 at the activation of the pretensioner unit 7 (a state where the clutch pawls 232 project).

The clutch mechanism 216 includes: a pawl base 231 made of a steel material or the like; four clutch pawls 232 made of a steel material or the like; a substantially ring-like pawl guide 233 made of a synthetic resin such as polyacetal and made to have contact with the base plate 218 side of the pawl base 231; and the substantially ring-like bearing 235 made of a synthetic resin such as polyacetal, and made to have contact with the take-up drum 181 side of the pawl base 231, and to hold the pawl base 231 and the clutch pawls 232, with the pawl guide 233.

A center portion of the pawl base 231 has a fitting hole 236 having six spline grooves for the boss portion 215D of the pinion gear 215 to fit in. As the boss portion 215D of the pinion gear 215 is press-fitted in the fitting hole 236 of the pawl base 231 with the base plate 218 and the pawl guide 233 therebetween, the pawl base 231 is attached relatively non-rotatably with regard to the pinion gear 215. That is, the pawl base 231 and the pinion gear 215 are configured to rotate integrally.

Further, the bearing 235 is configured to be locked at the outer circumference portion of the pawl guide 233 by a plurality of elastic engagement pieces 235A projecting from the outer circumference portion to the pawl guide 233 side. Further, a through hole 235B having an inner diameter substantially the same size as the outer diameter of the boss 187 of the take-up drum 181 is formed in the center portion of the bearing 235. Further, a cylindrical shaft receiving portion 235C is formed, continuously projecting from the peripheral portion of the pawl base 231 side of the through hole 235B. The cylindrical shaft receiving portion 235C has the same inner diameter as that of the through hole 235B and the outer diameter substantially the same as the inner diameter of the boss portion 215D of the pinion gear 215.

When the boss portion 215D of the pinion gear 215 is press-fitted in the fitting hole 236 of the pawl base 231, the cylindrical shaft receiving portion 235C erected in the center portion of the bearing 235 is fitted inside the boss portion 215D. Further, the boss 187 is erected in the center position of end face portion on the pretensioner unit 7 side of the take-up drum 181. The boss 187 is rotatably inserted into the bearing 235. The pawl base 231 supports each clutch pawl 232 in an accommodated position. The accommodated position is a position in which the entire clutch pawls 232 are accommodated within the outer peripheral portion of the pawl base 231.

The pawl guide 233 is a substantially ring-like member, and arranged at a position facing the pawl base 231 and each clutch pawl 232. Four positioning projections (not shown) are projecting on the side face on the base plate 218 side of the pawl guide 233, and the positioning projections are inserted in positioning holes 218A of the base plate 218, respectively, and in the waiting state, the pawl guide 233 is fixed to the base plate 218 in a non-rotatable state.

On a surface on the pawl base 231 side of the pawl guide 233, position-changing projecting portions 233A are projecting corresponding to clutch pawls 232, respectively. When the pawl base 231 and the pawl guide 233 are relatively rotated by the activation of the pretensioner unit 7, the clutch pawls 232 respectively make contact with the position-changing projecting portions 233A, so that the position is changed from an accommodated position to a locking position. The locking position is a position in which the tip portions of the clutch pawls 232 project outward of the outer peripheral end portion of the pawl base 231.

Further, when the position of the clutch pawls 232 is changed to the locking position, the clutch pawls 232 is engaged with the take-up drum 181. Specifically, the clutch mechanism 216 is inserted in the boss 187 of the take-up drum 181 via the bearing 235, so as to rotatably support the take-up drum 181. When the clutch pawls 232 project to the outside of the outer peripheral end portion of the pawl base 231, the clutch pawls 232 are engageable with the internal gear 186 formed on the inner surface of the flange portion 185.

Then, when the clutch pawls 232 change the position to the locking position, the tip portion of each clutch pawl 232 engages with the internal gear 186, so that the pawl base 231 rotates the take-up drum 181. Incidentally, the engagement of the clutch pawl 232 and the internal gear 186 has an engagement structure that allows the take-up drum 181 to rotate in one direction, namely, in a take-up direction of the webbing 3.

Further, once engaged, the clutch pawls 232 each catch the internal gear 186 with deformation, so that when the take-up drum 181 rotates in the webbing pull-out direction after engagement, the pinion gear 215 is rotated in a direction opposite to the activation of the pretensioner unit 7 through the clutch mechanism 216, and the piston 213 is pushed back in the direction opposite to the activation direction. When the piston 213 is pushed back up to the point to release the engagement between the rack 213A of the piston 213 and the pinion gear teeth 215A of the pinion gear 215, the pinion gear 215 is released from the piston 213, so as to allow the take-up drum 181 to freely rotate with regard to the piston 213.

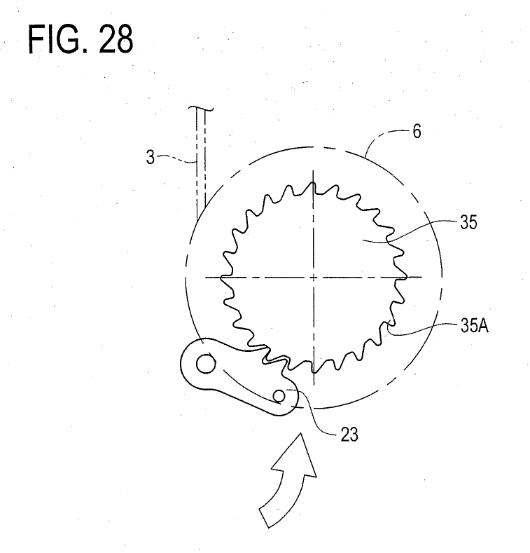

Next, the operation of the pretensioner unit 7 configured, as in the above, to be activated to take up the webbing 3 is discussed referring to FIGS. 27 and 28. FIG. 28 is an explanatory view illustrating the operation of the pawl 23 at vehicle collision.

As illustrated in FIG. 27, when the gas generating member 211 of the pretensioner unit 7 is activated at vehicle collision or the like, the pressure of the generated gas moves the piston 213 toward the tip portion of the piston guiding cylindrical portion 212A, and rotates the pinion gear 215 having the pinion gear teeth 215A engaging with the rack 213A (rotates in the counterclockwise direction in FIG. 27).

Further, at vehicle collision or the like, the inertial mass 52 of the vehicle acceleration sensor 28 moves on the bottom face portion of the sensor holder 51 to rotate the sensor lever 53 vertically upward. Thereby, as discussed above, the lock claw 53A of the sensor lever 53 rotates the pilot lever 86 vertically upward. Then the engagement claw portion 86A of the pilot lever 86 makes contact with a locking gear tooth 81A formed on the outer circumference portion of the locking gear 81.

Here, the engagement of the engagement claw portion 86A of the pilot lever 86 and a locking gear tooth 81A has an engagement structure that activates in one direction, namely, in a direction preventing the rotation of the take-up drum 181 in the webbing pull-out direction. Accordingly, when the pretensioner unit 7 is activated, even if the engagement claw portion 86A of the pilot lever 86 abuts on a locking gear tooth 81A, the take-up drum 181 is still smoothly rotatable in the webbing take-up direction.

Then, as illustrated in FIG. 27, as the pinion gear 215 rotates, the pawl base 231 rotates together with the pinion gear 215. At this time, the pawl base 231 relatively rotates with regard to the pawl guide 233; so that the position-changing projecting portions 233A formed on the pawl guide 233 respectively abut on the clutch pawls 232 and the clutch pawls 232 are changed to the locking position.

As a result, the tip portion of each clutch pawl 232 engages with the internal gear 186 of the take-up drum 181, transmitting the force of the piston 213 to move to the tip end side of the piston guiding cylindrical portion 212A, to the take-up drum 181, through the pinion gear 215, the pawl base 231 the clutch pawls 232 and the internal gear 186. Thereby, the take-up drum 181 is rotatably driven in the take-up direction of the webbing 3, and the webbing 3 is taken up by the take-up drum 181.

At vehicle collision or the like, if the webbing 3 is pulled out subsequently after the activation of the pretensioner unit 7 and the take-up drum 181 rotates in the webbing pull-out direction, the engagement claw portion 86A of the pilot lever 86 engages with locking gear tooth 81A formed on the outer circumference portion of the locking gear 81 and the clutch 85 is rotated in the webbing pull-out direction. Accordingly, as illustrated in FIG. 28, the pawl 23 guided by the guiding hole 116 of the clutch 85 is made to engage with the ratchet gear portion 35A of the ratchet gear 35.

As explained, when the webbing 3 is pulled out successively after the activation of the pretensioner unit 7 at vehicle collision, etc., the engagement of the pawl 23 and the ratchet gear portion 35A serves to stop rotation of the ratchet gear 35 of the take-up drum unit 6 in the webbing-pull-out direction. Incidentally, the pawl 23 and the ratchet gear portion 35A has an engagement structure that allows the take-up drum 181 to rotate in one direction, namely, in the webbing pull-out direction.

### [Energy Absorption]

Next, in a case where a vehicle occupant is relatively moved frontward with respect to the vehicle in a state that engagement of the pawl 23 and the ratchet gear portion 35A of the ratchet gear 35 is kept, after the activation of the pretensioner unit 7 at vehicle collision, etc., a significantly large pull-out load acts on the webbing 3. In a case where the webbing 3 is pulled out with the pull-out load exceeding predetermined value corresponding to threshold, rotation torque in the webbing-pull-out direction acts on the take-up drum 181.

Thus, as the ratchet gear 35 is prevented by the pawl 23 from rotating (refer to FIG. 28), the connecting portion 182B of the torsion bar 182 press-fitted in the fitting concave portion 201A of the ratchet gear 35 is prevented from rotating in the webbing-pull-out direction. Therefore, of the torsion bar 182, the connecting portion 182A side press-fitted into the shaft hole 181A of the take-up drum 181 is rotated by the rotation torque acting on the take-up drum 181 in the webbing-pull-out direction so that torsional deformation starts at the shaft portion 182C of the torsion bar 182. The take-up drum 181 is rotated in the webbing-pull-out direction due to the torsional deformation at the shaft portion 182C of the torsion bar 182, whereby impact energy is absorbed in the form of the torsional deformation caused to the torsion bar 182, as “first energy absorption mechanism.”

At the same time, since the pawl 23 and the ratchet gear 35 are engaged when the take-up drum 181 is rotated, relative rotation is caused between the ratchet gear 35 and the take-up drum 181. Consequently, relative rotation is subsequently caused between the wire 183 and the ratchet gear 35 due to rotation of the take-up drum 181, whereby the wire 183 serves to absorb impact energy, as “second energy absorption mechanism.”

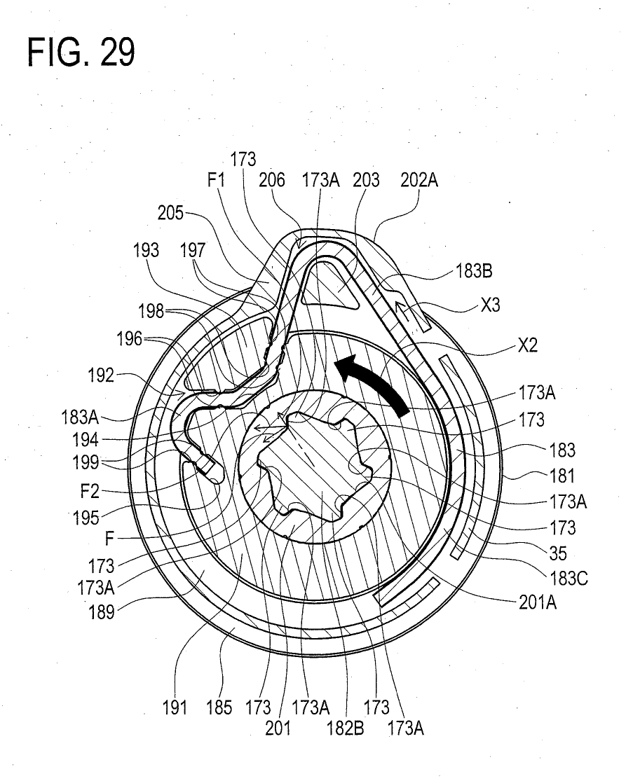

Hereinafter, explanation will be given regarding a load that acts on the fitting concave portion 201A of the ratchet gear 35, along with the torsional deformation of the shaft portion 182C of the torsion bar 182, referring to FIG. 29. FIG. 29 is a view for illustrating an operation at a start of pulling out the wire 183.

As illustrated in FIG. 29, the connecting portion 182B of the torsion bar 182 press-fitted in the fitting concave portion 201A of the ratchet gear 35 is subjected to rotation torque in the webbing pull-out direction (in the direction indicated by arrow X2), together with the torsional deformation of the shaft portion 182C.

As a result, at the fitting concave portion 201A, a large load F is applied to each face 173A in a tangential direction (circumferential direction) by the rotation torque, through the face 173A of each of the convex portions 173 of the connecting portion 182B (FIG. 29 depicts the large load F applied to the face 173A of one convex portion 173 from among the six convex portions 173). Thus, in the fitting concave portion 201A, a load F1 that satisfies “F1=F×tan θ1” acts in the radial direction from each face 173A, and a load F2 that satisfies “F2=F/cos θ1” acts vertically on each face 173A.

Further, as described above, as the inclination angle θ1 of the face 173A with regard to a radial direction is formed to be smaller than 45 degrees, or preferably smaller than 26.6 degrees, the load F1 in the radial direction can be made smaller than the load F. If the inclination angle θ1 of the face 173A with regard to a radial direction is smaller than 26.6 degrees, the load F1 in the radial direction that acts on the fitting concave portion 201A can be reduced to half the load F, or lower. Accordingly, as the inclination angle θ1 of the face 173A with regard to a radial direction becomes closer to 0 degree, the load F1 in the radial direction that acts on the fitting concave portion 201A also becomes closer to 0.

### [Pull-Out-Wire Operation]

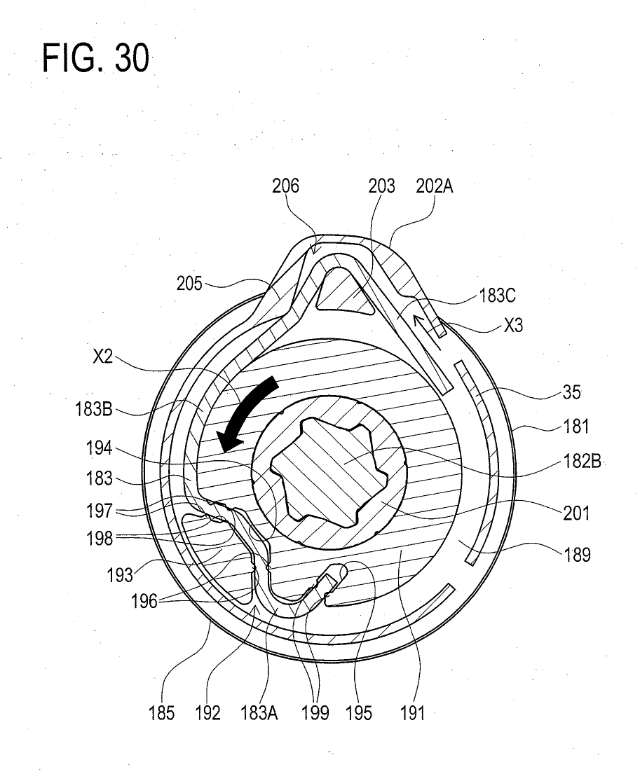

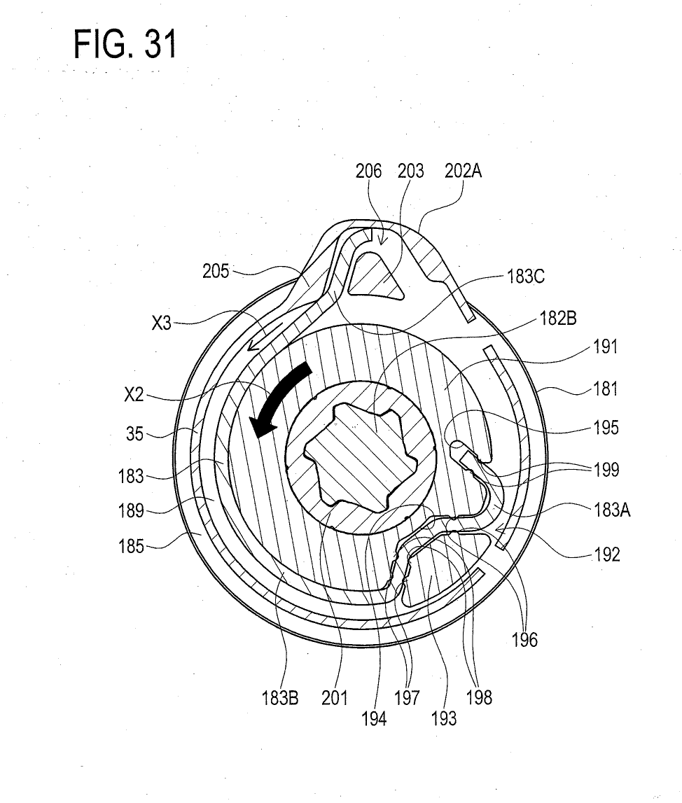

Here will be described on the operation of pulling out the wire 183 when absorbing impact energy with the wire 183 referring to FIGS. 25, 29 through 32. FIGS. 29 through 32 are views illustrating the operation of pulling out the wire 183.

As shown in FIG. 25, at the initial state between the take-up drum 181 and the ratchet gear 35, the end portion on the wire 183 exit-side of the convex portion 193 and that of the concave portion 194 constituting the holding-side crooked path 192 of the take-up drum 181 are located near the wire-pull-out-side end portion of the deformation-giving crooked path 206 formed on the outer periphery portion of the convex portion 203 arranged so as to project from the trapezoid-like portion 202A of the flange portion 202.

The crooked portion 183A that is a part of the wire 183 and bent like substantially S-shaped is fitted in and fixedly held by the holding-side crooked path 192 constituted by the convex portion 193, the concave portion 194 and the groove portion 195 of the take-up drum 181. The crooked portion 183B substantially inverted U-shaped in front view and formed so as to continue to the crooked portion 183A is fitted in the deformation-giving crooked path 206 formed on the outer peripheral portion of the convex portion 203 that is arranged so as to project from the trapezoid-like portion 202A. Thereby, the end portion on the wire 183 exit-side of the holding-side crooked path 192 and the wire-pull-out-side end portion of the deformation-giving crooked path 206 communicate each other almost straight via the wire 183.

As illustrated in FIGS. 29 through 32, when the take-up drum 181 rotates in the webbing-pull-out direction (in the direction indicated by arrow X2) in response to the pull-out operation of the webbing 3, rotation of the ratchet gear 35 is stopped by the pawl 23 (see FIG. 28) and the stepped portion 191 is relatively rotated in the webbing-pull-out direction (in the direction indicated by arrow X2) with respect to the trapezoid-like portion 202A of the ratchet gear 35.

Thereby, the wire 183 of which crooked portion 183A is fixedly held at the holding-side crooked path 192 of the stepped portion 191 is pulled out in the direction of arrow X3, while sequentially squeezed by the deformation-giving crooked path 206 substantially inverted U-shaped in front view and farmed with the convex portion 203 projecting at the center of the trapezoid-like portion 202A and with the flange portion 205 projecting at the outer peripheral portion of the trapezoid-like portion 202A, and then taken up on the outer peripheral surface of the stepped portion 191. In concurrence with the pull-out operation of the wire 183, torsional deformation is caused to the torsion bar 182 by rotation of the take-up drum 181.

The wire 183 is deformed when passing through the deformation-giving crooked path 206 substantially inverted U-shaped in front view, and when passing, the wire 183 slides with friction to a side surface portion, in the rotational direction of the stepped portion 191 (in the direction indicated by the arrow X2) on the wire-pull-out-side end portion of the deformation-giving crooked path 206 and to the outer peripheral surface of the convex portion 203. Thereby, sliding resistance is caused between the convex portion 203 and the wire 183, and also bending resistance is caused by the wire 183 on its own. The sliding resistance and the bending resistance make up pull-out resistance, and the wire 183 absorbs impact energy with this pull-out resistance.

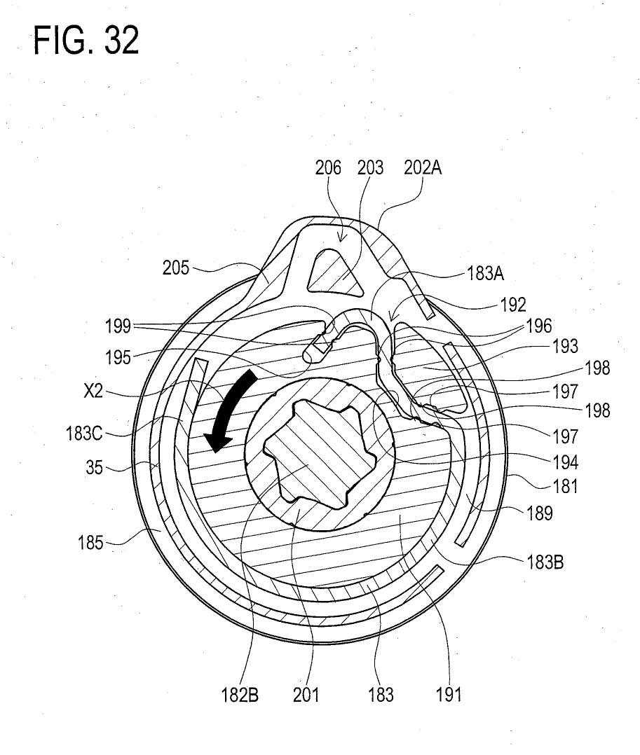

As illustrated in FIG. 32, when the end of the crooked portion 183C of the wire 183 leaves the deformation-giving crooked path 206 along rotation of the take-up drum 181, the impact energy absorption effect by the wire 183 terminates. Thereafter, impact energy is absorbed only by torsional deformation of the torsion bar 182 along rotation of the take-up drum 181.

As has been discussed above in detail, in the seatbelt retractor 1 according to the embodiment, if the webbing 3 is pulled out under a state that the rotation in the webbing pull-out direction of the ratchet gear 35 is prevented by the pawl 23, in case of emergency such as vehicle collision, torsional deformation is caused at the shaft portion 182C of the torsion bar 182. Further, the load F1 in the radial direction acts on the fitting concave portion 201A of the ratchet gear 35 by the large load F in the tangential direction due to the rotation torque, via the face 173A each of the convex portions 173 of the torsion bar 182.

As a result, the fitting concave portion 201A is subjected to the load F1 satisfying “F1=F×tan θ1” in the radial direction from the face 173A of each of the convex portions 173. Accordingly, the decrease of the inclination angle θ1 of the face 173A with regard to a radial direction (for instance, the inclination angle θ1 of 25 degrees) helps reduce the load F1 in the radial direction applied to the fitting concave portion 201A. Thereby, the decrease of the inclination angle θ1 of each face 173A with regard to a radial direction helps reduce the mechanical strength required in the fixation boss 201 of the ratchet gear 35, and also enables the downsizing, weight-saving and cost-reduction of the ratchet gear 35.

Further, the smaller the inclination angle θ1 with regard to a radial direction at the face 173A of each of the convex portions 173 is, the smaller the load F1 in the radial direction applied to the fitting concave portion 201A can be made. Simultaneously, if the torsion bar 182 is made by forging, etc., the increase of a load on a die at forming the convex portions 173 may deteriorate the formability, resulting in the difficulty in manufacturing the torsion bar 182.

However, even with the smaller inclination angle θ1 with regard to a radial direction at the face 173A of each of the convex portions 173, each of the convex portions 173 can be formed easily by forging, etc., by increasing the inclination angle θ2 with regard to a radial direction at the face 173B circumferentially opposite to the face 173A of each of the convex portions 173, and the formability of the torsion bar 182 by forging, etc. can be improved.

Further, even with the smaller inclination angle θ1 of with regard to a radial direction at the face 173A of each of the convex portions 173, the inclination angle θ2 with regard to a radial direction at the face 173B circumferentially opposite to the face 173A of each of the convex portions 173 can be easily made larger (for instance, the inclination angle θ2 of 50 degrees). As a result, the circumferential width dimension of each of the convex portions 173 can be widened, the shear strength in the circumferential direction of each of the convex portions 173 can easily be improved, and the mechanical strength required for each of the convex portions 173 can easily be secured.

Accordingly, as the inclination angle θ1 with regard to a radial direction at the face 173A of each of the convex portions 173 formed on the connecting portion 182B of the torsion bar 182 is made to be smaller than the inclination angle θ2 with regard to a radial direction at the face 173B circumferentially opposite to the face 173A of each of the convex portions 173, the design freedom of the plurality of convex portions 173 increases. Accordingly, while securing the mechanical strength required in each of the convex portions 173 and the fitting concave portion 201A of the fixation boss 201, the formability by forging, etc. of the torsion bar 182 can be improved.

The present invention is not limited to the above-described embodiment, but various improvements and modifications can be made thereto without departing from the spirit of the present invention. For instance, the following modification can be made. In the following discussion, the same reference numerals as those of the seatbelt retractor 1 according to the above-described embodiment depicted in FIGS. 1 through 32 represent the same or equivalent elements as those of the seatbelt retractor 1 according to the above-described embodiment.

### First Different Embodiment

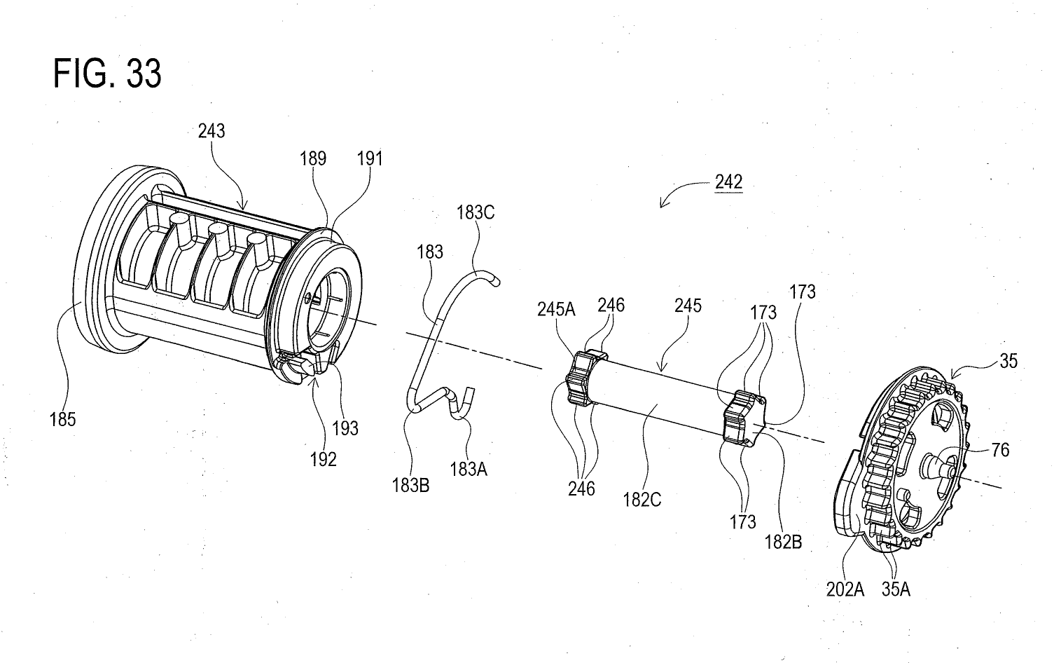

(A) A schematic configuration of a seatbelt retractor 241 according to a first different embodiment will be described, referring to FIGS. 33 through 37. FIG. 33 is an exploded perspective view illustrating a take-up drum unit 242 of the seatbelt retractor 241 according to the first different embodiment.

The schematic configuration of the seatbelt retractor 241 according to the first different embodiment is substantially the same as that of the seatbelt retractor 1 according to the above embodiment.

However, as illustrated in FIG. 33, the configuration of the take-up drum unit 242 is almost the same as that of the take-up drum unit 6, but different in that a take-up drum 243 and a torsion bar 245 are employed in place of the take-up drum 181 and the torsion bar 182.

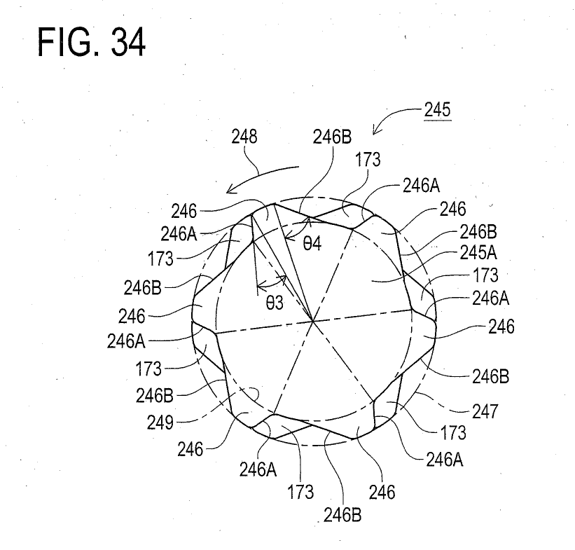

First, the configuration of the torsion bar 245 will be discussed referring to FIGS. 33 and 34. FIG. 34 is a side view of the torsion bar 245 on the take-up drum 243 side.

As illustrated in FIGS. 33 and 34, the configuration of the torsion bar 245 is almost the same as that of the torsion bar 182; however, a connecting portion 245A is formed on the end portion of the torsion bar 245 at the side to be inserted into the take-up drum 243, in place of the connecting portion 182A. The connecting portion 245A of the torsion bar 245 has six convex portions 246 protruding from outer periphery of a column of a predetermined length in axial direction (for instance, approximately 6 mm long in axial direction), by every 60 degrees of equal central angle continuously in the circumferential direction. Each of the six convex portions 246 has a trapezoidal cross section.

Further, a tip diameter 247 of each of the convex portions 246 is formed substantially equal to the tip diameter 174 of each of the convex portions 173 of the connecting portion 182B, and the height in a radial direction of each of the convex portions 246 is formed substantially equal to the height of each of the convex portions 173 in a radial direction.

Further, of two faces facing a circumferential direction of each of the convex portions 246, a face 246A is on the side for transmitting to the take-up drum 243 a rotary driving force for rotating in the webbing take-up direction (in the direction indicated by arrow 248 in FIG. 34). The face 246A has an inclination angle θ3 with regard to a radial direction. The inclination angle θ3 is designed to be smaller than 45 degrees, or preferably smaller than 26.6 degrees. Further, the inclination angle θ3 is formed to be smaller than an inclination angle θ4 with regard to a radial direction at a face 246B on a side for transmitting to the take-up drum 243 a rotary driving force to rotate in the webbing pull-out direction (in the direction opposite to arrow 248 in FIG. 34), that is, the face 246B on the circumferentially opposite side. For instance, the inclination angle θ3 may be approximately 25 degrees, and the inclination angle θ4 may be approximately 50 degrees.

Further, the base end portions of the two faces 246A, 246B facing a circumferential direction of each of the convex portions 246 are formed to be located on a concentric circle. The base end portions of the two faces 246A, 246B facing a circumferential direction of each of the convex portions 246 may be connected to the base end portions of the face 246A or the face 246B adjacent in the circumferential direction. As a result, the inclination angle θ4 of the face 246B with regard to a radial direction can further be increased.

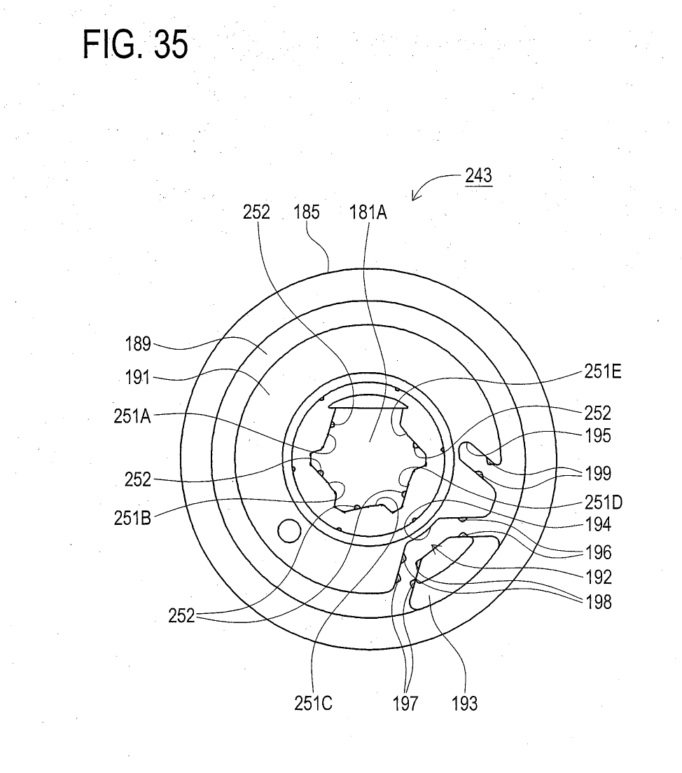

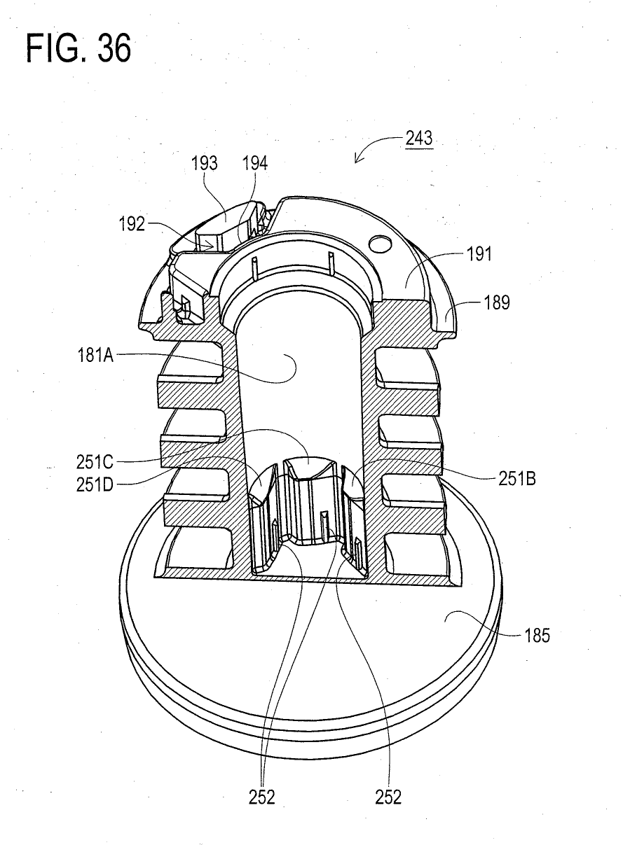

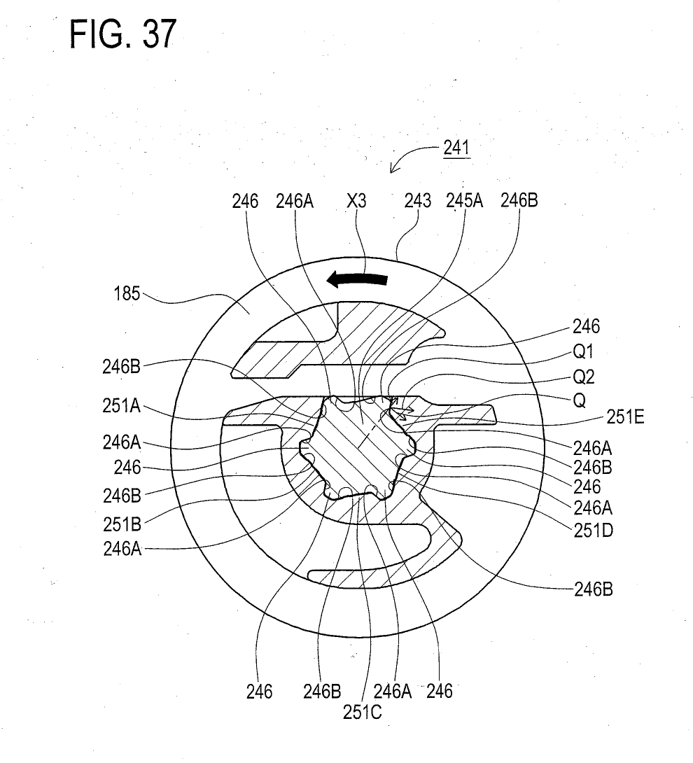

Next, the configuration of the take-up drum 243 will be discussed referring to FIGS. 33, 35 through 37. FIG. 35 is a front view of the take-up drum seen from a side for mounting the ratchet gear 35. FIG. 36 is a partial cutaway sectional view showing the take-up drum 243 in the axial direction. FIG. 37 is a cross sectional view for illustrating a state of the take-up drum 243 with the torsion bar 245 installed thereon.

As illustrated in FIGS. 33, 35 and 36, the configuration of the take-up drum 243 is substantially the same as that of the take-up drum 181 of the seatbelt retractor 1 directed to the above embodiment; however, the take-up drum 243 has five projecting portions 251A through 251E having a triangular cross section formed on the inner circumferential surface of the flange portion 185 side end portion within the shaft hole 181A, instead of the five projecting portions 188A through 188E. The projecting portions 251A through 251E are projecting at a predetermined circumferential pitch, radially inward in a rib-like shape along the axial direction, so as to function as a fitting portion into which the connecting portion 245A of the torsion bar 245 is inserted.

The projecting portions 251A through 251E are engageably projecting between the convex portions 246 of the connecting portion 245A formed on the end portion of the torsion bar 245 at the side to be inserted into the take-up drum 243. Further, the length in the axial direction of the projecting portions 251A through 251E is formed to exceed (for instance, approximately twice as long as) the width in the axial direction of each of the convex portions 246. Further, ridge portions 252 are formed on the projecting portions 251A through 251E, each on a side face portion in the webbing take-up direction side (on a side in the counterclockwise direction in FIG. 35). Each of the ridge portions 252 has a thin and long triangular cross section, long in the axial direction, and is projecting at a predetermined height (for instance, approximately 0.3 mm high) contactably with a face 246B of each of the convex portions 246 of the connecting portion 245A inserted in the shaft hole 181A.

Thereafter, as illustrated in FIG. 37, if the connecting portion 245A of the torsion bar 245 is inserted into the shaft hole 181A of the take-up drum 243 and press-fitted, the convex portions 246 of the connecting portion 245A are inserted into and press-fitted between the projecting portions 251A through 251E, respectively, while crushing the ridge portions 252.

Here, an explanation is given referring to FIG. 37, with regard to a load acting on the convex portions 246 of the torsion bar 245 and the projecting portions 251A through 251E of the take-up drum 243. The load is caused by the rotation torque in the webbing pull-out direction acting on the take-up drum 243, when a vehicle occupant moves forward relative to the vehicle, under a state where the engagement between the pawl 23 and the ratchet gear portion 35A of the ratchet gear 35 is still maintained, after the pretensioner unit 7 is activated at vehicle collision, etc.

As illustrated in FIG. 37, the connecting portion 182B of the torsion bar 245 is prevented from rotating in the webbing pull-out direction via the ratchet gear 35. Thereby, the connecting portion 245A of the torsion bar 245 press-fitted among the projecting portions 251A through 251E of the take-up drum 243 is subjected to the rotation torque in the webbing pull-out direction (in the direction indicated by arrow X3) along the rotation of the take-up drum 243.

As a result, at the projecting portions 251A through 251E, a large load Q is applied to each face 246A in a tangential direction (circumferential direction) as a counteraction by the rotation torque, through the face 246A of each of the convex portions 246 of the connecting portion 245A (FIG. 37 depicts the large load Q applied to the face 246A of one convex portion 246 from among the six convex portions 246). Thus, in the projecting portions 251A through 251E, a load Q1 that satisfies “Q1=Q×tan θ3” acts in the radial direction from each face 246A, and a load Q2 that satisfies “Q2=Q/cos θ3” acts vertically on each face 246A.

Further, as described above, as the inclination angle θ3 of the face 246A with regard to a radial direction is formed to be smaller than 45 degrees, or preferably smaller than 26.6 degrees, the load Q1 in the radial direction can be made smaller than the load Q. If the inclination angle θ3 of the face 246A with regard to a radial direction is smaller than 26.6 degrees, the load Q1 in the radial direction that acts on the projecting portions 251A through 251E can be reduced to half the load Q, or lower. Accordingly, as the inclination angle θ3 of the face 246A with regard to a radial direction becomes closer to 0 degree, the load Q1 in the radial direction that acts on the projecting portions 251A through 251E also becomes closer to 0.

Thus, in addition to the effects of the seatbelt retractor 1 according to the above embodiment, in the seatbelt retractor 241 according to the first different embodiment, the projecting portions 251A through 251E are subjected to the load Q1 satisfying “Q1=Q×tan θ3” in the radial direction from the face 246A of each of the convex portions 246. Accordingly, decrease of the inclination angle θ3 of the face 246A with regard to a radial direction (for instance, the inclination angle θ3 of 25 degrees) helps reduce the load Q1 in the radial direction applied to the projecting portions 251A through 251E. Thereby, the decrease of the inclination angle θ3 of each face 246A with regard to a radial direction helps reduce the mechanical strength required in the projecting portions 251A through 251E of the take-up drum 243, and also enables the downsizing, weight-saving and cost-reduction of the take-up drum 243.

Further, the smaller the inclination angle θ3 with regard to a radial direction at the face 246A of each of the convex portions 246 is, the smaller the load Q1 in the radial direction applied to each of the projecting portions 251A through 251E can be made. Simultaneously, if the torsion bar 245 is made by forging, etc., the increase of a load on a die at forming the convex portions 246 may deteriorate the formability, resulting in the difficulty in manufacturing the torsion bar 245.

However, even with the smaller inclination angle θ3 with regard to a radial direction at the face 246A of each of the convex portions 246, each of the convex portions 246 can be formed easily by forging, etc., by increasing the inclination angle θ4 with regard to a radial direction at the face 246B circumferentially opposite to the face 246A of each of the convex portions 246, and the formability of the torsion bar 245 by forging, etc. can be improved.

Further, even with the smaller inclination angle θ3 with regard to a radial direction at the face 246A of each of the convex portions 246 formed on the connecting portion 245A of the torsion bar 245, the inclination angle θ4 with regard to a radial direction at the face 246B circumferentially opposite to the face 246A of each of the convex portions 246 can easily be made larger (for instance, the inclination angle θ4 of 50 degrees). As a result, the circumferential width dimension of each of the convex portions 246 can be widened, the shear strength in the circumferential direction of each of the convex portions 246 can easily be improved, and the mechanical strength required in the convex portions 246 can easily be secured.

Accordingly, as the inclination angle θ3 with regard to a radial direction at the face 246A of each of the convex portions 246 formed on the connecting portion 245A of the torsion bar 245 is made to be smaller than the inclination angle θ4 with regard to a radial direction at the face 246B circumferentially opposite to the face 246A of each of the convex portions 246, the design freedom of the plurality of convex portions 246 increases, and while securing the mechanical strength required in each of the convex portions 246 and the projecting portions 251A through 251E of the take-up drum 243, the formability by forging, etc of the torsion bar 245 can further be improved.

### Second Different Embodiment

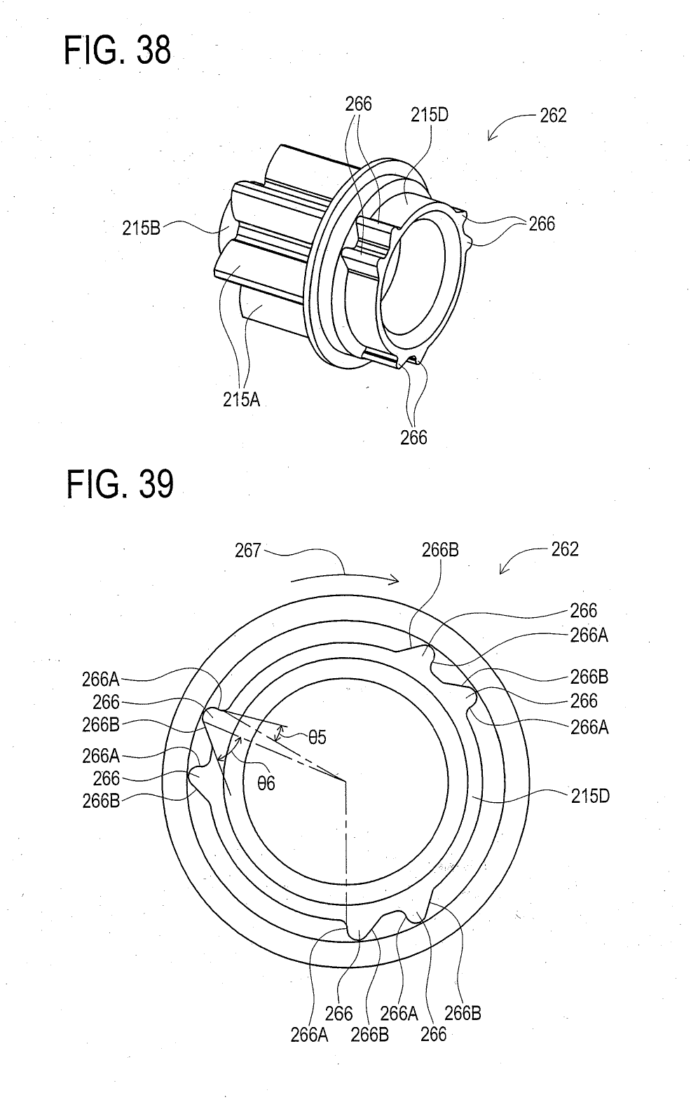

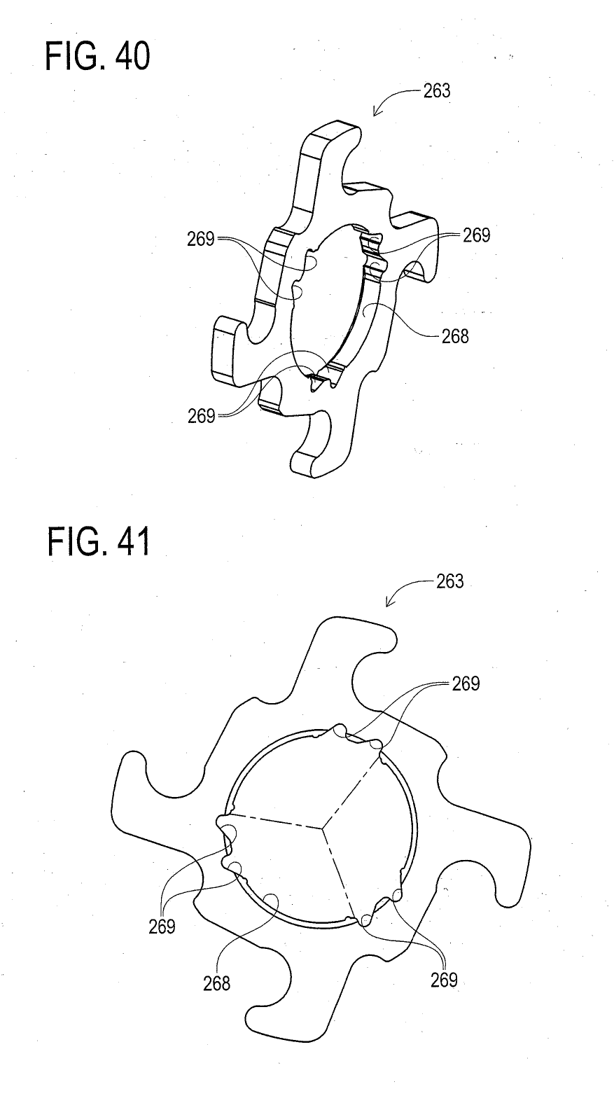

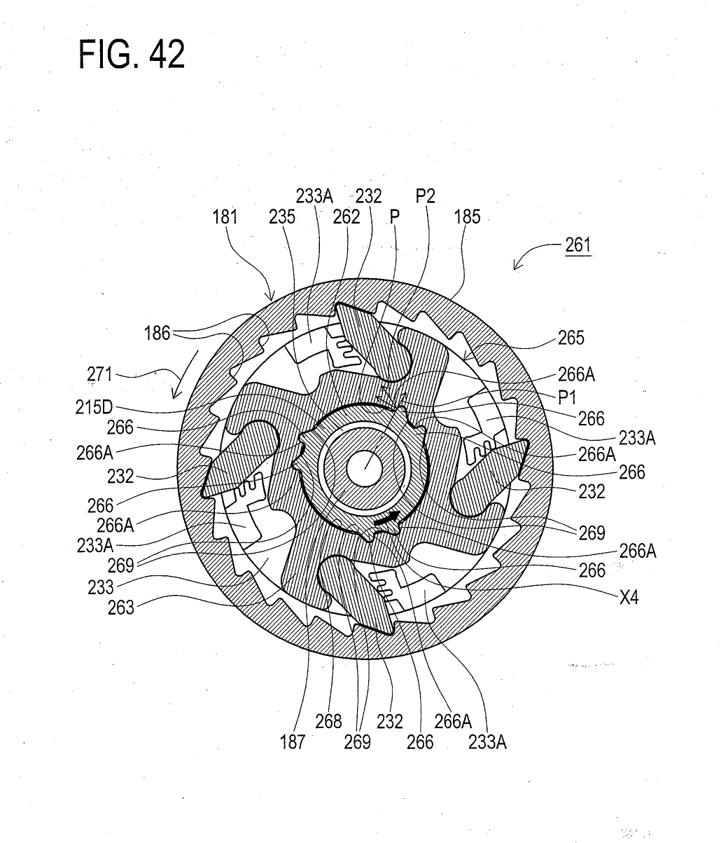

(B) Next will be discussed a seatbelt retractor 261 according to a second different embodiment, referring to FIGS. 38 through 42. FIG. 38 is a perspective view illustrating a pinion gear 262 of the seatbelt retractor 261 according to the second different embodiment. FIG. 39 is a side view of the pinion gear 262 on a pawl base 263 side. FIG. 40 is a perspective view illustrating a pawl base 263 of the seatbelt retractor 261 according to the second different embodiment. FIG. 41 is a front view of the pawl base 263. FIG. 42 is a sectional view illustrating a state of a clutch mechanism 265 at activation of the pretensioner unit 7.

The schematic configuration of the seatbelt retractor 261 according to the second different embodiment is substantially the same as that of the seatbelt retractor 1 according to the above embodiment.

However, as illustrated in FIGS. 38 and 40, the configuration is different in that the pinion gear 262 and the pawl base 263 are employed in place of the pinion gear 215 and the pawl base 231.

First, the configuration of the pinion gear 262 will be discussed, referring to FIGS. 38 and 39.

As illustrated in FIGS. 38 and 39, the configuration of the pinion gear 262 is substantially the same as that of the pinion gear 215 (see FIG. 26) of the seatbelt retractor 1 according to the above embodiment; however, convex portions 266 each having a substantially trapezoidal cross section are formed on the outer peripheral surface of the boss portion 215D, in place of a spline including six protrusions. The convex portions 266 are arranged in pairs, by every 120 degrees of equal center angle.

The tip diameter of each of the convex portions 266 is formed substantially equal to the outer diameter of the base end portion of the boss portion 215D. Further, of two faces facing a circumferential direction of each of the convex portions 266, a face 266A is on the side for transmitting to the pawl base 263 a rotary driving force for rotating in the webbing take-up direction (in the direction indicated by arrow 267 in FIG. 39). The face 266A has an inclination angle θ5 with regard to a radial direction. The inclination angle θ5 is designed to be smaller than 45 degrees, or preferably smaller than 26.6 degrees. Further, the inclination angle θ5 is formed to be smaller than an inclination angle θ6 with regard to a radial direction at a face 266B on a side for transmitting to the pawl base 263 a rotary driving force to rotate in the webbing pull-out direction (in the direction opposite to arrow 267 in FIG. 42), that is, the face 266B on the circumferentially opposite side. For instance, the inclination angle θ5 may be approximately 25 degrees, and the inclination angle θ6 may be approximately 50 degrees.

Next, the configuration of the pawl base 263 will be discussed referring to FIGS. 40 and 41.

As illustrated in FIGS. 40 and 41, the configuration of the pawl base 263 is substantially the same as that of the pawl base 231 of the seatbelt retractor 1 according to the above embodiment; however, a fitting hole 268 that receives an insertion of the boss portion 215D of the pinion gear 262 is formed at the center of the pawl base 263.

The inner circumferential surface of the fitting hole 268 has groove portions 269 that operate as a fitting portion. The convex portions 266 formed on the outer periphery of the boss portion 215D of the pinion gear 262 are fitted in the groove portions 269. The groove portions 269 each have a substantially trapezoidal cross section, and are arranged in pairs by every 120 degrees of equal center angle along the axial direction. Accordingly, as illustrated in FIG. 42, as the boss portion 215D of the pinion gear 262 is press-fitted into the fitting hole 268 of the pawl base 263, interposing the base plate 218 and the pawl guide 233, the pawl base 263 is attached to the pinion gear 262, non-rotatably relative to the pinion gear 262. Further, the bearing 235 is engaged with the outer peripheral portion of the pawl guide 233 using a plurality of elastic engagement pieces 235A projecting from the outer peripheral portion, so that the clutch mechanism 265 is configured.

Here will be discussed, referring to FIG. 42, a load that acts on the convex portions 266 of the pinion gear 262 and the groove portions 269 of the fitting hole 268 of the pawl base 263 by the rotation torque having rotatably driven the pinion gear 262 in the webbing take-up direction (in the direction indicated by arrow X4 in FIG. 42) when the pretensioner unit 7 is activated at vehicle collision or the like.

As illustrated in FIG. 42, if the pretensioner unit 7 is activated at vehicle collision or the like, the pawl base 263 rotates in the webbing take-up direction (in the direction indicated by arrow X4 in FIG. 42) together with the pinion gear 262. Here, the pawl base 263 is designed to rotate relative to the pawl guide 233, so that the position-changing projecting portions 233A formed on the pawl guide 233 make contact with clutch pawls 232, and each clutch pawl 232 is turned to an engagement position for engaging with the internal gear 186 formed on the inner circumferential surface of the flange portion 185 of the take-up drum 181.

Then, the position of the clutch pawls 232 is changed into the engagement position, the tip end portions of the clutch pawls 232 engage with the internal gear 186, and the pawl base 263 rotates the take-up drum 181 in the webbing take-up direction (in the direction indicated by arrow 271 in FIG. 42). Thus, the groove portions 269 of the pawl base 263 are subjected to the rotation torque in the webbing take-up direction (in the direction indicated by arrow X4) along the rotation of the pinion gear 262. As a result, in the groove portions 269 of the pawl base 263, a large load P is applied to each face 266A in a tangential direction (circumferential direction), through the face 266A of each of the convex portions 266 of the pinion gear 262 (FIG. 42 depicts the large load P applied to the face 266A of one convex portion 266 from among the six convex portions 266).

Thus, in the groove portions 269, a load P1 that satisfies “P1=P×tan θ5” acts in the radial direction from each face 266A, and a load P2 that satisfies “P2=P/cos θ6” acts vertically on each face 266A.

Further, as described above, as the inclination angle θ5 of the face 266A with regard to a radial direction is farmed to be smaller than 45 degrees, or preferably smaller than 26.6 degrees, the load P1 in radial direction can be made smaller than the load P. If the inclination angle θ5 of the face 266A with regard to a radial direction is smaller than 26.6 degrees, the load P1 in the radial direction that acts on the groove portions 269 can be reduced to half the load P or lower. Accordingly, as the inclination angle θ5 of the face 266A with regard to a radial direction becomes closer to 0 degree, the load P1 in the radial direction that acts on the groove portions 269 also becomes closer to 0.

Thus, in addition to the effects of the seatbelt retractor 1 according to the above embodiment, in the seatbelt retractor 261 according to the second different embodiment, the groove portions 269 are subjected to the load P1 satisfying “P1=P×tan θ5” in the radial direction from the face 266A. Accordingly, decrease of the inclination angle θ5 with regard to a radial direction of the face 266A of each of the convex portions 266 (for instance, the inclination angle θ5 of 25 degrees) helps reduce the load P1 in the radial direction applied to the groove portions 269. Thereby, the decrease of the inclination angle θ5 of each face 266A with regard to a radial direction helps reduce the mechanical strength required in the pawl base 263, and also enables the downsizing, weight-saving and cost-reduction of the pawl base 263.

Further, the smaller the inclination angle θ5 with regard to a radial direction at the face 266A of each of the convex portions 266 is, the smaller the load P1 in the radial direction applied to each groove portion 269 can be made. Simultaneously, if the pinion gear 262 is made by forging, etc., the increase of a load on a die at forming the convex portions 266 may deteriorate the formability, resulting in the difficulty in manufacturing the pinion gear 262.

However, even with the smaller inclination angle θ5 with regard to a radial direction at the face 266A of each of the convex portions 266, each of the convex portions 266 can be formed easily by forging, etc., by increasing the inclination angle θ6 with regard to a radial direction at the face 266B circumferentially opposite to the face 266A of each of the convex portions 266, and the formability, of the pinion gear 262 by forging, etc. can be improved.

Further, even with the smaller inclination angle θ5 with regard to a radial direction at the face 266A of each of the convex portions 266 formed on the boss portion 215D of the pinion gear 262, the inclination angle θ6 with regard to a radial direction at the face 266B circumferentially opposite to the face 266A of each of the convex portions 266 can easily be made larger (for instance, the inclination angle θ6 of 50 degrees). As a result, the circumferential width dimension of each of the convex portions 266 can be widened, the shear strength in the circumferential direction of each of the convex portions 266 can easily be improved, and the mechanical strength required in the convex portions 266 can easily be secured.

Accordingly, as the inclination angle θ5 with regard to a radial direction at the face 266A of each of the convex portions 266 formed on the boss portion 215D of the pinion gear 262 is made to be smaller than the inclination angle θ6 with regard to a radial direction at the face 266B circumferentially opposite to the face 266A of each of the convex portions 266, the design freedom of the plurality of convex portions 266 increases, and while securing mechanical strength required for each of the convex portions 266 and the groove portions 269 of pawl base 263, the formability by forging, etc. of the pinion gear 262 can further be improved.

### Third Different Embodiment

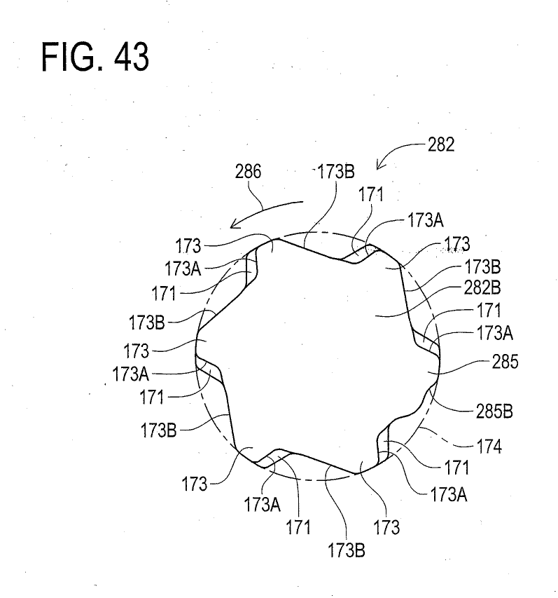

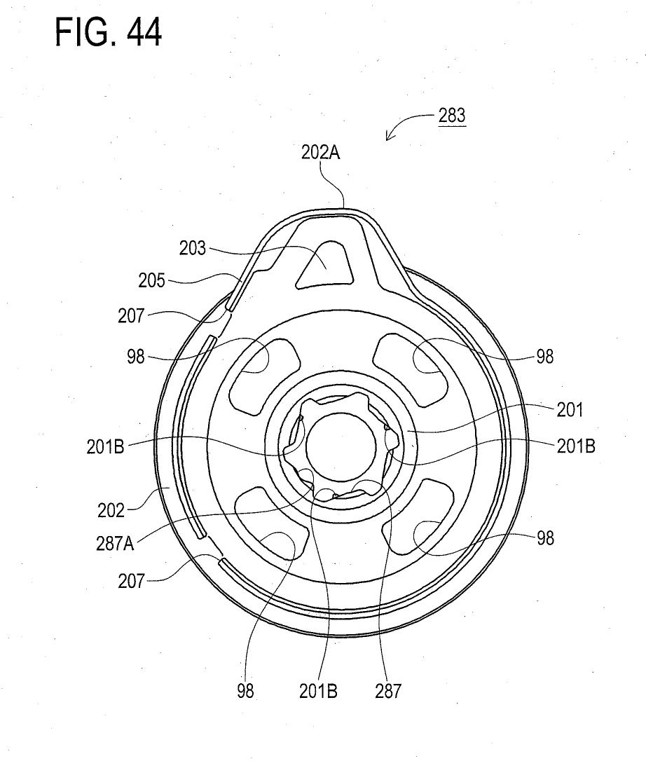

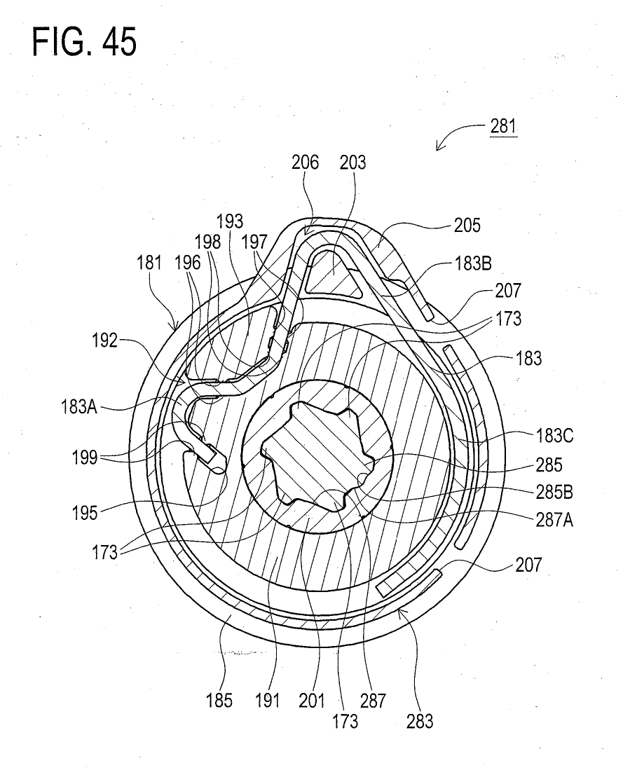

(C) Next will be discussed a seatbelt retractor 281 according to a third different embodiment referring to FIGS. 43 through 45. FIG. 43 is a side view of a torsion bar 282 on a ratchet gear 283 side of the seatbelt retractor 281 according to the third different embodiment. FIG. 44 is a front view illustrating an inside of the ratchet gear 283 of the seatbelt retractor 281 according to the third different embodiment. FIG. 45 is a sectional view illustrating a state of the ratchet gear 283 with the torsion bar 282 attached thereon.

The schematic configuration of the seatbelt retractor 281 according to the third different embodiment is substantially the same as that of the seatbelt retractor 1 according to the above embodiment.

However, as illustrated in FIGS. 43 and 44, the configuration is different in that the torsion bar 282 and the ratchet gear 283 are employed in place of the torsion bar 182 and the ratchet gear 35.

First, the configuration of the torsion bar 282 will be discussed, referring to FIG. 43.

As illustrated in FIG. 43, the configuration of the torsion bar 282 is substantially the same as that of the torsion bar 182 (see FIGS. 19 and 24) of the seatbelt retractor 1 according to the above embodiment; however, a connecting portion 282B is formed on an end portion at the side to be inserted to the ratchet gear 283, in place of the connecting portion 182B formed on the end portion at the side to be inserted to the ratchet gear 35.

The connecting portion 282B is formed at the end portion of the torsion bar 282 at a side to be inserted into the ratchet gear 283. The connecting portion 282B has five convex portions 173 each having a trapezoidal cross section and one positioning convex portion 285 having a substantially trapezoidal cross section. The convex portions 173 and the positioning convex portion 285 are arranged by every 60 degrees of equal central angle continuously in the circumferential direction. Further, the tip diameter 174 of the convex portions 173 and the positioning convex portion 285 is formed substantially equal to the tip diameter 172 of the protruding portions 171, and the height in radial direction of each of the convex portions 173 and the positioning convex portion 285 is formed substantially equal to the height of the protruding portions 171 in radial direction.

The positioning convex portion 285 of the connecting portion 282B has the substantially the same shape as each of the convex portions 173, and a face 173A is formed on a side that transmits to the ratchet gear 283 a rotary driving force for driving in the webbing pull-out direction (in the direction indicated by arrow 286 in FIG. 43), similar to each of the convex portions 173. Meanwhile, the positioning convex portion 285 of the connecting portion 282B has a face 285B slightly bulging radially outward at the center portion, on the side that transmits to the ratchet gear 283 a rotary driving force for driving in the webbing take-up direction (in the direction opposite to arrow 286 in FIG. 43), so as to have a cross section different from the convex portions 173.

Next, the configuration of the ratchet gear 283 will be discussed referring to FIG. 44.

As illustrated in FIG. 44, the configuration of the ratchet gear 283 is substantially the same as that of the ratchet gear 35 (see FIG. 22) of the seatbelt retractor 1 according to the above embodiment; however, on the fixation boss 201, a fitting concave portion 287 is formed as a fitting portion to which the connecting portion 282B of the torsion bar 282 is inserted.

The configuration of the fitting concave portion 287 of the ratchet gear 283 is substantially the same as that of the fitting concave portion 201A of the ratchet gear 35; however, a bulging portion 287A is formed on an inner circumferential surface of the connecting portion 282B facing the face 285B of the positioning convex portion 285. The bulging portion 287A is slightly bulging radially outward so as to allow insertion of the face 285B. Further, three ribs 201B are formed on an inner circumferential surface of the fitting concave portion 287 facing the face 173B of each of the convex portions 173. The three ribs 201B are projecting radially inward and arranged along the axial direction.

Next, the assembly of the ratchet gear 283 to the take-up drum 181 will be discussed referring to FIG. 45.

As illustrated in FIG. 45, the crooked portion 183B of the wire 183 is substantially inverted U-shaped in front view and projecting outside the outer periphery of the flange portion 189 of the take-up drum 181. The crooked portion 183B is inserted inside the deformation-giving crooked path 206 formed on the outer peripheral portion of the convex portion 203 formed on the trapezoid-like portion 202A of the flange portion 202 of the ratchet gear 283.

Further, at the same time, the fixation boss 201 of the ratchet gear 283 is inserted inside the stepped portion 191 of the take-up drum 181, so that the connecting portion 282B on the end portion of the torsion bar 282 at the side to be inserted to the ratchet gear 283 is press-fitted inside the fitting concave portion 287 of the fixation boss 201, while crushing the ribs 201B. As a result, the face 285B of the positioning convex portion 285 arranged on the connecting portion 282B of the torsion bar 282 is inserted in the bulging portion 287A of the fitting concave portion 287, press-fitted while being positioned in the circumferential direction. Further, the wire 183 is arranged between the flange portion 189 of the take-up drum 181 and flange portions 202, 205 of the ratchet gear 283, and at the same time, the ratchet gear 283 is mounted on the take-up drum 181.

Meanwhile, there may be a case where the wire 183 is not mounted between the take-up drum 181 and the ratchet gear 283. Even in that case, the fixation boss 201 of the ratchet gear 283 is inserted inside the stepped portion 191 of the take-up drum 181, and then, while inserting the face 285B of the positioning convex portion 285 of the connecting portion 282B of the torsion bar 282 into the bulging portion 287A of the fitting concave portion 287, the ribs 201B are inserted as being crushed. Accordingly, even if the wire 183 is not mounted between the take-up drum 181 and the ratchet gear 283, by the positioning convex portion 285 of the connecting portion 282B of the torsion bar 282, the ratchet gear 283 can be press-fitted while being positioned at the same position with regard to the torsion bar 282 as a state where the wire 183 is mounted.

Accordingly, in the seatbelt retractor 281, the torsion bar 282 is fitted under a state being positioned at the fitting concave portion 287 of the ratchet gear 283 by the positioning convex portion 285 arranged at the connecting portion 282B, so that by a simple configuration, the assembly accuracy can be improved and the efficiency of assembly operation can be promoted. Further, the face 285B slightly bulging radially outward of the positioning convex portion 285 arranged on the connecting portion 282B is formed on a side that transmits to ratchet gear 283 a rotary driving force for rotating in the webbing take-up direction (clockwise in FIG. 45), so as to prevent the positioning convex portion 285 from adversely affecting the mechanical strength.

The following configurations may also be employed.

(1) In the positioning convex portion 285 of the connecting portion 282B, the face 285B may be formed slightly depressed radially inward. Further, on the inner circumferential surface of the fitting concave portion 287 of the ratchet gear 283, a bulging portion may be formed at a location of the connecting portion 282B facing the face 285B of the positioning convex portion 285, so as to slightly project radially inward along the face 285B.

Accordingly, as the torsion bar 282 is fitted under a state positioned at the fitting concave portion 287 of the ratchet gear 283 by the positioning convex portion 285 arranged at the connecting portion 282B, the assembly accuracy can be improved and the efficiency of assembly operation can be promoted in the seatbelt retractor 281 by a simple configuration.

(2) Further, two to five positioning convex portions 285 may be arranged on the connecting portion 282B of the torsion bar 282. Further, the fitting concave portion 287 of the ratchet gear 283 may be designed to make the inner circumferential surface facing a face 285B of the positioning convex portion 285 slightly bulging radially outward or radially inward, so as to allow insertion of the face 285B.

Accordingly, as the torsion bar 282 is fitted under a state positioned at the fitting concave portion 287 of the ratchet gear 283 by the positioning convex portions 285 arranged at the connecting portion 282B, the assembly accuracy can be improved and the efficiency of assembly operation can be promoted in the seatbelt retractor 281 by a simple configuration.

(3) Further, in the seatbelt retractor 241 according to the first different embodiment, at least one positioning convex portion 285 may be arranged on the connecting portions 182B, 245A formed on the two end portions in the axial direction of the torsion bar 245. Further, of the projecting portions 251A through 251E of the take-up drum 243, the side face portion facing the face 285B of the positioning convex portion 285 may be formed slightly bulging radially outward or radially inward, so as to allow insertion of the face 285B of the positioning convex portion 285.

Accordingly, it becomes possible for the take-up drum 243 and the ratchet gear 35 of the seatbelt retractor 241 to be connected through the torsion bar 245 non-rotatably relative to each other, under a state mutually positioned, so that the assembly accuracy can be improved and the efficiency of assembly operation can be promoted in the seatbelt retractor 241 by a simple configuration.

1. A seatbelt retractor comprising:
a take-up drum configured to wind up a webbing thereon;
a transmission member arranged coaxially with a rotation axis of the take-up drum, and including a plurality of convex portions protruding radially outward at a predetermined circumferential pitch on an outer peripheral portion of at least one end portion of the transmission member so as to transmit a rotary driving force; and
one or more fitting members each including a fitting portion, the fitting portion configured to receive insertion of the one end portion of the transmission member having the plurality of convex portions, and to fit with the plurality of convex portions, wherein
each of the plurality of convex portions has a trapezoidal cross section and two faces facing a circumferential direction, with an inclination angle with regard to a radial direction at one face of the two faces smaller than an inclination angle with regard to a radial direction at the other face of the two faces, and
the one face is configured to receive a load through one of the one or more fitting members by the rotary driving force transmitted in case of emergency larger than a load that the other face receives.

2. The seatbelt retractor according to claim 1, wherein
the transmission member includes a torsion bar configured to be fittingly inserted in the take-up drum, with one axial end side of the torsion bar configured to be connected to one end portion of the take-up drum, non-rotatably relative to the take-up drum,
the one or more fitting members include a lock member configured to be connected to the other axial end side of the torsion bar, non-rotatably relative to the torsion bar, the lock member configured to be prevented from rotating in a webbing pull-out direction in case of emergency,
a set of the plurality of convex portions is protruding radially outward at a predetermined circumferential pitch on an outer peripheral portion at the other axial end side of the torsion bar,
the fitting portion is arranged on the lock member, and
the one face of the two faces facing a circumferential direction of each of the plurality of convex portions protruding on the outer peripheral portion of the other axial end of the torsion bar is at a side configured to transmit to the lock member a rotary driving force for rotation in the webbing pull-out direction.

3. The seatbelt retractor according to claim 1, wherein
the transmission member includes a torsion bar configured to be fittingly inserted in the take-up drum, with one axial end side of the torsion bar configured to be connected to one end portion of the take-up drum non-rotatably relative to the take-up drum,
the one or more fitting members include the take-up drum configured to fittingly house the torsion bar inserted therein,
a set of the plurality of convex portions is arranged protruding radially outward at a predetermined circumferential pitch on an outer peripheral portion of the one axial end side of the torsion bar,
the fitting portion is arranged at a one-end-portion side of the take-up drum, and
the one face of the two faces facing a circumferential direction of each of the plurality of convex portions arranged on the outer peripheral portion of the one axial end of the torsion bar is at a side configured to transmit to the take-up drum a rotary driving force for rotation in a webbing take-up direction.

4. The seatbelt retractor according to claim 3, wherein
the take-up drum comprises:
a shaft hole having an approximately cylindrical shape, closed at the one-end-portion side of the take-up drum, and housing the torsion bar fittingly inserted from the other-end-portion side of the take-up drum; and
a plurality of projecting ribs each having an approximately trapezoidal cross section, projecting radially inward at a predetermined circumferential pitch at the one-end-portion side on an inner circumferential surface of the shaft hole, and extending axially in a predetermined length so as to fit in-between the plurality of convex portions, and
the fitting portion is structured with the inner circumferential surface of the shaft hole and the plurality of projecting ribs.

5. The seatbelt refractor according to claim 1, further comprising a pretensioner mechanism configured to wind up the webbing at vehicle collision, wherein
the pretensioner mechanism includes:
a driven body configured to rotate coaxially with the rotation axis of the take-up drum;
a driving mechanism configured to rotatingly drive the driven body at vehicle collision;
a rotating body fixedly mounted on the driven body coaxially; and
an engaging member supported by the rotating body and configured to engage with an engaging portion arranged on an axially outer side at the one end portion of the take-up drum in response to rotation of the rotating body,
the transmission member includes the driven body,
the one or more fitting members include the rotating body,
a set of the plurality of convex portions are arranged protruding radially outward at a predetermined circumferential pitch on an outer peripheral portion of an axial end portion of the driven body at a take-up-drum side,
the fitting portion is arranged on an inner circumferential surface of a through hole of the rotating body configured to fittingly house the axial end portion of the driven body at the take-up-drum side inserted therein, and
the one face of the two faces facing a circumferential direction of each of the plurality of convex portions is at a side configured to transmit to the rotating body a rotary driving force for rotation in the webbing take-up direction.

6. The seatbelt retractor according to claim 1, wherein
the plurality of convex portions include at least one positioning convex portion having a different cross section from that of other convex portions, the one positioning convex portion having a positioning portion on the other face thereof, and
the one end portion of the transmission member is fittingly inserted into the fitting portion under a state positioned by the positioning convex portion.

7. The seatbelt retractor according to claim 2, wherein
the one or more fitting members include the take-up drum configured to fittingly house the torsion bar inserted therein,
a set of the plurality of convex portions is arranged protruding radially outward at a predetermined circumferential pitch on an outer peripheral portion of the one axial end side of the torsion bar,
the fitting portion is arranged at a one-end-portion side of the take-up drum, and
the one face of the two faces facing a circumferential direction of each of the plurality of convex portions arranged on the outer peripheral portion of the one axial end of the torsion bar is at a side configured to transmit to the take-up drum a rotary driving force for rotation in a webbing take-up direction.

8. The seatbelt retractor according to claim 7, wherein
the take-up drum comprises:
a shaft hole having an approximately cylindrical shape, closed at the one-end-portion side of the take-up drum, and housing the torsion bar fittingly inserted from the other-end-portion side of the take-up drum; and
a plurality of projecting ribs each having an approximately trapezoidal cross section, projecting radially inward at a predetermined circumferential pitch at the one-end-portion side on an inner circumferential surface of the shaft hole, and extending axially in a predetermined length so as to fit in-between the plurality of convex portions, and
the fitting portion is structured with the inner circumferential surface of the shaft hole and the plurality of projecting ribs.
